(19) United States
(12) Patent Application Publication
(10) Pub. No.: US 2025/0330590 A1
(43) Pub. Date: Oct. 23, 2025

(54) METHOD, APPARATUS, AND MEDIUM FOR VIDEO PROCESSING

(71) Applicant: Bytedance Inc., Los Angeles, CA (US)

(72) Inventors: Wei JIA, Los Angeles, CA (US); Kai Zhang, Los Angeles, CA (US); Li Zhang, Los Angeles, CA (US)

(21) Appl. No.: 19/253,669

(22) Filed: Jun. 27, 2025

Related U.S. Application Data
(63) Continuation of application No. PCT/US2023/085730, filed on Dec. 22, 2023.
(60) Provisional application No. 63/477,683, filed on Dec. 29, 2022.

(51) Int. Cl. H04N 19/11; H04N 19/119; H04N 19/136; H04N 19/176; H04N 19/186; H04N 19/593; H04N 19/70

(52) U.S. Cl. CPC H04N 19/11; H04N 19/119; H04N 19/136; H04N 19/176; H04N 19/186; H04N 19/593; H04N 19/70

(57) ABSTRACT

Embodiments of the present disclosure provide a solution for video processing. A method for video processing is proposed. The method comprises: determining, for a conversion between a current video block of a video and a bitstream of the video, a prediction for the current video block based on a plurality of sub-partitions of the current video block and at least one intra prediction scheme, wherein the current video block is a chroma block, and the plurality of sub-partitions are obtained by partitioning the current video block; and performing the conversion based on the prediction for the current video block.

### CROSS REFERENCE

This application is a continuation of International Application No. PCT/US2023/085730, filed on Dec. 22, 2023, which claims the benefit of U.S. Provisional Application No. 63/477,683, filed on Dec. 29, 2022. The entire contents of these applications are hereby incorporated by reference in their entireties.

### FIELDS

Embodiments of the present disclosure relates generally to video processing techniques, and more particularly, to block partition.

### BACKGROUND

In nowadays, digital video capabilities are being applied in various aspects of peoples' lives. Multiple types of video compression technologies, such as MPEG-2, MPEG-4, ITU-TH.263, ITU-TH.264/MPEG-4 Part 10 Advanced Video Coding (AVC), ITU-TH.265 high efficiency video coding (HEVC) standard, versatile video coding (VVC) standard, have been proposed for video encoding/decoding. However, coding quality and coding efficiency of video coding techniques is generally expected to be further improved.

### SUMMARY

Embodiments of the present disclosure provide a solution for video processing.

In a first aspect, a method for video processing is proposed. The method comprises: determining, for a conversion between a current video block of a video and a bitstream of the video, a prediction for the current video block based on a plurality of sub-partitions of the current video block and at least one intra prediction scheme, wherein the current video block is a chroma block, and the plurality of sub-partitions are obtained by partitioning the current video block; and performing the conversion based on the prediction for the current video block.

According to the method in accordance with the first aspect of the present disclosure, a chroma block is divided into a plurality of sub-partitions, and a prediction for a chroma block is determined based on the plurality of sub-partitions and at least one intra prediction scheme. Thereby, the proposed method can advantageously improve coding efficiency and coding quality, especially when the block is of different signal and texture distributions.

In a second aspect, an apparatus for video processing is proposed. The apparatus comprises a processor and a non-transitory memory with instructions thereon. The instructions upon execution by the processor, cause the processor to perform a method in accordance with the first aspect of the present disclosure.

In a third aspect, a non-transitory computer-readable storage medium is proposed. The non-transitory computer-readable storage medium stores instructions that cause a processor to perform a method in accordance with the first aspect of the present disclosure.

In a fourth aspect, another non-transitory computer-readable recording medium is proposed. The non-transitory computer-readable recording medium stores a bitstream of a video which is generated by a method performed by an apparatus for video processing. The method comprises: determining a prediction for a current video block of the video based on a plurality of sub-partitions of the current video block and at least one intra prediction scheme, wherein the current video block is a chroma block, and the plurality of sub-partitions are obtained by partitioning the current video block; and generating the bitstream based on the prediction for the current video block.

In a fifth aspect, a method for storing a bitstream of a video is proposed. The method comprises: determining a prediction for a current video block of the video based on a plurality of sub-partitions of the current video block and at least one intra prediction scheme, wherein the current video block is a chroma block, and the plurality of sub-partitions are obtained by partitioning the current video block; generating the bitstream based on the prediction for the current video block; and storing the bitstream in a non-transitory computer-readable recording medium.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

Through the following detailed description with reference to the accompanying drawings, the above and other objectives, features, and advantages of example embodiments of the present disclosure will become more apparent. In the example embodiments of the present disclosure, the same reference numerals usually refer to the same components.

FIG. 1 illustrates a block diagram that illustrates an example video coding system, in accordance with some embodiments of the present disclosure;

FIG. 2 illustrates a block diagram that illustrates a first example video encoder, in accordance with some embodiments of the present disclosure;

FIG. 3 illustrates a block diagram that illustrates an example video decoder, in accordance with some embodiments of the present disclosure;

FIG. 4 illustrates nominal vertical and horizontal locations of 4:2:2 luma and chroma samples in a picture;

FIG. 5 illustrates example of encoder block diagram;

FIG. 6 illustrates 67 intra prediction modes;

FIG. 7 illustrates reference samples for wide-angular intra prediction;

FIG. 8 illustrates problem of discontinuity in case of directions beyond 45°;

FIG. 9 illustrates locations of the samples used for the derivation of α and β;

FIG. 10A illustrates four Sobel based gradient patterns for gradient linear model (GLM);

FIG. 10B illustrates an example of classifying the neighboring samples into two groups;

FIG. 10C illustrates the effect of the slope adjustment parameter;

FIG. 11A is a schematic diagram illustrating definition of samples used by PDPC applied to a diagonal top-right mode;

FIG. 11B is a schematic diagram illustrating definition of samples used by PDPC applied to a diagonal bottom-left mode;

FIG. 11C is a schematic diagram illustrating definition of samples used by PDPC applied to an adjacent diagonal top-right mode;

FIG. 11D is a schematic diagram illustrating definition of samples used by PDPC applied to an adjacent diagonal bottom-left mode;

FIG. 12 illustrates gradient approach for non-vertical/non-horizontal mode;

FIG. 13 illustrates nScale values with respect to nTbH and mode number; for all nScale<0 cases gradient approach is used;

FIG. 14 illustrates flowchart: current PDPC (left), and proposed PDPC (right);

FIG. 15 illustrates neighboring blocks (L, A, BL, AR, AL) used in the derivation of a general MPM list;

FIG. 16 illustrates example on proposed intra reference mapping;

FIG. 17 illustrates example of four reference lines neighboring to a prediction block;

FIG. 18A is a schematic diagram illustrating examples of sub-partitions for 4×8 and 8×4 CUs;

FIG. 18B is a schematic diagram illustrating examples of sub-partitions for CUs other than 4×8, 8×4 and 4×4;

FIG. 19A illustrates matrix weighted intra prediction process;

FIG. 19B illustrates an intra template matching search area used;

FIG. 20 illustrates target samples, template samples and the reference samples of template used in the DIMD;

FIG. 21 illustrates proposed intra block decoding process;

FIG. 22 illustrates HoG computation from a template of width 3 pixels;

FIG. 23 illustrates Prediction fusion by weighted averaging of two HoG modes and planar;

FIG. 24 illustrates neighboring reconstructed samples used for DIMD chroma mode;

FIG. 25 illustrates MMVD search point;

FIG. 26 illustrates Illustration for symmetrical MVD mode;

FIG. 27 illustrates extended CU region used in BDOF;

FIG. 28 illustrates control point based affine motion model;

FIG. 29 illustrates affine MVF per subblock;

FIG. 30 illustrates locations of inherited affine motion predictors;

FIG. 31 illustrates control point motion vector inheritance;

FIG. 32 illustrates locations of candidates position for constructed affine merge mode;

FIG. 33 illustrates illustration of motion vector usage for proposed combined method;

FIG. 34 illustrates subblock MV VSB and pixel Δv(i,j);

FIG. 35A and FIG. 35B illustrate the SbTMVP process in VVC;

FIG. 36 illustrates local illumination compensation;

FIG. 37 illustrates no subsampling for the short side;

FIG. 38 illustrates decoding side motion vector refinement;

FIG. 39 illustrates diamond regions in the search area;

FIG. 40 illustrates positions of spatial merge candidate;

FIG. 41 illustrates candidate pairs considered for redundancy check of spatial merge candidates;

FIG. 42 illustrates illustration of motion vector scaling for temporal merge candidate;

FIG. 43 illustrates candidate positions for temporal merge candidate, C₀ and C₁;

FIG. 44 illustrates VVC spatial neighboring blocks of the current block;

FIG. 45 illustrates illustration of virtual block in the i-th search round;

FIG. 46 illustrates examples of the GPM splits grouped by identical angles;

FIG. 47 illustrates uni-prediction MV selection for geometric partitioning mode;

FIG. 48 illustrates exemplified generation of a bending weight w₀ using geometric partitioning mode;

FIG. 49 illustrates spatial neighboring blocks used to derive the spatial merge candidates;

FIG. 50 illustrates template matching performs on a search area around initial MV;

FIG. 51 illustrates illustration of sub-blocks where OBMC applies;

FIG. 52 illustrates SBT position, type and transform type;

FIG. 53 illustrates neighboring samples used for calculating SAD;

FIG. 54 illustrates neighboring samples used for calculating SAD for sub-CU level motion information;

FIG. 55 illustrates the sorting process;

FIG. 56 illustrates reorder process in encoder;

FIG. 57 illustrates reorder process in decoder;

FIG. 58 illustrates spatial part of the convolutional filter;

FIG. 59 illustrates reference area (with its paddings) used to derive the filter coefficients;

FIG. 60 illustrates a schematic diagram of an example partitioning mode in accordance with some embodiments of the present disclosure;

FIG. 61 illustrates a schematic diagram of an example partitioning mode in accordance with some embodiments of the present disclosure;

FIG. 62 illustrates a schematic diagram of an example partitioning mode in accordance with some embodiments of the present disclosure;

FIG. 63 illustrates a schematic diagram of an example partitioning mode in accordance with some embodiments of the present disclosure;

FIG. 64 illustrates a schematic diagram of an example partitioning mode in accordance with some embodiments of the present disclosure;

FIG. 65 illustrates a schematic diagram of an example partitioning mode in accordance with some embodiments of the present disclosure;

FIG. 66 illustrates a schematic diagram of an example partitioning mode in accordance with some embodiments of the present disclosure;

FIG. 67 illustrates a schematic diagram of an example partitioning mode in accordance with some embodiments of the present disclosure;

FIG. 68 illustrates a schematic diagram of an example partitioning mode in accordance with some embodiments of the present disclosure;

FIG. 69 illustrates a schematic diagram of an example partitioning mode in accordance with some embodiments of the present disclosure;

FIG. 70 illustrates a flowchart of a method for video processing in accordance with embodiments of the present disclosure;

FIG. 71 illustrates a flowchart of a method for video processing in accordance with some embodiments of the present disclosure; and

FIG. 72 illustrates a block diagram of a computing device in which various embodiments of the present disclosure can be implemented.

Throughout the drawings, the same or similar reference numerals usually refer to the same or similar elements.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

### Example Environment

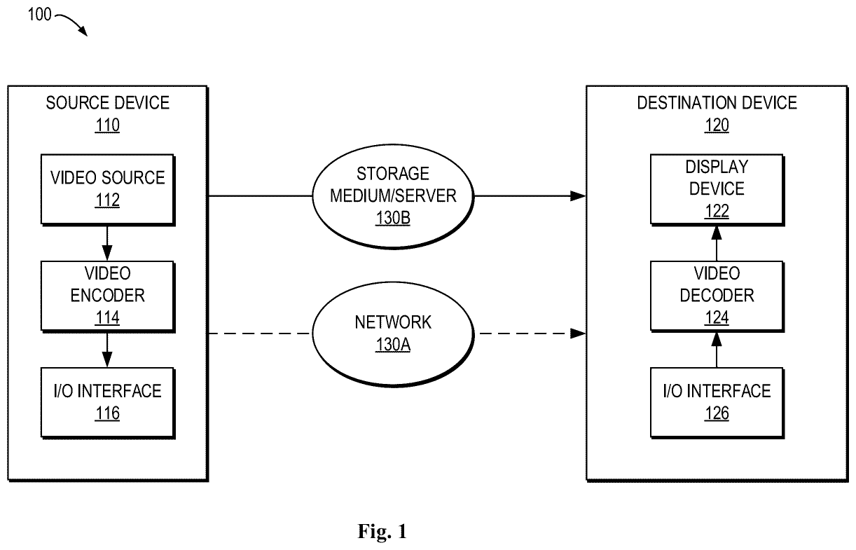

FIG. 1 is a block diagram that illustrates an example video coding system 100 that may utilize the techniques of this disclosure. As shown, the video coding system 100 may include a source device 110 and a destination device 120. The source device 110 can be also referred to as a video encoding device, and the destination device 120 can be also referred to as a video decoding device. In operation, the source device 110 can be configured to generate encoded video data and the destination device 120 can be configured to decode the encoded video data generated by the source device 110. The source device 110 may include a video source 112, a video encoder 114, and an input/output (I/O) interface 116.

The video source 112 may include a source such as a video capture device. Examples of the video capture device include, but are not limited to, an interface to receive video data from a video content provider, a computer graphics system for generating video data, and/or a combination thereof.

The video data may comprise one or more pictures. The video encoder 114 encodes the video data from the video source 112 to generate a bitstream. The bitstream may include a sequence of bits that form a coded representation of the video data. The bitstream may include coded pictures and associated data. The coded picture is a coded representation of a picture. The associated data may include sequence parameter sets, picture parameter sets, and other syntax structures. The I/O interface 116 may include a modulator/demodulator and/or a transmitter. The encoded video data may be transmitted directly to destination device 120 via the I/O interface 116 through the network 130A. The encoded video data may also be stored onto a storage medium/server 130B for access by destination device 120.

The destination device 120 may include an I/O interface 126, a video decoder 124, and a display device 122. The I/O interface 126 may include a receiver and/or a modem. The I/O interface 126 may acquire encoded video data from the source device 110 or the storage medium/server 130B. The video decoder 124 may decode the encoded video data. The display device 122 may display the decoded video data to a user. The display device 122 may be integrated with the destination device 120, or may be external to the destination device 120 which is configured to interface with an external display device.

The video encoder 114 and the video decoder 124 may operate according to a video compression standard, such as the High Efficiency Video Coding (HEVC) standard, Versatile Video Coding (VVC) standard and other current and/or further standards.

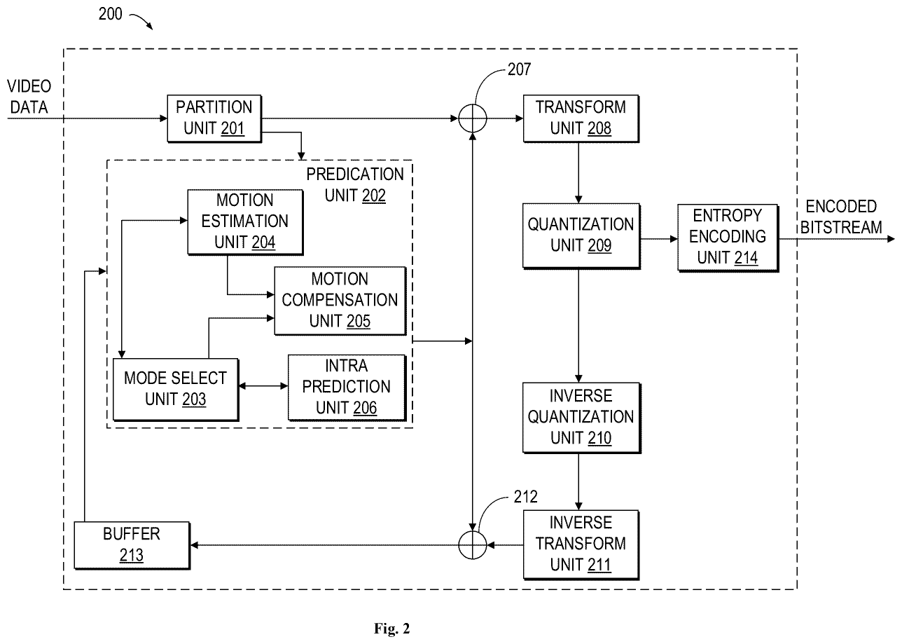

FIG. 2 is a block diagram illustrating an example of a video encoder 200, which may be an example of the video encoder 114 in the system 100 illustrated in FIG. 1, in accordance with some embodiments of the present disclosure.

The video encoder 200 may be configured to implement any or all of the techniques of this disclosure. In the example of FIG. 2, the video encoder 200 includes a plurality of functional components. The techniques described in this disclosure may be shared among the various components of the video encoder 200. In some examples, a processor may be configured to perform any or all of the techniques described in this disclosure.

In some embodiments, the video encoder 200 may include a partition unit 201, a prediction unit 202 which may include a mode select unit 203, a motion estimation unit 204, a motion compensation unit 205 and an intra-prediction unit 206, a residual generation unit 207, a transform unit 208, a quantization unit 209, an inverse quantization unit 210, an inverse transform unit 211, a reconstruction unit 212, a buffer 213, and an entropy encoding unit 214.

In other examples, the video encoder 200 may include more, fewer, or different functional components. In an example, the prediction unit 202 may include an intra block copy (IBC) unit. The IBC unit may perform prediction in an IBC mode in which at least one reference picture is a picture where the current video block is located.

Furthermore, although some components, such as the motion estimation unit 204 and the motion compensation unit 205, may be integrated, but are represented in the example of FIG. 2 separately for purposes of explanation.

The partition unit 201 may partition a picture into one or more video blocks. The video encoder 200 and the video decoder 300 may support various video block sizes.

The mode select unit 203 may select one of the coding modes, intra or inter, e.g., based on error results, and provide the resulting intra-coded or inter-coded block to a residual generation unit 207 to generate residual block data and to a reconstruction unit 212 to reconstruct the encoded block for use as a reference picture. In some examples, the mode select unit 203 may select a combination of intra and inter prediction (CIIP) mode in which the prediction is based on an inter prediction signal and an intra prediction signal. The mode select unit 203 may also select a resolution for a motion vector (e.g., a sub-pixel or integer pixel precision) for the block in the case of inter-prediction.

To perform inter prediction on a current video block, the motion estimation unit 204 may generate motion information for the current video block by comparing one or more reference frames from buffer 213 to the current video block. The motion compensation unit 205 may determine a predicted video block for the current video block based on the motion information and decoded samples of pictures from the buffer 213 other than the picture associated with the current video block.

The motion estimation unit 204 and the motion compensation unit 205 may perform different operations for a current video block, for example, depending on whether the current video block is in an I-slice, a P-slice, or a B-slice. As used herein, an “I-slice” may refer to a portion of a picture composed of macroblocks, all of which are based upon macroblocks within the same picture. Further, as used herein, in some aspects, “P-slices” and “B-slices” may refer to portions of a picture composed of macroblocks that are not dependent on macroblocks in the same picture.

In some examples, the motion estimation unit 204 may perform uni-directional prediction for the current video block, and the motion estimation unit 204 may search reference pictures of list 0 or list 1 for a reference video block for the current video block. The motion estimation unit 204 may then generate a reference index that indicates the reference picture in list 0 or list 1 that contains the reference video block and a motion vector that indicates a spatial displacement between the current video block and the reference video block. The motion estimation unit 204 may output the reference index, a prediction direction indicator, and the motion vector as the motion information of the current video block. The motion compensation unit 205 may generate the predicted video block of the current video block based on the reference video block indicated by the motion information of the current video block.

Alternatively, in other examples, the motion estimation unit 204 may perform bi-directional prediction for the current video block. The motion estimation unit 204 may search the reference pictures in list 0 for a reference video block for the current video block and may also search the reference pictures in list 1 for another reference video block for the current video block. The motion estimation unit 204 may then generate reference indexes that indicate the reference pictures in list 0 and list 1 containing the reference video blocks and motion vectors that indicate spatial displacements between the reference video blocks and the current video block. The motion estimation unit 204 may output the reference indexes and the motion vectors of the current video block as the motion information of the current video block. The motion compensation unit 205 may generate the predicted video block of the current video block based on the reference video blocks indicated by the motion information of the current video block.

In some examples, the motion estimation unit 204 may output a full set of motion information for decoding processing of a decoder. Alternatively, in some embodiments, the motion estimation unit 204 may signal the motion information of the current video block with reference to the motion information of another video block. For example, the motion estimation unit 204 may determine that the motion information of the current video block is sufficiently similar to the motion information of a neighboring video block.

In one example, the motion estimation unit 204 may indicate, in a syntax structure associated with the current video block, a value that indicates to the video decoder 300 that the current video block has the same motion information as the another video block.

In another example, the motion estimation unit 204 may identify, in a syntax structure associated with the current video block, another video block and a motion vector difference (MVD). The motion vector difference indicates a difference between the motion vector of the current video block and the motion vector of the indicated video block. The video decoder 300 may use the motion vector of the indicated video block and the motion vector difference to determine the motion vector of the current video block.

As discussed above, video encoder 200 may predictively signal the motion vector. Two examples of predictive signaling techniques that may be implemented by video encoder 200 include advanced motion vector prediction (AMVP) and merge mode signaling.

The intra prediction unit 206 may perform intra prediction on the current video block. When the intra prediction unit 206 performs intra prediction on the current video block, the intra prediction unit 206 may generate prediction data for the current video block based on decoded samples of other video blocks in the same picture. The prediction data for the current video block may include a predicted video block and various syntax elements.

The residual generation unit 207 may generate residual data for the current video block by subtracting (e.g., indicated by the minus sign) the predicted video block(s) of the current video block from the current video block. The residual data of the current video block may include residual video blocks that correspond to different sample components of the samples in the current video block.

In other examples, there may be no residual data for the current video block for the current video block, for example in a skip mode, and the residual generation unit 207 may not perform the subtracting operation.

The transform processing unit 208 may generate one or more transform coefficient video blocks for the current video block by applying one or more transforms to a residual video block associated with the current video block.

After the transform processing unit 208 generates a transform coefficient video block associated with the current video block, the quantization unit 209 may quantize the transform coefficient video block associated with the current video block based on one or more quantization parameter (QP) values associated with the current video block.

The inverse quantization unit 210 and the inverse transform unit 211 may apply inverse quantization and inverse transforms to the transform coefficient video block, respectively, to reconstruct a residual video block from the transform coefficient video block. The reconstruction unit 212 may add the reconstructed residual video block to corresponding samples from one or more predicted video blocks generated by the prediction unit 202 to produce a reconstructed video block associated with the current video block for storage in the buffer 213.

After the reconstruction unit 212 reconstructs the video block, loop filtering operation may be performed to reduce video blocking artifacts in the video block.

The entropy encoding unit 214 may receive data from other functional components of the video encoder 200. When the entropy encoding unit 214 receives the data, the entropy encoding unit 214 may perform one or more entropy encoding operations to generate entropy encoded data and output a bitstream that includes the entropy encoded data.

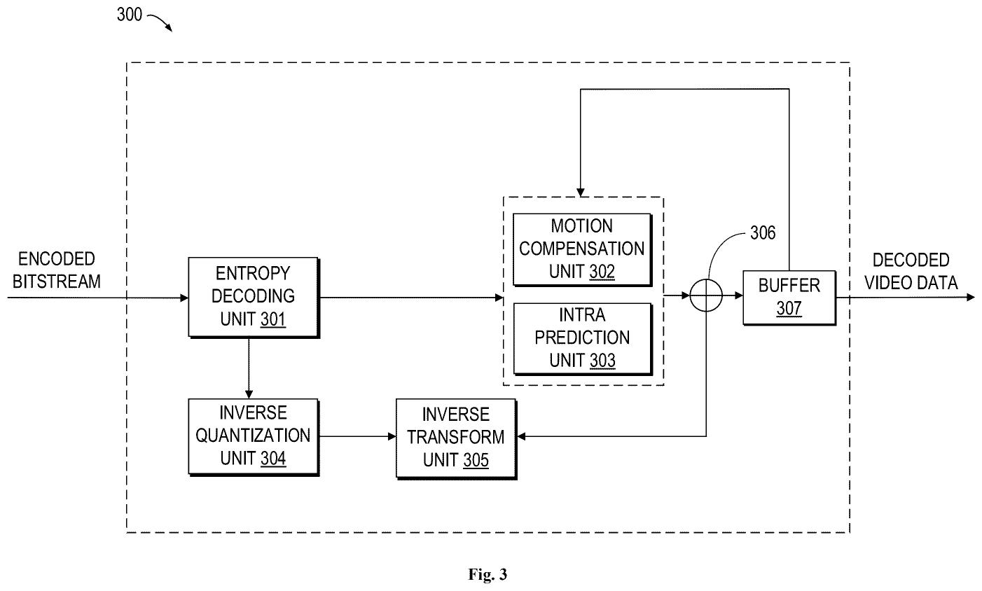

FIG. 3 is a block diagram illustrating an example of a video decoder 300, which may be an example of the video decoder 124 in the system 100 illustrated in FIG. 1, in accordance with some embodiments of the present disclosure.

The video decoder 300 may be configured to perform any or all of the techniques of this disclosure. In the example of FIG. 3, the video decoder 300 includes a plurality of functional components. The techniques described in this disclosure may be shared among the various components of the video decoder 300. In some examples, a processor may be configured to perform any or all of the techniques described in this disclosure.

In the example of FIG. 3, the video decoder 300 includes an entropy decoding unit 301, a motion compensation unit 302, an intra prediction unit 303, an inverse quantization unit 304, an inverse transformation unit 305, and a reconstruction unit 306 and a buffer 307. The video decoder 300 may, in some examples, perform a decoding pass generally reciprocal to the encoding pass described with respect to video encoder 200.

The entropy decoding unit 301 may retrieve an encoded bitstream. The encoded bitstream may include entropy coded video data (e.g., encoded blocks of video data). The entropy decoding unit 301 may decode the entropy coded video data, and from the entropy decoded video data, the motion compensation unit 302 may determine motion information including motion vectors, motion vector precision, reference picture list indexes, and other motion information. The motion compensation unit 302 may, for example, determine such information by performing the AMVP and merge mode. AMVP is used, including derivation of several most probable candidates based on data from adjacent PBs and the reference picture. Motion information typically includes the horizontal and vertical motion vector displacement values, one or two reference picture indices, and, in the case of prediction regions in B slices, an identification of which reference picture list is associated with each index. As used herein, in some aspects, a “merge mode” may refer to deriving the motion information from spatially or temporally neighboring blocks.

The motion compensation unit 302 may produce motion compensated blocks, possibly performing interpolation based on interpolation filters. Identifiers for interpolation filters to be used with sub-pixel precision may be included in the syntax elements.

The motion compensation unit 302 may use the interpolation filters as used by the video encoder 200 during encoding of the video block to calculate interpolated values for sub-integer pixels of a reference block. The motion compensation unit 302 may determine the interpolation filters used by the video encoder 200 according to the received syntax information and use the interpolation filters to produce predictive blocks.

The motion compensation unit 302 may use at least part of the syntax information to determine sizes of blocks used to encode frame(s) and/or slice(s) of the encoded video sequence, partition information that describes how each macroblock of a picture of the encoded video sequence is partitioned, modes indicating how each partition is encoded, one or more reference frames (and reference frame lists) for each inter-encoded block, and other information to decode the encoded video sequence. As used herein, in some aspects, a “slice” may refer to a data structure that can be decoded independently from other slices of the same picture, in terms of entropy coding, signal prediction, and residual signal reconstruction. A slice can either be an entire picture or a region of a picture.

The intra prediction unit 303 may use intra prediction modes for example received in the bitstream to form a prediction block from spatially adjacent blocks. The inverse quantization unit 304 inverse quantizes, i.e., de-quantizes, the quantized video block coefficients provided in the bitstream and decoded by entropy decoding unit 301. The inverse transform unit 305 applies an inverse transform.

The reconstruction unit 306 may obtain the decoded blocks, e.g., by summing the residual blocks with the corresponding prediction blocks generated by the motion compensation unit 302 or intra-prediction unit 303. If desired, a deblocking filter may also be applied to filter the decoded blocks in order to remove blockiness artifacts. The decoded video blocks are then stored in the buffer 307, which provides reference blocks for subsequent motion compensation/intra prediction and also produces decoded video for presentation on a display device.

Some exemplary embodiments of the present disclosure will be described in detailed hereinafter. It should be understood that section headings are used in the present document to facilitate ease of understanding and do not limit the embodiments disclosed in a section to only that section. Furthermore, while certain embodiments are described with reference to Versatile Video Coding or other specific video codecs, the disclosed techniques are applicable to other video coding technologies also. Furthermore, while some embodiments describe video coding steps in detail, it will be understood that corresponding steps decoding that undo the coding will be implemented by a decoder. Furthermore, the term video processing encompasses video coding or compression, video decoding or decompression and video transcoding in which video pixels are represented from one compressed format into another compressed format or at a different compressed bitrate.

### 1. BRIEF SUMMARY

This disclosure is related to video coding technologies. Specifically, it is related a coding tool that partitions blocks in different sub-structures and shapes for multiple coding tools in a component of a frame for a better coding efficiency. It may be applied to the existing video coding standard like HEVC, or Versatile Video Coding (VVC). It may be also applicable to future video coding standards or video codec.

### 2. INTRODUCTION

Video coding standards have evolved primarily through the development of the well-known ITU-T and ISO/IEC standards. The ITU-T produced H.261 and H.263, ISO/IEC produced MPEG-1 and MPEG-4 Visual, and the two organizations jointly produced the H.262/MPEG-2 Video and H.264/MPEG-4 Advanced Video Coding (AVC) and H.265/HEVC standards. Since H.262, the video coding standards are based on the hybrid video coding structure wherein temporal prediction plus transform coding are utilized. To explore the future video coding technologies beyond HEVC, Joint Video Exploration Team (JVET) was founded by VCEG and MPEG jointly in 2015. Since then, many new methods have been adopted by JVET and put into the reference software named Joint Exploration Model (JEM). In April 2018, the Joint Video Expert Team (JVET) between VCEG (Q6/16) and ISO/IEC JTC1 SC29/WG11 (MPEG) was created to work on the VVC standard targeting at 50% bitrate reduction compared to HEVC.

### 2.1. Color Space and Chroma Subsampling

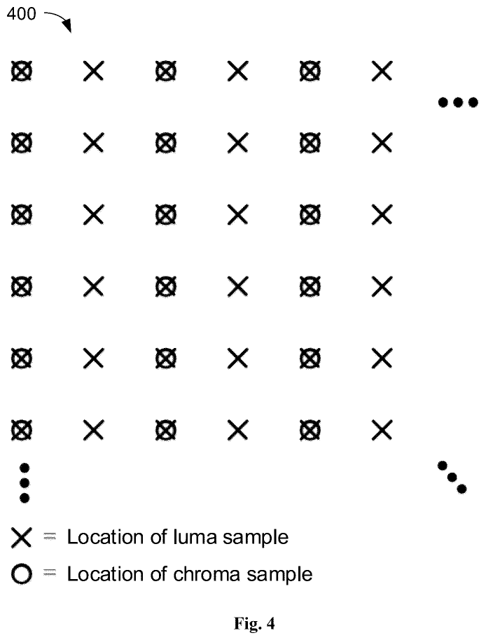

Color space, also known as the color model (or color system), is an abstract mathematical model which simply describes the range of colors as tuples of numbers, typically as 3 or 4 values or color components (e.g. RGB). Basically speaking, color space is an elaboration of the coordinate system and sub-space.
For video compression, the most frequently used color spaces are YCbCr and RGB.
YCbCr, Y′CbCr, or Y Pb/Cb Pr/Cr, also written as YCBCR or Y′CBCR, is a family of color spaces used as a part of the color image pipeline in video and digital photography systems. Y′ is the luma component and CB and CR are the blue-difference and red-difference chroma components. Y′ (with prime) is distinguished from Y, which is luminance, meaning that light intensity is nonlinearly encoded based on gamma corrected RGB primaries.
Chroma subsampling is the practice of encoding images by implementing less resolution for chroma information than for luma information, taking advantage of the human visual system's lower acuity for color differences than for luminance.
2.1.1. 4:4:4
Each of the three Y′CbCr components have the same sample rate, thus there is no chroma subsampling. This scheme is sometimes used in high-end film scanners and cinematic post production.
2.1.2. 4:2:2
The two chroma components are sampled at half the sample rate of luma: the horizontal chroma resolution is halved while the vertical chroma resolution is unchanged. This reduces the bandwidth of an uncompressed video signal by one-third with little to no visual difference. An example of nominal vertical and horizontal locations of 4:2:2 color format is depicted in FIG. 4 in VVC working draft. FIG. 4 illustrates nominal vertical and horizontal locations of 4:2:2 luma and chroma samples in a picture.
2.1.3. 4:2:0
In 4:2:0, the horizontal sampling is doubled compared to 4:1:1, but as the Cb and Cr channels are only sampled on each alternate line in this scheme, the vertical resolution is halved. The data rate is thus the same. Cb and Cr are each subsampled at a factor of 2 both horizontally and vertically. There are three variants of 4:2:0 schemes, having different horizontal and vertical siting.
In MPEG-2, Cb and Cr are cosited horizontally. Cb and Cr are sited between pixels in the vertical direction (sited interstitially).
In JPEG/JFIF, H.261, and MPEG-1, Cb and Cr are sited interstitially, halfway between alternate luma samples.
In 4:2:0 DV, Cb and Cr are co-sited in the horizontal direction. In the vertical direction, they are co-sited on alternating lines.

TABLE 1
SubWidthC and SubHeightC values derived from chroma_{—}
format_idc and separate_colour_plane_flag

| chroma_format_idc | separate_colour_plane_flag | Chroma format | SubWidthC | SubHeightC |
|---|---|---|---|---|
| 0 | 0 | Monochrome | 1 | 1 |
| 1 | 0 | 4:2:0 | 2 | 2 |
| 2 | 0 | 4:2:2 | 2 | 1 |
| 3 | 0 | 4:4:4 | 1 | 1 |
| 3 | 1 | 4:4:4 | 1 | 1 |

### 2.2. Coding Flow of a Typical Video Codec

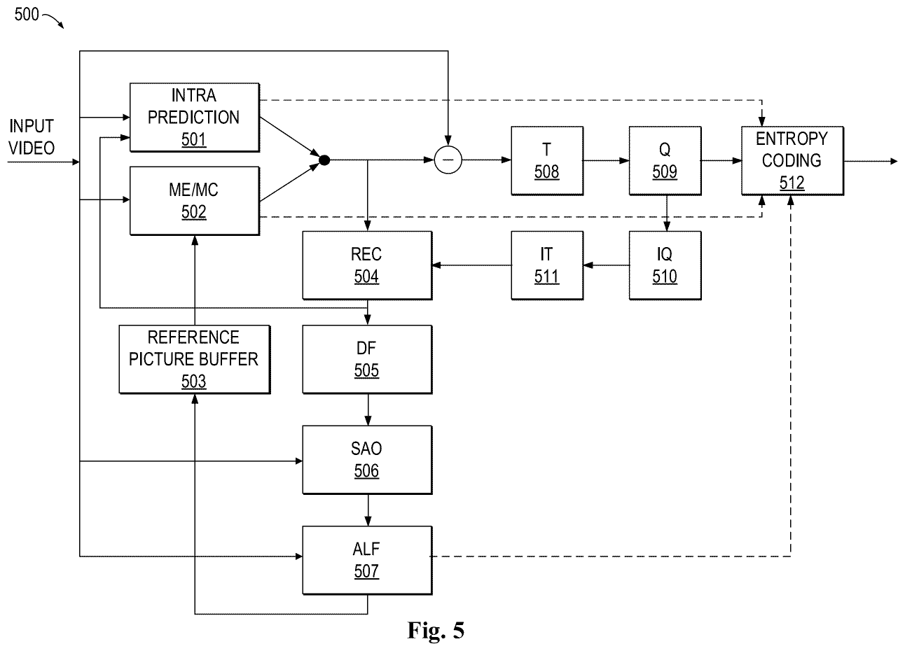

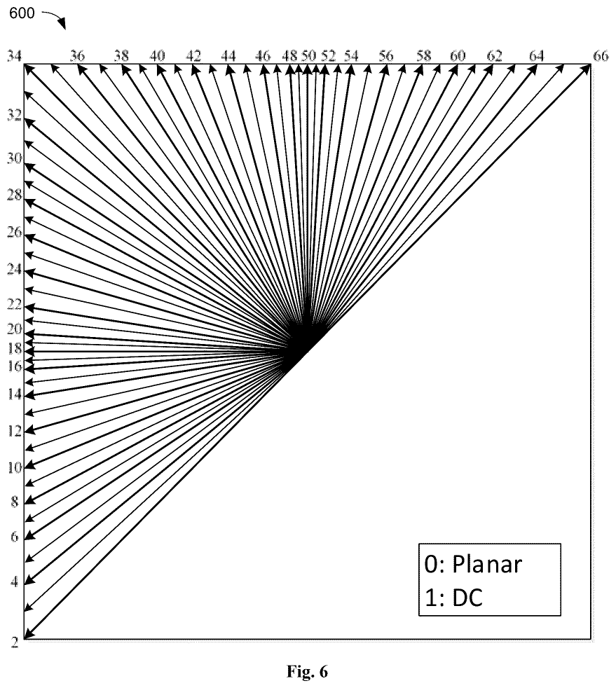

FIG. 5 illustrates example of encoder block diagram. FIG. 5 shows an example of encoder block diagram of VVC, which contains three in-loop filtering blocks: deblocking filter (DF), sample adaptive offset (SAO) and ALF. Unlike DF, which uses predefined filters, SAO and ALF utilize the original samples of the current picture to reduce the mean square errors between the original samples and the reconstructed samples by adding an offset and by applying a finite impulse response (FIR) filter, respectively, with coded side information signalling the offsets and filter coefficients. ALF is located at the last processing stage of each picture and can be regarded as a tool trying to catch and fix artifacts created by the previous stages.
2.3. Intra Mode Coding with 67 Intra Prediction Modes
FIG. 6 illustrates 67 intra prediction modes. To capture the arbitrary edge directions presented in natural video, the number of directional intra modes is extended from 33, as used in HEVC, to 65, as shown in FIG. 6, and the planar and DC modes remain the same. These denser directional intra prediction modes apply for all block sizes and for both luma and chroma intra predictions.
In the HEVC, every intra-coded block has a square shape and the length of each of its side is a power of 2. Thus, no division operations are required to generate an intra-predictor using DC mode. In VVC, blocks can have a rectangular shape that necessitates the use of a division operation per block in the general case. To avoid division operations for DC prediction, only the longer side is used to compute the average for non-square blocks.

### 2.3.1. Wide Angle Intra Prediction

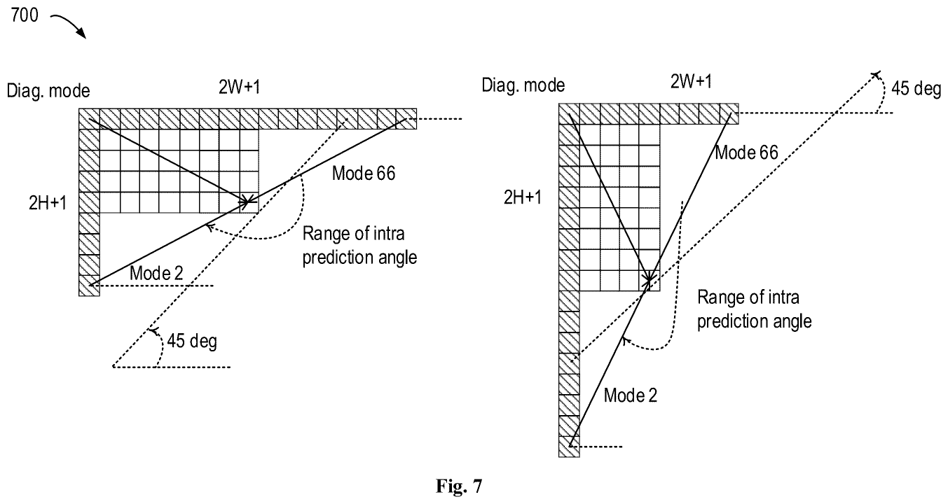

Although 67 modes are defined in the VVC, the exact prediction direction for a given intra prediction mode index is further dependent on the block shape. Conventional angular intra prediction directions are defined from 45 degrees to −135 degrees in clockwise direction. In VVC, several conventional angular intra prediction modes are adaptively replaced with wide-angle intra prediction modes for non-square blocks. The replaced modes are signalled using the original mode indexes, which are remapped to the indexes of wide angular modes after parsing. The total number of intra prediction modes is unchanged, i.e., 67, and the intra mode coding method is unchanged. FIG. 7 illustrates reference samples for wide-angular intra prediction. To support these prediction directions, the top reference with length 2W+1, and the left reference with length 2H+1, are defined as shown in FIG. 7.
The number of replaced modes in wide-angular direction mode depends on the aspect ratio of a block. The replaced intra prediction modes are illustrated in Table 2.

TABLE 2
Intra prediction modes replaced by wide-angular modes

| Aspect ratio | Replaced intra prediction modes |
|---|---|
| W/H == 16 | Modes 2, 3, 4, 5, 6, 7, 8, 9, 10, 11, 12, 13, 14, 15 |
| W/H == 8 | Modes 2, 3, 4, 5, 6, 7, 8, 9, 10, 11, 12, 13 |
| W/H == 4 | Modes 2, 3, 4, 5, 6, 7, 8, 9, 10, 11 |
| W/H == 2 | Modes 2, 3, 4, 5, 6, 7, 8, 9 |
| W/H == 1 | None |
| W/H == ½ | Modes 59, 60, 61, 62, 63, 64, 65, 66 |
| W/H == ¼ | Mode 57, 58, 59, 60, 61, 62, 63, 64, 65, 66 |
| W/H == ⅛ | Modes 55, 56, 57, 58, 59, 60, 61, 62, 63, 64, 65, 66 |
| W/H == 1/16 | Modes 53, 54, 55, 56, 57, 58, 59, 60, 61, 62, 63, 64, 65, 66 |

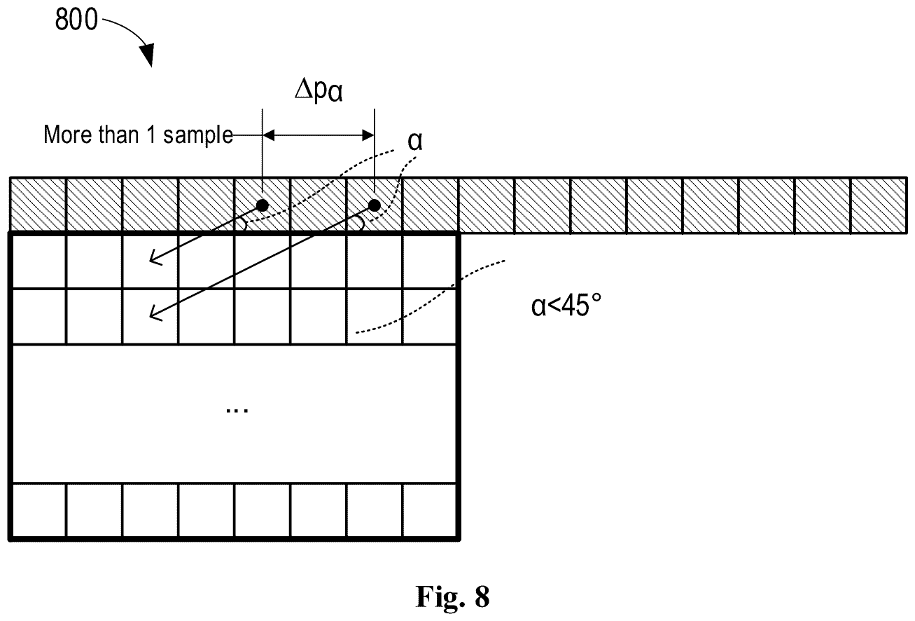

FIG. 8 illustrates problem of discontinuity in case of directions beyond 45°. As shown in FIG. 8, two vertically adjacent predicted samples may use two non-adjacent reference samples in the case of wide-angle intra prediction. Hence, low-pass reference samples filter and side smoothing are applied to the wide-angle prediction to reduce the negative effect of the increased gap Δp_{α}. If a wide-angle mode represents a non-fractional offset. There are 8 modes in the wide-angle modes satisfy this condition, which are [−14, −12, −10, −6, 72, 76, 78, 80]. When a block is predicted by these modes, the samples in the reference buffer are directly copied without applying any interpolation. With this modification, the number of samples needed to be smoothing is reduced. Besides, it aligns the design of non-fractional modes in the conventional prediction modes and wide-angle modes.
In VVC, 4:2:2 and 4:4:4 chroma formats are supported as well as 4:2:0. Chroma derived mode (DM) derivation table for 4:2:2 chroma format was initially ported from HEVC extending the number of entries from 35 to 67 to align with the extension of intra prediction modes. Since HEVC specification does not support prediction angle below −135 degree and above 45 degree, luma intra prediction modes ranging from 2 to 5 are mapped to 2. Therefore, chroma DM derivation table for 4:2:2: chroma format is updated by replacing some values of the entries of the mapping table to convert prediction angle more precisely for chroma blocks.

### 2.4. Intra Prediction Mode Coding for Chroma Component

For the chroma component of an intra PU, the encoder selects the best chroma prediction modes among five modes including Planar, DC, Horizontal, Vertical and a direct copy of the intra prediction mode for the luma component. The mapping between intra prediction direction and intra prediction mode number for chroma is shown in Table 3.
When the intra prediction mode number for the chroma component is 4, the intra prediction direction for the luma component is used for the intra prediction sample generation for the chroma component. When the intra prediction mode number for the chroma component is not 4 and it is identical to the intra prediction mode number for the luma component, the intra prediction direction of 66 is used for the intra prediction sample generation for the chroma component.

### 2.5. Inter Prediction

For each inter-predicted CU, motion parameters consisting of motion vectors, reference picture indices and reference picture list usage index, and additional information needed for the new coding feature of VVC to be used for inter-predicted sample generation. The motion parameter can be signalled in an explicit or implicit manner. When a CU is coded with skip mode, the CU is associated with one PU and has no significant residual coefficients, no coded motion vector delta or reference picture index. A merge mode is specified whereby the motion parameters for the current CU are obtained from neighbouring CUs, including spatial and temporal candidates, and additional schedules introduced in VVC. The merge mode can be applied to any inter-predicted CU, not only for skip mode. The alternative to merge mode is the explicit transmission of motion parameters, where motion vector, corresponding reference picture index for each reference picture list and reference picture list usage flag and other needed information are signalled explicitly per each CU.

### 2.6. Intra Block Copy (IBC)

Intra block copy (IBC) is a tool adopted in HEVC extensions on SCC. It is well known that it significantly improves the coding efficiency of screen content materials. Since IBC mode is implemented as a block level coding mode, block matching (BM) is performed at the encoder to find the optimal block vector (or motion vector) for each CU. Here, a block vector is used to indicate the displacement from the current block to a reference block, which is already reconstructed inside the current picture. The luma block vector of an IBC-coded CU is in integer precision. The chroma block vector rounds to integer precision as well. When combined with AMVR, the IBC mode can switch between 1-pel and 4-pel motion vector precisions. An IBC-coded CU is treated as the third prediction mode other than intra or inter prediction modes. The IBC mode is applicable to the CUs with both width and height smaller than or equal to 64 luma samples.
At the encoder side, hash-based motion estimation is performed for IBC. The encoder performs RD check for blocks with either width or height no larger than 16 luma samples. For non-merge mode, the block vector search is performed using hash-based search first. If hash search does not return valid candidate, block matching based local search will be performed.
In the hash-based search, hash key matching (32-bit CRC) between the current block and a reference block is extended to all allowed block sizes. The hash key calculation for every position in the current picture is based on 4×4 sub-blocks. For the current block of a larger size, a hash key is determined to match that of the reference block when all the hash keys of all 4×4 sub-blocks match the hash keys in the corresponding reference locations. If hash keys of multiple reference blocks are found to match that of the current block, the block vector costs of each matched reference are calculated and the one with the minimum cost is selected.
In block matching search, the search range is set to cover both the previous and current CTUs.
At CU level, IBC mode is signalled with a flag and it can be signalled as IBC AMVP mode or IBC skip/merge mode as follows:
IBC skip/merge mode: a merge candidate index is used to indicate which of the block vectors in the list from neighbouring candidate IBC coded blocks is used to predict the current block. The merge list consists of spatial, HMVP, and pairwise candidates.
IBC AMVP mode: block vector difference is coded in the same way as a motion vector difference. The block vector prediction method uses two candidates as predictors, one from left neighbour and one from above neighbour (if IBC coded). When either neighbour is not available, a default block vector will be used as a predictor. A flag is signalled to indicate the block vector predictor index.

### 2.7. Cross-Component Linear Model Prediction

To reduce the cross-component redundancy, a cross-component linear model (CCLM) prediction mode is used in the VVC, for which the chroma samples are predicted based on the reconstructed luma samples of the same CU by using a linear model as follows:

$${pred}_{C} ( i , j ) = α \cdot {rec}_{L}^{′} ( i , j ) + β \qquad ( 2 - 1 )$$

where pred_{C}(i, j) represents the predicted chroma samples in a CU and rec_{L}(i, j) represents the down-sampled reconstructed luma samples of the same CU.
The CCLM parameters (α and β) are derived with at most four neighbouring chroma samples and their corresponding down-sampled luma samples. Suppose the current chroma block dimensions are W×H, then W″ and H′ are set as:
W′=W, H′=H when LM mode is applied;
W′=W+H when LM_T mode is applied;
H′=H+W when LM_L mode is applied.
   The above neighbouring positions are denoted as S[0, −1] . . . S[W′−1, −1] and the left neighbouring positions are denoted as S[−1, 0] . . . S[−1, H′−1]. Then the four samples are selected as:
S[W′/4, −1], S[3*W′/4, −1], S[−1, H′/4], S[−1, 3*H′/4] when LM mode is applied and both above and left neighbouring samples are available;
S[W′/8, −1], S[3*W′/8, −1], S[5*W′/8, −1], S[7*W′/8, −1] when LM_T mode is applied or only the above neighbouring samples are available;
S[−1, H′/8], S[−1, 3*H′/8], S[−1, 5*H′/8], S[−1, 7*H′/8] when LM_L mode is applied or only the left neighbouring samples are available.
   The four neighbouring luma samples at the selected positions are down-sampled and compared four times to find two larger values: x⁰_{A} and x¹_{A}, and two smaller values: x⁰_{B} and x¹_{B}. Their corresponding chroma sample values are denoted as y⁰_{A}, y¹_{A}, y⁰_{B} and y¹_{B}. Then x_{A}, x_{B}, y_{A} and y_{B} are derived as:

$${X}_{a} = ( {x}_{A}^{0} + {x}_{A}^{1} + 1 ) >> 1 ; {X}_{b} = ( {x}_{B}^{0} + {x}_{B}^{1} + 1 ) >> 1 ; {Y}_{a} = ( {y}_{A}^{0} + {y}_{A}^{1} + 1 ) >> 1 ; {Y}_{b} = ( {y}_{B}^{0} + {y}_{B}^{1} + 1 ) >> 1 \qquad ( 2 - 2 )$$

Finally, the linear model parameters α and β are obtained according to the following equations.

$$α = \frac{{Y}_{a} - {Y}_{b}}{{X}_{a} - {X}_{b}} \qquad ( 2 - 3 )$$

$$β = {Y}_{b} - α \cdot {X}_{b} \qquad ( 2 - 4 )$$

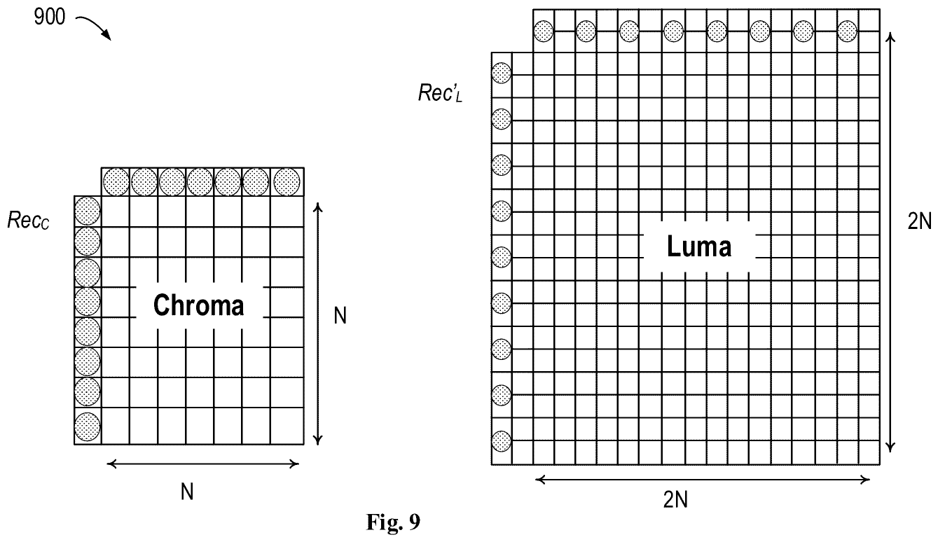

FIG. 9 shows an example of the location of the left and above samples and the sample of the current block involved in the CCLM mode. FIG. 9 illustrates locations of the samples used for the derivation of α and β.
The division operation to calculate parameter α is implemented with a look-up table. To reduce the memory required for storing the table, the diff value (difference between maximum and minimum values) and the parameter α are expressed by an exponential notation. For example, diff is approximated with a 4-bit significant part and an exponent. Consequently, the table for 1/diff is reduced into 16 elements for 16 values of the significand as follows:

$$DivTable [ ] = \{ 0 , 7 , 6 , 5 , 5 , 4 , 4 , 3 , 3 , 2 , 2 , 1 , 1 , 1 , 1 , 0 \} \qquad ( 2 - 5 )$$

This would have a benefit of both reducing the complexity of the calculation as well as the memory size required for storing the needed tables.
Besides the above template and left template can be used to calculate the linear model coefficients together, they also can be used alternatively in the other 2 LM modes, called LM_T, and LM_L modes.
In LM_T mode, only the above template is used to calculate the linear model coefficients. To get more samples, the above template is extended to (W+H) samples. In LM_L mode, only left template is used to calculate the linear model coefficients. To get more samples, the left template is extended to (H+W) samples.
In LM mode, left and above templates are used to calculate the linear model coefficients.
To match the chroma sample locations for 4:2:0 video sequences, two types of down-sampling filter are applied to luma samples to achieve 2 to 1 down-sampling ratio in both horizontal and vertical directions. The selection of down-sampling filter is specified by a SPS level flag. The two down-sampling filters are as follows, which are corresponding to “type-0” and “type-2” content, respectively.

$${Rec}_{L}^{′} ( i , j ) = [ \begin{matrix}{rec}_{L} ( 2 i - 1 , 2 j - 1 ) + 2 \cdot {rec}_{L} ( 2 i - 1 , 2 j - 1 ) + {rec}_{L} ( 2 i + 1 , 2 j - 1 ) + \\ {rec}_{L} ( 2 i - 1 , 2 j ) + 2 \cdot {rec}_{L} ( 2 i , 2 j ) + {rec}_{L} ( 2 i + 1 , 2 j ) + 4\end{matrix} ] ≫ 3 \qquad ( 2 - 6 )$$

$${rec}_{L}^{′} ( i , j ) = [ \begin{matrix}r e {c}_{L} ( 2 i , 2 j - 1 ) + re {c}_{L} ( 2 i - 1 , 2 j ) + 4 \cdot {rec}_{L} ( 2 i , 2 j ) + \\ {rec}_{L} ( 2 i + 1 , 2 j ) + {rec}_{L} ( 2 i , 2 j + 1 ) + 4\end{matrix} ] ≫ 3 \qquad ( 2 - 7 )$$

Note that only one luma line (general line buffer in intra prediction) is used to make the down-sampled luma samples when the upper reference line is at the CTU boundary.
This parameter computation is performed as part of the decoding process, and is not just as an encoder search operation. As a result, no syntax is used to convey the α and β values to the decoder.
For chroma intra mode coding, a total of 8 intra modes are allowed for chroma intra mode coding. Those modes include five conventional intra modes and three cross-component linear model modes (LM, LM_T, and LM_L). Chroma mode signalling and derivation process are shown in Table 3. Chroma mode coding directly depends on the intra prediction mode of the corresponding luma block. Since separate block partitioning structure for luma and chroma components is enabled in I slices, one chroma block may correspond to multiple luma blocks. Therefore, for Chroma DM mode, the intra prediction mode of the corresponding luma block covering the center position of the current chroma block is directly inherited.

TABLE 3
Derivation of chroma prediction mode
from luma mode when CCLM is enabled

| Chroma | Corresponding luma intra prediction mode | | | | |
|---|---|---|---|---|---|
| prediction | | | | | X (0 <= |
| mode | 0 | 50 | 18 | 1 | X <= 66) |
| 0 | 66 | 0 | 0 | 0 | 0 |
| 1 | 50 | 66 | 50 | 50 | 50 |
| 2 | 18 | 18 | 66 | 18 | 18 |
| 3 | 1 | 1 | 1 | 66 | 1 |
| 4 | 0 | 50 | 18 | 1 | X |
| 5 | 81 | 81 | 81 | 81 | 81 |
| 6 | 82 | 82 | 82 | 82 | 82 |
| 7 | 83 | 83 | 83 | 83 | 83 |

A single binarization table is used regardless of the value of sps_cclm_enabled_flag as shown in Table 4.

TABLE 4
Unified binarization table for chroma prediction mode

| Value of | Bin |
|---|---|
| intra_chroma_pred_mode | string |
| 4 | 00 |
| 0 | 0100 |
| 1 | 0101 |
| 2 | 0110 |
| 3 | 0111 |
| 5 | 10 |
| 6 | 110 |
| 7 | 111 |

In Table 4, the first bin indicates whether it is regular (0) or LM modes (1). If it is LM mode, then the next bin indicates whether it is LM_CHROMA (0) or not. If it is not LM_CHROMA, next 1 bin indicates whether it is LM_L (0) or LM_T (1). For this case, when sps_cclm_enabled_flag is 0, the first bin of the binarization table for the corresponding intra_chroma_pred_mode can be discarded prior to the entropy coding. Or, in other words, the first bin is inferred to be 0 and hence not coded. This single binarization table is used for both sps_cclm_enabled_flag equal to 0 and 1 cases. The first two bins in Table 4 are context coded with its own context model, and the rest bins are bypass coded.
In addition, in order to reduce luma-chroma latency in dual tree, when the 64×64 luma coding tree node is partitioned with Not Split (and ISP is not used for the 64×64 CU) or QT, the chroma CUs in 32×32/32×16 chroma coding tree node is allowed to use CCLM in the following way:
If the 32×32 chroma node is not split or partitioned QT split, all chroma CUs in the 32×32 node can use CCLM.
If the 32×32 chroma node is partitioned with Horizontal BT, and the 32×16 child node does not split or uses Vertical BT split, all chroma CUs in the 32×16 chroma node can use CCLM.
   In all the other luma and chroma coding tree split conditions, CCLM is not allowed for chroma CU.

### 2.8. Gradient Linear Model (GLM)

Compared with CCLM, instead of downsampled luma values, the GLM utilizes luma sample gradients to derive the linear model. In other words, rather than the low-pass filtered luma sample, a gradient G is replaced in the CCLM process. The other designs of CCLM (e.g., parameter derivation, prediction sample linear transform) are kept unchanged.

$$C = α \cdot G + β$$

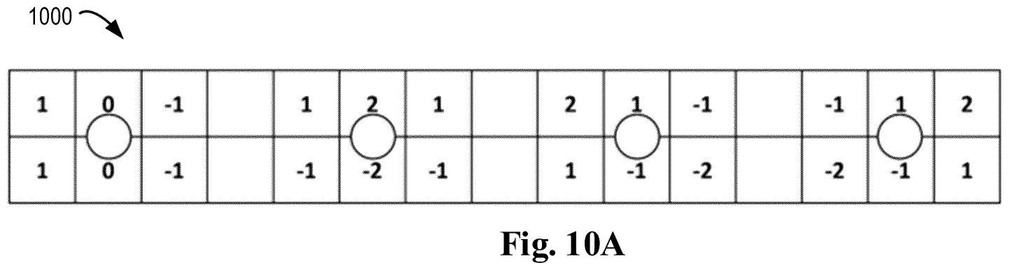

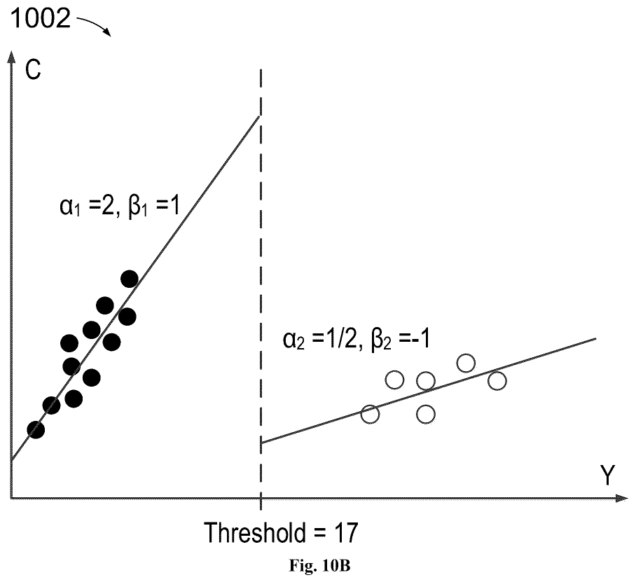

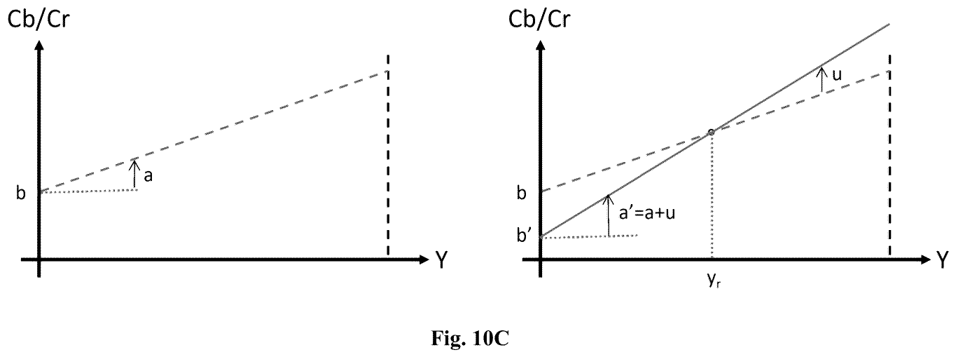

FIG. 10A shows that G can be calculated by one of four Sobel based gradient patterns.
For signaling, when the CCLM mode is enabled to the current CU, two flags are signaled separately for Cb/Cr component to indicate whether GLM is enabled to the component; if the GLM is enabled for one component, one syntax element is further signaled to select one of four gradient patterns in FIG. 10A for gradient calculation.

### 2.9. Multi-Model Linear Model (MMLM)

With MMLM, there can be more than one linear models between the luma samples and chroma samples in a CU. In this method, neighboring luma samples and neighboring chroma samples of the current block are classified into several groups, each group is used as a training set to derive a linear model (i.e., particular α and β are derived for a particular group). Furthermore, the samples of the current luma block is also classified based on the same rule for the classification of neighboring luma samples.
The neighboring samples can be classified into M groups, where M is 2 or 3. The MMLM method with M=2 and M=3 are designed as two appended Chroma prediction modes named MMLM2 and MMLM3, besides the original LM mode. The encoder chooses the optimal mode in the RDO process and signal the mode.
When M is equal to 2, FIG. 10B shows an example of classifying the neighboring samples into two groups. Threshold is calculated as the average value of the neighboring reconstructed Luma samples. A neighboring sample with Rec′L[x,y]<=Threshold is classified into group 1; while a neighboring sample with Rec′L[x,y]>Threshold is classified into group 2. Similar to CCLM, there are 3 modes in MMLM, namely MMLM, MMLM_T and MMLM_L. Two models are derived as follows.

$$\{ \begin{matrix}Pre {d}_{C} [ x , y ] = {α}_{1} \times {Rec}_{L}^{′} [ x , y ] + {β}_{1} & if {Rec}_{L}^{′} [ x , y ] \leq Thre s h o l d \\ Pre {d}_{C} [ x , y ] = {α}_{2} \times {Rec}_{L}^{′} [ x , y ] + {β}_{2} & if {Rec}_{L}^{′} [ x , y ] > Thre s h o l d\end{matrix} \qquad ( 2 - 8 )$$

FIG. 10B illustrates an example of classifying the neighboring samples into two groups.
The threshold which is the average of the luma reconstructed neighboring samples. The linear model of each class is derived by using the Least-Mean-Square (LMS) method, if enabled, or min/max method of VVC.

### 2.9.1. Slope Adjustment of CCLM

CCLM uses a model with 2 parameters to map luma values to chroma values. The slope parameter “a” and the bias parameter “b” define the mapping as follows:

$$chromaVal = a * lumaVal + b ,$$

An adjustment “u” to the slope parameter is signaled to update the model to the following form:

chromaVal=a′*lumaVal+b′,

where

$$\begin{matrix}a ’ = a + u , \\ b ’ = b - u * {y}_{r} .\end{matrix}$$

With this selection the mapping function is tilted or rotated around the point with luminance value yᵣ. The average of the reference luma samples used in the model creation as yᵣ in order to provide a meaningful modification to the model. The process is shown in FIG. 10C, which illustrates the effect of the slope adjustment parameter “u”. The left sub-figure in FIG. 10C illustrates a model created with the current CCLM, and the right sub-figure in FIG. 10C illustrates a model updated as proposed.

### Implementation

Slope adjustment parameter is provided as an integer between −4 and 4, inclusive, and signaled in the bitstream. The unit of the slope adjustment parameter is ⅛^{th} of a chroma sample value per one luma sample value (for 10-bit content).
Adjustment is available for the CCLM models that are using reference samples both above and left of the block (“LM_CHROMA_IDX” and “MMLM_CHROMA_IDX”), but not for the “single side” modes. This selection is based on coding efficiency vs. complexity trade-off considerations.
When slope adjustment is applied for a multimode CCLM model, both models can be adjusted and thus up to two slope updates are signaled for a single chroma block.

### Encoder Approach

The proposed encoder approach performs an SATD based search for the best value of the slope update for Cr and a similar SATD based search for Cb. If either one results as a non-zero slope adjustment parameter, the combined slope adjustment pair (SATD based update for Cr, SATD based update for Cb) is included in the list of RD checks for the TU.

### 2.10. Position Dependent Intra Prediction Combination

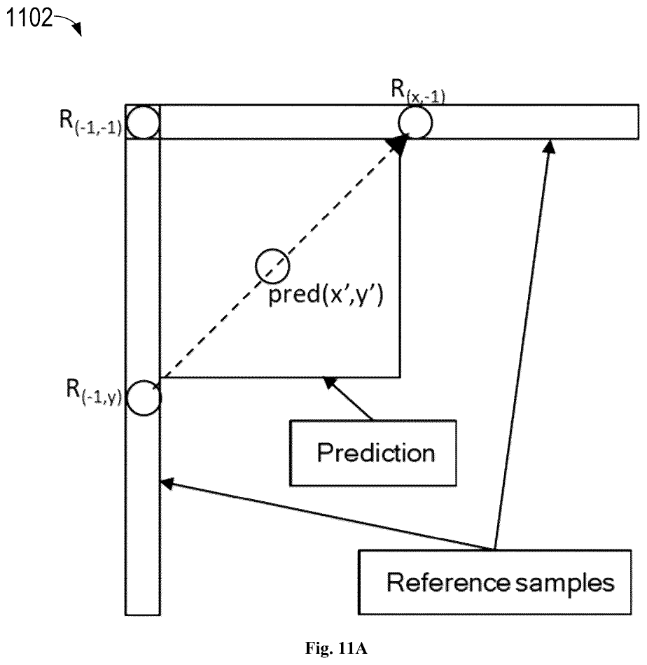

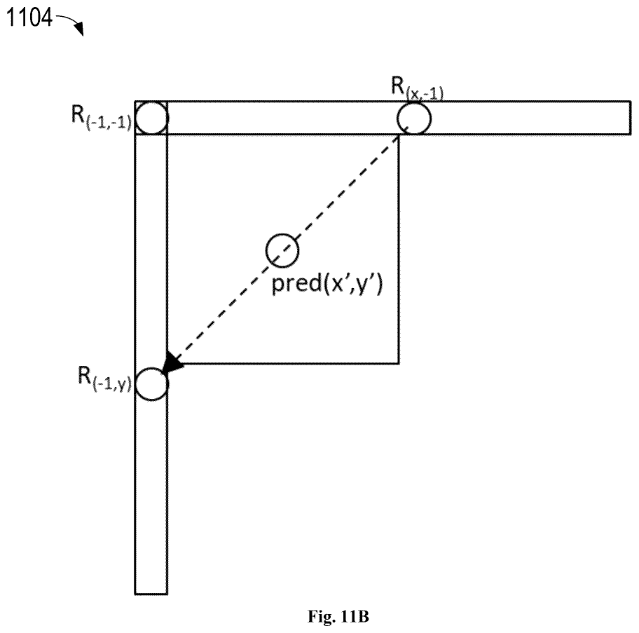

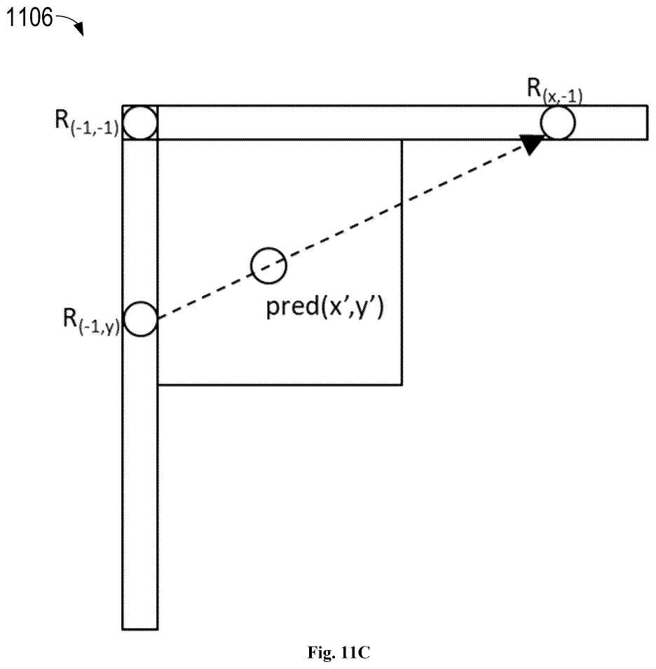

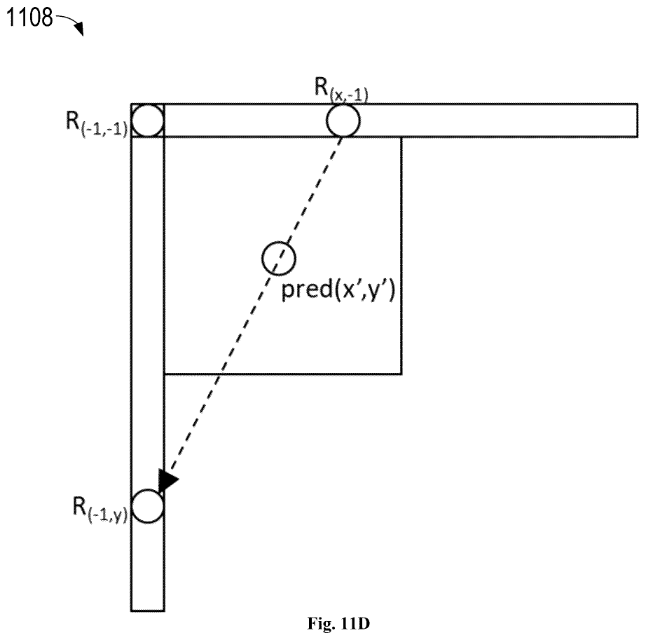

In VVC, the results of intra prediction of DC, planar and several angular modes are further modified by a position dependent intra prediction combination (PDPC) method. PDPC is an intra prediction method which invokes a combination of the boundary reference samples and HEVC style intra prediction with filtered boundary reference samples. PDPC is applied to the following intra modes without signalling: planar, DC, intra angles less than or equal to horizontal, and intra angles greater than or equal to vertical and less than or equal to 80. If the current block is BDPCM mode or MRL index is larger than 0, PDPC is not applied.
The prediction sample pred(x′,y′) is predicted using an intra prediction mode (DC, planar, angular) and a linear combination of reference samples according to the Equation 2-8 as follows:

$$pred ( x ’ , y ’ ) = Clip ( 0 , ( 1 << BitDepth ) - 1 , ( wL \times {R}_{- 1 , y ’} + wT \times {R}_{x ’ , - 1} + ( 64 - w L - w T ) \times p r e d ( x ’ , y ’ ) + 32 ) >> 6 ) \qquad ( 2 - 9 )$$

where R_{x,-1}, R_{-1,y} represent the reference samples located at the top and left boundaries of current sample (x, y), respectively.
If PDPC is applied to DC, planar, horizontal, and vertical intra modes, additional boundary filters are not needed, as required in the case of HEVC DC mode boundary filter or horizontal/vertical mode edge filters. PDPC process for DC and Planar modes is identical. For angular modes, if the current angular mode is HOR_IDX or VER_IDX, left or top reference samples is not used, respectively. The PDPC weights and scale factors are dependent on prediction modes and the block sizes. PDPC is applied to the block with both width and height greater than or equal to 4.
FIGS. 11A and 8B illustrate the definition of reference samples (R_{x,-1} and R_{-1,y}) for PDPC applied over various prediction modes. The prediction sample pred(x′, y′) is located at (x′, y′) within the prediction block. As an example, the coordinate x of the reference sample R_{x,-1} is given by: x=x′+y′+1, and the coordinate y of the reference sample R_{-1,y} is similarly given by: y=x′+y′+1 for the diagonal modes. For the other angular mode, the reference samples R_{x,-1} and R_{-1,y} could be located in fractional sample position. In this case, the sample value of the nearest integer sample location is used.
FIGS. 11A-11D illustrate definition of samples used by PDPC applied to diagonal and adjacent angular intra modes. FIG. 11A illustrates diagonal top-right mode. FIG. 11B illustrates diagonal bottom-left mode. FIG. 11C illustrates adjacent diagonal top-right mode. FIG. 11D illustrates adjacent diagonal bottom-left mode.

### 2.11. Gradient PDPC

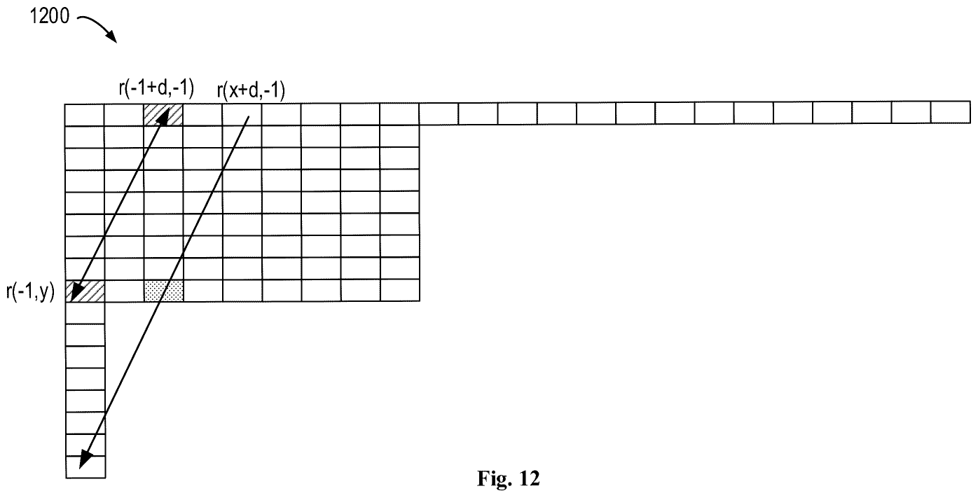

The gradient based approach is extended for non-vertical/non-horizontal mode, as shown in FIG. 12. Here, the gradient is computed as r(−1, y)−r(−1+d, −1), where d is the horizontal displacement depending on the angular direction. A few points to note here.
The gradient term r(−1, y)−r(−1+d, −1) is needed to be computed once for every row, as it does not depend on the x position.
The computation of d is already part of original intra prediction process which can be reused, so a separate computation of d is not needed. Accordingly, d is in 1/32 pixel accuracy.
We have used two tap (linear) filtering when d is at fractional position, i.e., if dPos is the displacement in 1/32 pixel accuracy, dInt is the (floored) integer part (dPos>>5), and dFract is the fractional part in 1/32 pixel accuracy (dPos & 31), then r(−1+d) is computed as:

$$r ( - 1 + d ) = ( 32 - dFrac ) * r ( - 1 + dInt ) + dFrac * r ( - 1 + d I n t + 1 ) .$$

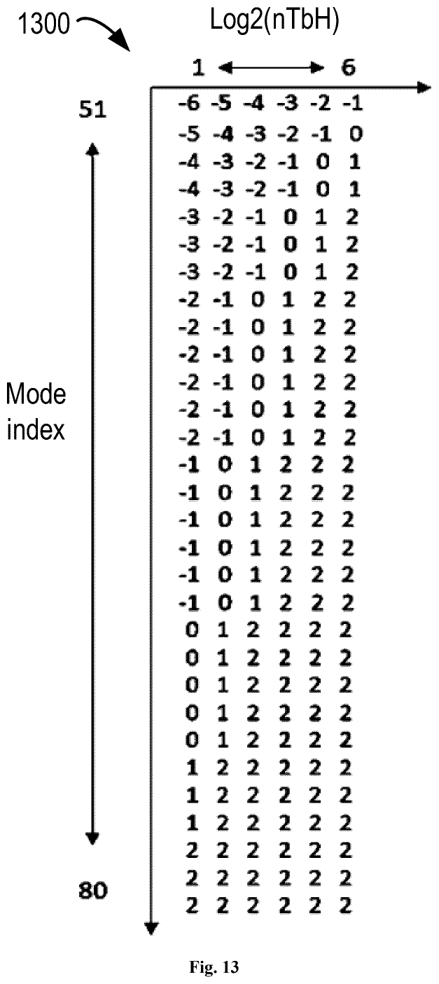

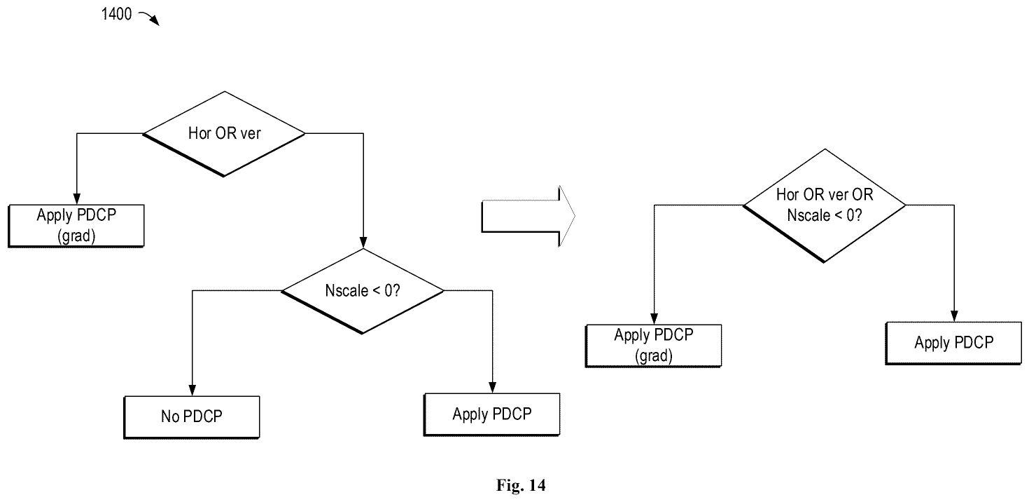

This 2 tap filtering is performed once per row (if needed), as explained in a.
Finally, the prediction signal is computed:

$$p ( x , y ) = Clip ( ( ( 64 - w L ( x ) ) * p ( x , y ) + wL ( x ) * ( r ( - 1 , y ) - r ( - 1 + d , - 1 ) ) + 32 ) >> 6 )$$

where wL(x)=32>>((x<<1)>>nScale2), and nScale2=(log 2(nTbH)+log 2(nTbW)−2)>>2, which are the same as vertical/horizontal mode. In a nutshell, the same process is applied compared to vertical/horizontal mode (in fact, d=0 indicates vertical/horizontal mode). FIG. 9 illustrates gradient approach for non-vertical/non-horizontal mode.
Second, activate the gradient based approach for non-vertical/non-horizontal mode when (nScale<0) or when PDPC can't be applied due to unavailability of secondary reference sample. We have shown the values of nScale in FIG. 13, with respect to TB size and angular mode, to better visualize the cases where gradient approach is used. Additionally, the flowchart for current and proposed PDPC is shown.
FIG. 13 illustrates nScale values with respect to nTbH and mode number; for all nScale<0 cases gradient approach is used. FIG. 14 illustrates flowchart: current PDPC (left), and proposed PDPC (right).

### 2.12. Secondary MPM

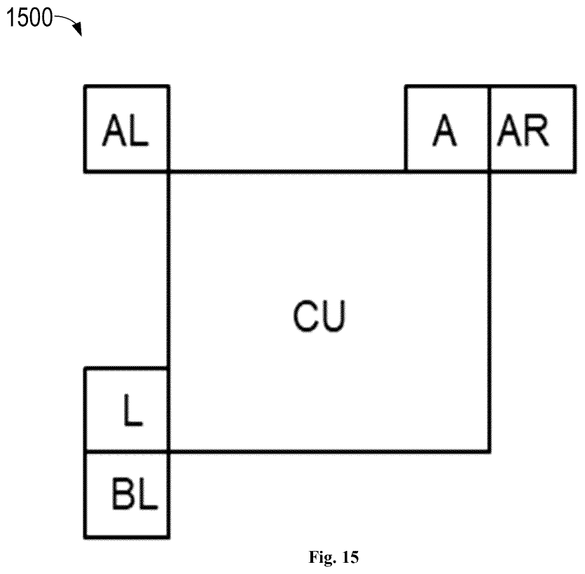

Secondary MPM lists is introduced. The existing primary MPM (PMPM) list consists of 6 entries and the secondary MPM (SMPM) list includes 16 entries. A general MPM list with 22 entries is constructed first, and then the first 6 entries in this general MPM list are included into the PMPM list, and the rest of entries form the SMPM list. The first entry in the general MPM list is the Planar mode. The remaining entries are composed of the intra modes of the left (L), above (A), below-left (BL), above-right (AR), and above-left (AL) neighbouring blocks as shown in FIG. 15, the directional modes with added offset from the first two available directional modes of neighbouring blocks, and the default modes.
   If a CU block is vertically oriented, the order of neighbouring blocks is A, L, BL, AR, AL; otherwise, it is L, A, BL, AR, AL. FIG. 15 illustrates Neighbouring blocks (L, A, BL, AR, AL) used in the derivation of a general MPM list.
   A PMPM flag is parsed first, if equal to 1 then a PMPM index is parsed to determine which entry of the PMPM list is selected, otherwise the SPMPM flag is parsed to determine whether to parse the SMPM index or the remaining modes.

### 2.13. 6-Tap Intra Interpolation Filter

To improve prediction accuracy, it is proposed to replace 4-tap Cubic interpolation filter with 6-tap interpolation filter, the filter coefficients are derived based on the same polynomial regression model, but with polynomial order of 6.
Filter coefficients are listed below:

$$\begin{matrix}\{ 0 , 0 , 256 , 0 , 0 , 0 \} , & // 0 / 32 position \\ \{ 0 , - 4 , 253 , 9 , - 2 , 0 \} , & // 1 / 32 position \\ \{ 1 , - 7 , 249 , 17 , - 4 , 0 \} , & // 2 / 32 position \\ \{ 1 , - 10 , 245 , 25 , - 6 , 1 \} , & // 3 / 32 position \\ \{ 1 , - 13 , 241 , 34 , - 8 , 1 \} , & // 4 / 32 position \\ \{ 2 , - 16 , 235 , 44 , - 10 , 1 \} , & // 5 / 32 position \\ \{ 2 , - 18 , 229 , 53 , - 12 , 2 \} , & // 6 / 32 position \\ \{ 2 , - 20 , 223 , 63 , - 14 , 2 \} , & // 7 / 32 position \\ \{ 2 , - 22 , 217 , 72 , - 15 , 2 \} , & // 8 / 32 position \\ \{ 3 , - 23 , 209 , 82 , - 17 , 2 \} , & // 9 / 32 position \\ \{ 3 , - 24 , 202 , 92 , - 19 , 2 \} , & // 10 / 32 position \\ \{ 3 , - 25 , 194 , 101 , - 20 , 3 \} , & // 11 / 32 position \\ \{ 3 , - 25 , 185 , 111 , - 21 , 3 \} , & // 12 / 32 position \\ \{ 3 , - 26 , 178 , 121 , - 23 , 3 \} , & // 13 / 32 position \\ \{ 3 , - 25 , 168 , 131 , - 24 , 3 \} , & // 14 / 32 position \\ \{ 3 , - 25 , 159 , 141 , - 25 , 3 \} , & // 15 / 32 position \\ \{ 3 , - 25 , 150 , 150 , - 25 , 3 \} . & // half - pel position\end{matrix}$$

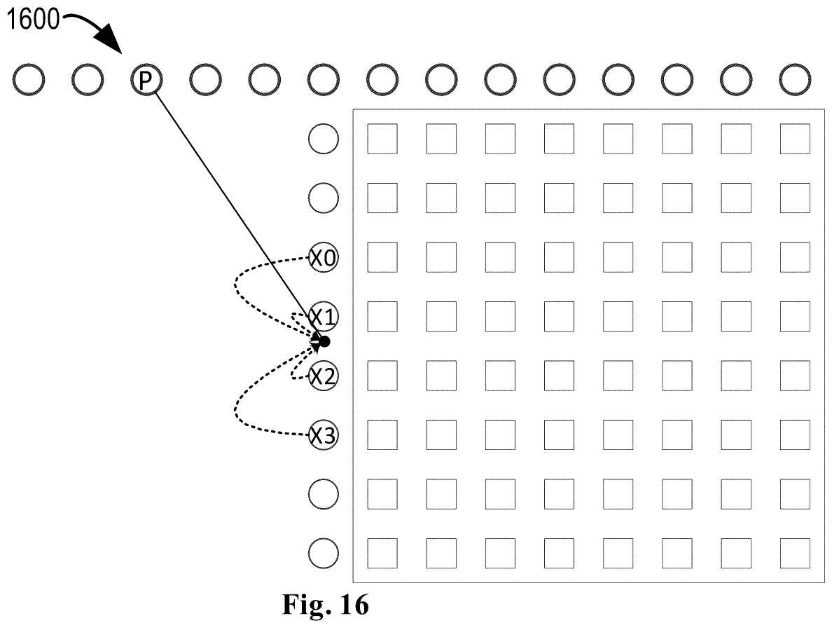

The reference samples used for interpolation come from reconstructed samples or padded as in HEVC, so that the conditional check on reference sample availability is not needed.
Instead of using nearest rounding operation to derive the extended Intra reference sample, it is proposed to use 4-tap Cubic interpolation filter. As shown in an example in FIG. 16, to derive the value of reference sample P, a four tap interpolation filter is used, while in JEM-3.0 or HM, P is directly set as X1.
FIG. 16 illustrates Example on proposed intra reference mapping.

### 2.14. Multiple Reference Line (MRL) Intra Prediction

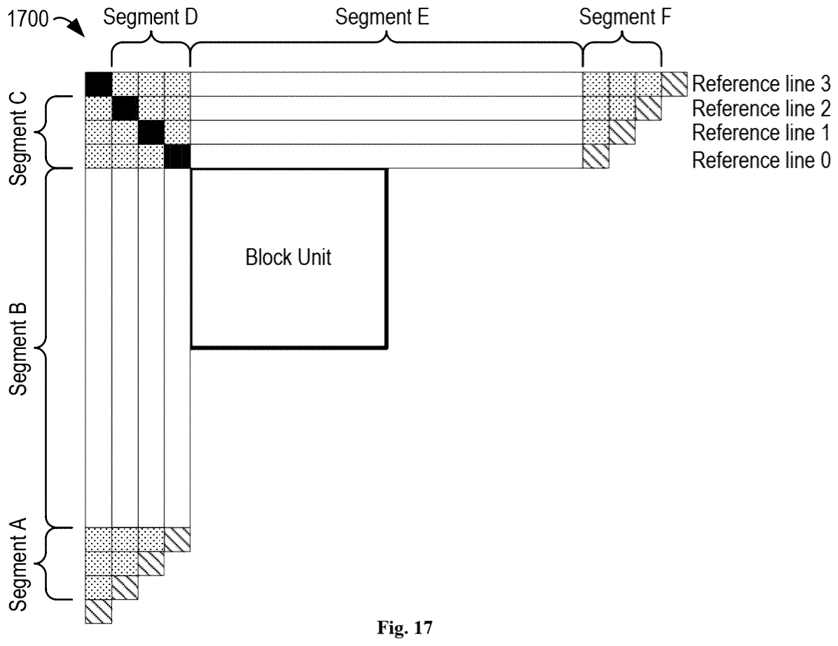

Multiple reference line (MRL) intra prediction uses more reference lines for intra prediction. In FIG. 17, an example of 4 reference lines is depicted, where the samples of segments A and F are not fetched from reconstructed neighbouring samples but padded with the closest samples from Segment B and E, respectively. HEVC intra-picture prediction uses the nearest reference line (i.e., reference line 0). In MRL, 2 additional lines (reference line 1 and reference line 2) are used.
The index of selected reference line (mrl_idx) is signalled and used to generate intra predictor. For reference line index, which is greater than 0, only include additional reference line modes in MPM list and only signal MPM index without remaining mode. The reference line index is signalled before intra prediction modes, and Planar mode is excluded from intra prediction modes in case a nonzero reference line index is signalled. FIG. 17 illustrates Example of four reference lines neighbouring to a prediction block.
MRL is disabled for the first line of blocks inside a CTU to prevent using extended reference samples outside the current CTU line. Also, PDPC is disabled when additional line is used. For MRL mode, the derivation of DC value in DC intra prediction mode for non-zero reference line indices are aligned with that of reference line index 0. MRL requires the storage of 3 neighbouring luma reference lines with a CTU to generate predictions. The Cross-Component Linear Model (CCLM) tool also requires 3 neighbouring luma reference lines for its down-sampling filters. The definition of MRL to use the same 3 lines is aligned as CCLM to reduce the storage requirements for decoders.

### 2.15. Intra Sub-Partitions (ISP)

The intra sub-partitions (ISP) divides luma intra-predicted blocks vertically or horizontally into 2 or 4 sub-partitions depending on the block size. For example, minimum block size for ISP is 4×8 (or 8×4). If block size is greater than 4×8 (or 8×4) then the corresponding block is divided by 4 sub-partitions. It has been noted that the M×128 (with M≤64) and 128×N (with N≤64) ISP blocks could generate a potential issue with the 64×64 VDPU. For example, an M×128 CU in the single tree case has an M×128 luma TB and two corresponding

$$\frac{M}{2} \times 64$$

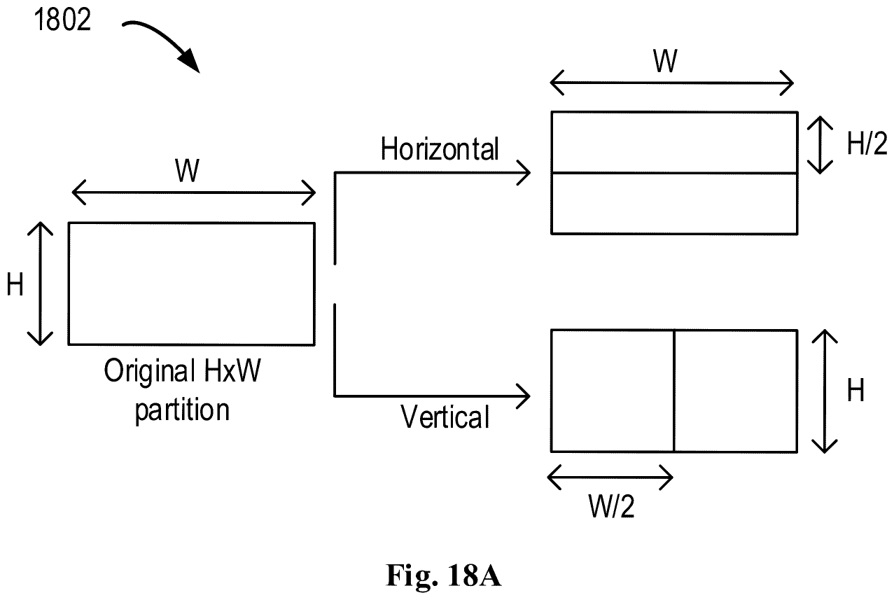

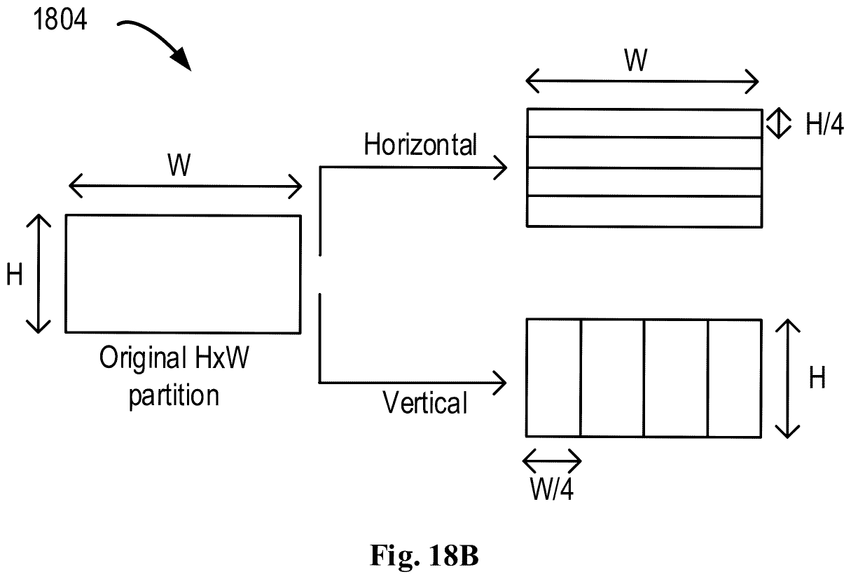

chroma TBs. If the CU uses ISP, then the luma TB will be divided into four M×32 TBs (only the horizontal split is possible), each of them smaller than a 64×64 block. However, in the current design of ISP chroma blocks are not divided. Therefore, both chroma components will have a size greater than a 32×32 block. Analogously, a similar situation could be created with a 128×N CU using ISP. Hence, these two cases are an issue for the 64×64 decoder pipeline. For this reason, the CU sizes that can use ISP is restricted to a maximum of 64×64. FIG. 18A and FIG. 18B show examples of the two possibilities. All sub-partitions fulfill the condition of having at least 16 samples.
In ISP, the dependence of 1×N/2×N subblock prediction on the reconstructed values of previously decoded 1×N/2×N subblocks of the coding block is not allowed so that the minimum width of prediction for subblocks becomes four samples. For example, an 8×N (N>4) coding block that is coded using ISP with vertical split is split into two prediction regions each of size 4×N and four transforms of size 2×N. Also, a 4×N coding block that is coded using ISP with vertical split is predicted using the full 4×N block; four transform each of 1×N is used. Although the transform sizes of 1×N and 2×N are allowed, it is asserted that the transform of these blocks in 4×N regions can be performed in parallel. For example, when a 4×N prediction region contains four 1×N transforms, there is no transform in the horizontal direction; the transform in the vertical direction can be performed as a single 4×N transform in the vertical direction. Similarly, when a 4×N prediction region contains two 2×N transform blocks, the transform operation of the two 2×N blocks in each direction (horizontal and vertical) can be conducted in parallel. Thus, there is no delay added in processing these smaller blocks than processing 4×4 regular-coded intra blocks.
FIGS. 18A and 15B illustrate Sub-partition depending on the block size. FIG. 18A illustrates examples of sub-partitions for 4×8 and 8×4 CU. FIG. 18B illustrates examples of sub-partitions for CUs other than 4×8, 8×4 and 4×4.

TABLE 5
Entropy coding coefficient group size

| | Coefficient |
|---|---|
| Block Size | group Size |
| 1 × N, N ≥ 16 | 1 × 16 |
| N × 1, N ≥ 16 | 16 × 1 |
| 2 × N, N ≥ 8 | 2 × 8 |
| N × 2, N ≥ 8 | 8 × 2 |
| All other possible | 4 × 4 |
| M × N cases | |

For each sub-partition, reconstructed samples are obtained by adding the residual signal to the prediction signal. Here, a residual signal is generated by the processes such as entropy decoding, inverse quantization and inverse transform. Therefore, the reconstructed sample values of each sub-partition are available to generate the prediction of the next sub-partition, and each sub-partition is processed repeatedly. In addition, the first sub-partition to be processed is the one containing the top-left sample of the CU and then continuing downwards (horizontal split) or rightwards (vertical split). As a result, reference samples used to generate the sub-partitions prediction signals are only located at the left and above sides of the lines. All sub-partitions share the same intra mode. The followings are summary of interaction of ISP with other coding tools.
Multiple Reference Line (MRL): if a block has an MRL index other than 0, then the ISP coding mode will be inferred to be 0 and therefore ISP mode information will not be sent to the decoder.
Entropy coding coefficient group size: the sizes of the entropy coding subblocks have been modified so that they have 16 samples in all possible cases, as shown in Table 5. Note that the new sizes only affect blocks produced by ISP in which one of the dimensions is less than 4 samples. In all other cases coefficient groups keep the 4×4 dimensions.
CBF coding: it is assumed to have at least one of the sub-partitions has a non-zero CBF. Hence, if n is the number of sub-partitions and the first n−1 sub-partitions have produced a zero CBF, then the CBF of the n-th sub-partition is inferred to be 1.
Transform size restriction: all ISP transforms with a length larger than 16 points uses the DCT-II.
MTS flag: if a CU uses the ISP coding mode, the MTS CU flag will be set to 0 and it will not be sent to the decoder. Therefore, the encoder will not perform RD tests for the different available transforms for each resulting sub-partition. The transform choice for the ISP mode will instead be fixed and selected according the intra mode, the processing order and the block size utilized. Hence, no signalling is required. For example, let t_{H} and t_{V} be the horizontal and the vertical transforms selected respectively for the w×h sub-partition, where w is the width and h is the height. Then the transform is selected according to the following rules:
   If w=1 or h=1, then there is no horizontal or vertical transform respectively.
   If w≥4 and w≤16, t_{H}=DST-VII, otherwise, t_{H}=DCT-II.
   If h≥4 and h≤16, t_{V}=DST-VII, otherwise, t_{V}=DCT-II.
      In ISP mode, all 67 intra prediction modes are allowed. PDPC is also applied if corresponding width and height is at least 4 samples long. In addition, the reference sample filtering process (reference smoothing) and the condition for intra interpolation filter selection doesn't exist anymore, and Cubic (DCT-IF) filter is always applied for fractional position interpolation in ISP mode.

### 2.16. Matrix Weighted Intra Prediction (MIP)

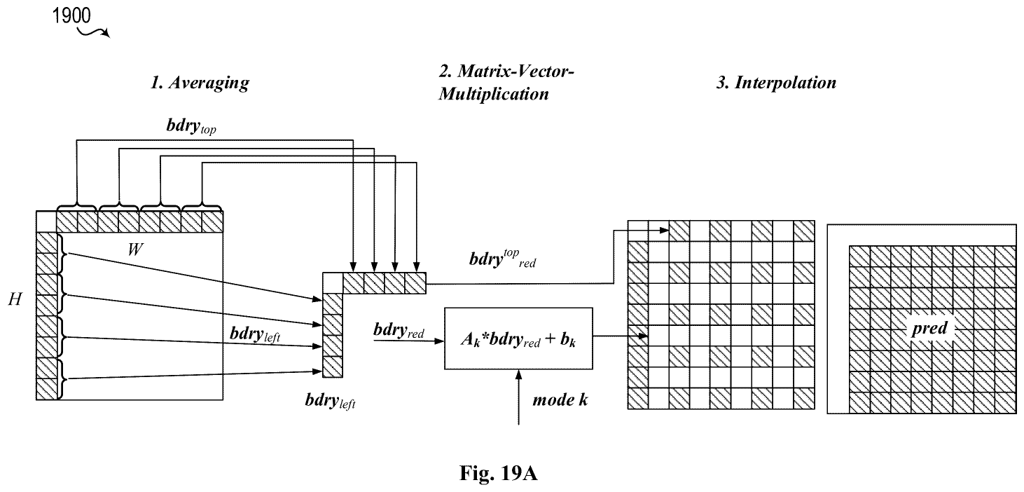

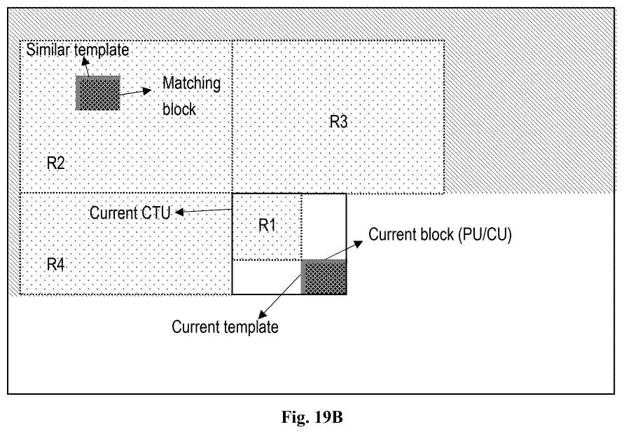

Matrix weighted intra prediction (MIP) method is a newly added intra prediction technique into VVC. For predicting the samples of a rectangular block of width W and height H, matrix weighted intra prediction (MIP) takes one line of H reconstructed neighbouring boundary samples left of the block and one line of W reconstructed neighbouring boundary samples above the block as input. If the reconstructed samples are unavailable, they are generated as it is done in the conventional intra prediction. The generation of the prediction signal is based on the following three steps, which are averaging, matrix vector multiplication and linear interpolation as shown in FIG. 19A. FIG. 19A illustrates Matrix weighted intra prediction process.

### 2.16.1. Averaging Neighbouring Samples

Among the boundary samples, four samples or eight samples are selected by averaging based on block size and shape. Specifically, the input boundaries bdry^{top} and bdry^{left} are reduced to smaller boundaries

$$bdr {y}_{r e d}^{t o p} and {bdry}_{r e d}^{l e f t}$$

by averaging neighbouring boundary samples according to predefined rule depends on block size. Then, the two reduced boundaries

$$b d r {y}_{r e d}^{t o p} and {bdry}_{r e d}^{l e f t}$$

are concatenated to a reduced boundary vector bdry_{red} which is thus of size four for blocks of shape 4×4 and of size eight for blocks of all other shapes. If mode refers to the MIP-mode, this concatenation is defined as follows:

$$b d r {y}_{r e d} = \{ \begin{matrix}[ {bdry}_{red}^{top} , {bdry}_{red}^{left} ] & for W = H = 4 and mode < 18 \\ [ {bdry}_{red}^{left} , {bdry}_{red}^{top} ] & for W = H = 4 and mode < 18 \\ [ {bdry}_{red}^{top} , {bdry}_{red}^{left} ] & for max ( W , H ) = 8 and mode < 10 \\ [ {bdry}_{red}^{left} , {bdry}_{red}^{top} ] & for max ( W , H ) = 8 and mode \geq 10 \\ [ {bdry}_{red}^{top} , {bdry}_{red}^{left} ] & for max ( W , H ) > 8 and mode < 6 \\ [ {bdry}_{red}^{left} , {bdry}_{red}^{top} ] & for max ( W , H ) > 8 and mode \geq 6.\end{matrix} \qquad ( 2 - 10 )$$

### 2.16.2. Matrix Multiplication

A matrix vector multiplication, followed by addition of an offset, is carried out with the averaged samples as an input. The result is a reduced prediction signal on a subsampled set of samples in the original block. Out of the reduced input vector bdry_{red} a reduced prediction signal pred_{red}, which is a signal on the down-sampled block of width W_{red} and height H_{red} is generated. Here, W_{red} and H_{red} are defined as:

$${W}_{r e d} = \{ \begin{matrix}4 & for max ( W , H ) \leq 8 \\ min ( W , 8 ) & for max ( W , H ) > 8\end{matrix} \qquad ( 2 - 11 )$$

$${H}_{r e d} = \{ \begin{matrix}4 & for max ( W , H ) \leq 8 \\ min ( H , 8 ) & for max ( W , H ) > 8\end{matrix} \qquad ( 2 - 12 )$$

The reduced prediction signal pred_{red} is computed by calculating a matrix vector product and adding an offset:

$$p r e {d}_{r e d} = A \cdot bdr {y}_{r e d} + b . \qquad ( 2 - 13 )$$

Here, A is a matrix that has W_{red}·H_{red} rows and 4 columns if W=H=4 and 8 columns in all other cases. b is a vector of size W_{red}·H_{red}. The matrix A and the offset vector b are taken from one of the sets S₀, S₁, S₂. One defines an index idx=idx(W, H) as follows:

$$i d x ( W , H ) = \{ \begin{matrix}0 & for W = H = 4 \\ 1 & for max ( W , H ) = 8 \\ 2 & for max ( W , H ) > 8.\end{matrix} \qquad ( 2 - 14 )$$

Here, each coefficient of the matrix A is represented with 8 bit precision. The set S₀ consists of 16 matrices A₀ⁱ, i∈{0, . . . , 15} each of which has 16 rows and 4 columns and 16 offset vectors b₀ⁱ, i∈{0, . . . , 16} each of size 16. Matrices and offset vectors of that set are used for blocks of size 4×4. The set S₁ consists of 8 matrices A₁ⁱ, i∈{0, . . . , 7}, each of which has 16 rows and 8 columns and 8 offset vectors b₁ⁱ, i∈{0, . . . , 7} each of size 16. The set S₂ consists of 6 matrices A₂ⁱ, i∈{0, . . . , 5}, each of which has 64 rows and 8 columns and of 6 offset vectors b₂ⁱ, i∈{0, . . . , 5} of size 64.

### 2.16.3. Interpolation

The prediction signal at the remaining positions is generated from the prediction signal on the subsampled set by linear interpolation which is a single step linear interpolation in each direction. The interpolation is performed firstly in the horizontal direction and then in the vertical direction regardless of block shape or block size.
2.16.4. Signalling of MIP Mode and Harmonization with Other Coding Tools
For each Coding Unit (CU) in intra mode, a flag indicating whether an MIP mode is to be applied or not is sent. If an MIP mode is to be applied, MIP mode (predModeIntra) is signalled. For an MIP mode, a transposed flag (isTransposed), which determines whether the mode is transposed, and MIP mode Id (modeId), which determines which matrix is to be used for the given MIP mode is derived as follows.

$$\begin{matrix}isTransposed = predModeIntra \& 1 \\ modeId = predModeIntra >> 1\end{matrix} \qquad ( 2 - 15 )$$

MIP coding mode is harmonized with other coding tools by considering following aspects:
LFNST is enabled for MIP on large blocks. Here, the LFNST transforms of planar mode are used.
The reference sample derivation for MIP is performed exactly as for the conventional intra prediction modes.
For the up-sampling step used in the MIP-prediction, original reference samples are used instead of down-sampled ones.
Clipping is performed before up-sampling and not after up-sampling.
MIP is allowed up to 64×64 regardless of the maximum transform size.
   The number of MIP modes is 32 for sizeId=0, 16 for sizeId=1 and 12 for sizeId=2.

### 2.16.5. Intra Template Matching

Intra template matching prediction (Intra TMP) is a special intra prediction mode that copies the best prediction block from the reconstructed part of the current frame, whose L-shaped template matches the current template. For a predefined search range, the encoder searches for the most similar template to the current template in a reconstructed part of the current frame and uses the corresponding block as a prediction block. The encoder then signals the usage of this mode, and the same prediction operation is performed at the decoder side.
The prediction signal is generated by matching the L-shaped causal neighbor of the current block with another block in a predefined search area in FIG. 19B consisting of:
R1: current CTU;
R2: top-left CTU;
R3: above CTU;
R4: left CTU.
   Sum of absolute differences (SAD) is used as a cost function.
   Within each region, the decoder searches for the template that has least SAD with respect to the current one and uses its corresponding block as a prediction block.
   The dimensions of all regions (SearchRange_w, SearchRange_h) are set proportional to the block dimension (BlkW, BlkH) to have a fixed number of SAD comparisons per pixel. That is:

$$\begin{matrix}SearchRange\_w = a * BlkW , \\ SearchRange\_h = a * BlkH ,\end{matrix}$$

where ‘a’ is a constant that controls the gain/complexity trade-off. In practice, ‘a’ is equal to 5.
The Intra template matching tool is enabled for CUs with size less than or equal to 64 in width and height. This maximum CU size for Intra template matching is configurable.
The Intra template matching prediction mode is signaled at CU level through a dedicated flag when DIMD is not used for current CU.

### 2.17. Decoder-Side Intra Mode Derivation

In JEM-2.0 intra modes are extended to 67 from 35 modes in HEVC, and they are derived at encoder and explicitly signalled to decoder. A significant amount of overhead is spent on intra mode coding in JEM-2.0. For example, the intra mode signalling overhead may be up to 5˜10% of overall bitrate in all intra coding configuration. This contribution proposes the decoder-side intra mode derivation approach to reduce the intra mode coding overhead while keeping prediction accuracy.
To reduce the overhead of intra mode signalling, this contribution presents a decoder-side intra mode derivation (DIMD) approach. In the proposed approach, instead of signalling intra mode explicitly, the information is derived at both encoder and decoder from the neighbouring reconstructed samples of current block. The intra mode derived by DIMD is used in two ways:
1) For 2N×2N CUs, the DIMD mode is used as the intra mode for intra prediction when the corresponding CU-level DIMD flag is turned on;
2) For N×N CUs, the DIMD mode is used to replace one candidate of the existing MPM list to improve the efficiency of intra mode coding.

### 2.17.1. Templated Based Intra Mode Derivation

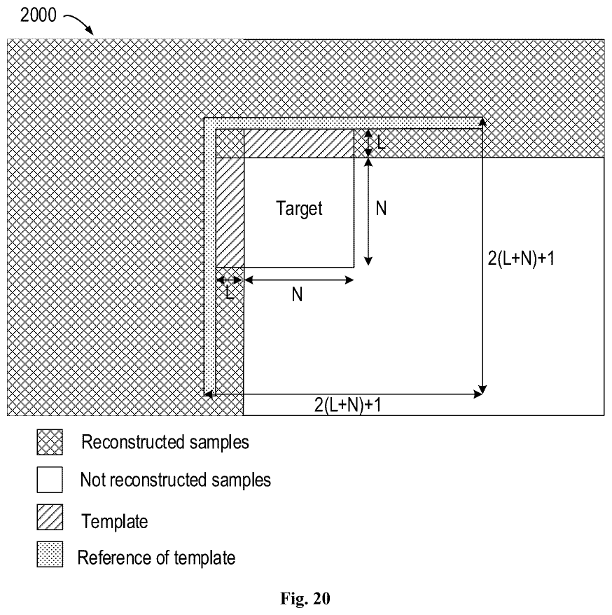

As illustrated in FIG. 20, the target denotes the current block (of block size N) for which intra prediction mode is to be estimated. The template (indicated by the patterned region in FIG. 20) specifies a set of already reconstructed samples, which are used to derive the intra mode. The template size is denoted as the number of samples within the template that extends to the above and the left of the target block, i.e., L. In the current implementation, a template size of 2 (i.e., L=2) is used for 4×4 and 8×8 blocks and a template size of 4 (i.e., L=4) is used for 16×16 and larger blocks. The reference of template (indicated by the dotted region in FIG. 20) refers to a set of neighbouring samples from above and left of the template, as defined by JEM-2.0. Unlike the template samples which are always from reconstructed region, the reference samples of template may not be reconstructed yet when encoding/decoding the target block. In this case, the existing reference samples substitution algorithm of JEM-2.0 is utilized to substitute the unavailable reference samples with the available reference samples.
FIG. 20 illustrates Target samples, template samples and the reference samples of template used in the DIMD. For each intra prediction mode, the DIMD calculates the absolute difference (SAD) between the reconstructed template samples and its prediction samples obtained from the reference samples of the template. The intra prediction mode that yields the minimum SAD is selected as the final intra prediction mode of the target block.

### 2.17.2. DIMD for Intra 2N×2N CUs

For intra 2N×2N CUs, the DIMD is used as one additional intra mode, which is adaptively selected by comparing the DIMD intra mode with the optimal normal intra mode (i.e., being explicitly signalled). One flag is signalled for each intra 2N×2N CU to indicate the usage of the DIMD. If the flag is one, then the CU is predicted using the intra mode derived by DIMD; otherwise, the DIMD is not applied and the CU is predicted using the intra mode explicitly signalled in the bit-stream. When the DIMD is enabled, chroma components always reuse the same intra mode as that derived for luma component, i.e., DM mode.
Additionally, for each DIMD-coded CU, the blocks in the CU can adaptively select to derive their intra modes at either PU-level or TU-level. Specifically, when the DIMD flag is one, another CU-level DIMD control flag is signalled to indicate the level at which the DIMD is performed. If this flag is zero, it means that the DIMD is performed at the PU level and all the TUs in the PU use the same derived intra mode for their intra prediction; otherwise (i.e., the DIMD control flag is one), it means that the DIMD is performed at the TU level and each TU in the PU derives its own intra mode.
Further, when the DIMD is enabled, the number of angular directions increases to 129, and the DC and planar modes still remain the same. To accommodate the increased granularity of angular intra modes, the precision of intra interpolation filtering for DIMD-coded CUs increases from 1/32-pel to 1/64-pel. Additionally, in order to use the derived intra mode of a DIMD coded CU as MPM candidate for neighbouring intra blocks, those 129 directions of the DIMD-coded CUs are converted to “normal” intra modes (i.e., 65 angular intra directions) before they are used as MPM.

### 2.17.3. DIMD for Intra N×N CUs

In the proposed method, intra modes of intra N×N CUs are always signalled. However, to improve the efficiency of intra mode coding, the intra modes derived from DIMD are used as MPM candidates for predicting the intra modes of four PUs in the CU. In order to not increase the overhead of MPM index signalling, the DIMD candidate is always placed at the first place in the MPM list and the last existing MPM candidate is removed. Also, pruning operation is performed such that the DIMD candidate will not be added to the MPM list if it is redundant.

### 2.17.4. Intra Mode Search Algorithm of DIMD

In order to reduce encoding/decoding complexity, one straightforward fast intra mode search algorithm is used for DIMD. Firstly, one initial estimation process is performed to provide a good starting point for intra mode search. Specifically, an initial candidate list is created by selecting N fixed modes from the allowed intra modes. Then, the SAD is calculated for all the candidate intra modes and the one that minimizes the SAD is selected as the starting intra mode. To achieve a good complexity/performance trade-off, the initial candidate list consists of 11 intra modes, including DC, planar and every 4-th mode of the 33 angular intra directions as defined in HEVC, i.e., intra modes 0, 1, 2, 6, 10 . . . 30, 34.
If the starting intra mode is either DC or planar, it is used as the DIMD mode. Otherwise, based on the starting intra mode, one refinement process is then applied where the optimal intra mode is identified through one iterative search. It works by comparing at each iteration the SAD values for three intra modes separated by a given search interval and maintain the intra mode that minimize the SAD. The search interval is then reduced to half, and the selected intra mode from the last iteration will serve as the center intra mode for the current iteration. For the current DIMD implementation with 129 angular intra directions, up to 4 iterations are used in the refinement process to find the optimal DIMD intra mode.

### 2.18. Decoder-Side Intra Mode Derivation by Calculating the Gradients of Neighbouring Samples

Three angular modes are selected from a Histogram of Gradient (HoG) computed from the neighboring pixels of current block. Once the three modes are selected, their predictors are computed normally and then their weighted average is used as the final predictor of the block. To determine the weights, corresponding amplitudes in the HoG are used for each of the three modes. The DIMD mode is used as an alternative prediction mode and is always checked in the FullRD mode.
Current version of DIMD has modified some aspects in the signaling, HoG computation and the prediction fusion. The purpose of this modification is to improve the coding performance as well as addressing the complexity concerns raised during the last meeting (i.e., throughput of 4×4 blocks). The following sections describe the modifications for each aspect.

### 2.18.1. Signalling

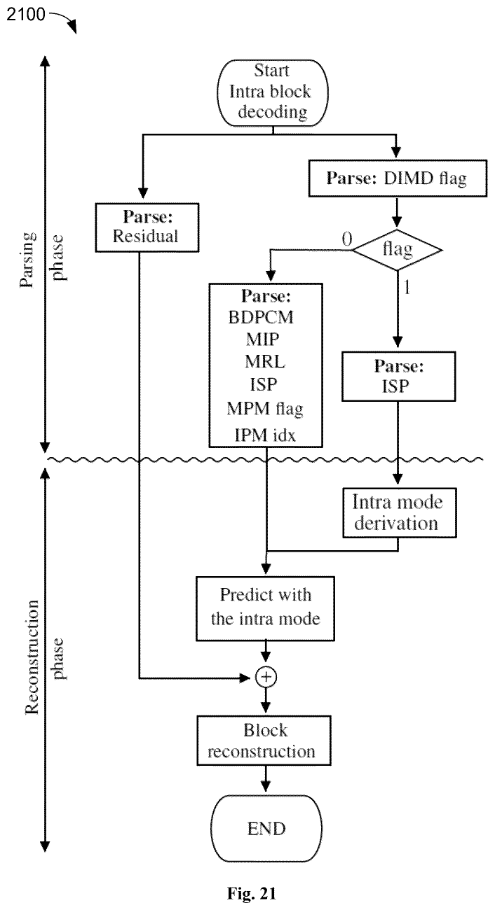

FIG. 21 shows the order of parsing flags/indices in VTM5, integrated with the proposed DIMD.
As can be seen, the DIMD flag of the block is parsed first using a single CABAC context, which is initialized to the default value of 154.
If flag==0, then the parsing continues normally.
Else (if flag==1), only the ISP index is parsed and the following flags/indices are inferred to be zero: BDPCM flag, MIP flag, MRL index. In this case, the entire IPM parsing is also skipped.
During the parsing phase, when a regular non-DIMD block inquires the IPM of its DIMD neighbor, the mode PLANAR_IDX is used as the virtual IPM of the DIMD block.
FIG. 21 illustrates proposed intra block decoding process.

### 2.18.2. Texture Analysis

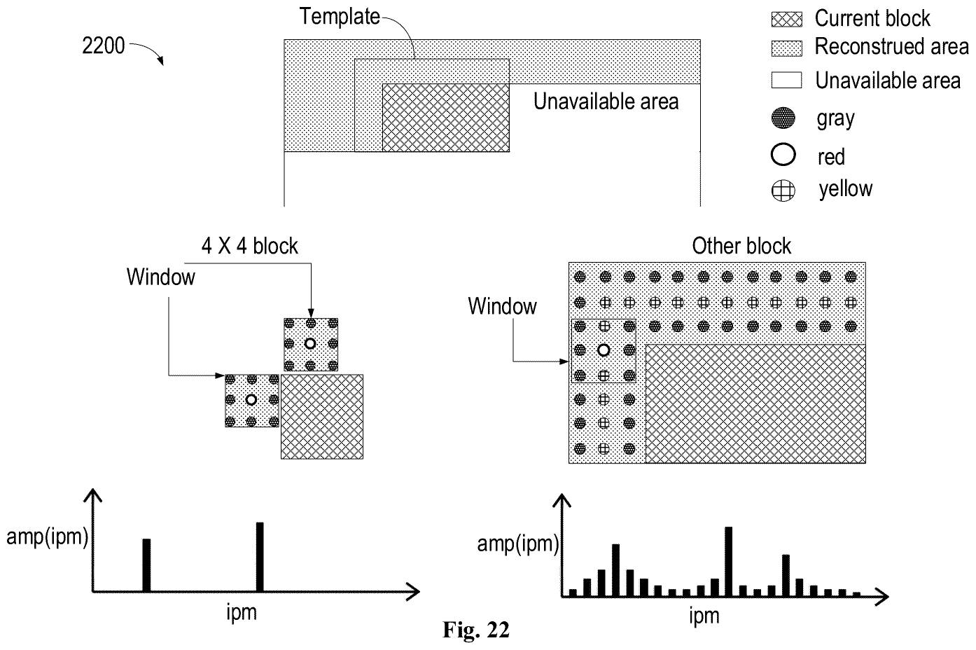

The texture analysis of DIMD includes a Histogram of Gradient (HoG) computation (shown in FIG. 22). The HoG computation is carried out by applying horizontal and vertical Sobel filters on pixels in a template of width 3 around the block. Except, if above template pixels fall into a different CTU, then they will not be used in the texture analysis.
Once computed, the IPMs corresponding to two tallest histogram bars are selected for the block.
In previous versions, all pixels in the middle line of the template were involved in the HoG computation. However, the current version improves the throughput of this process by applying the Sobel filter more sparsely on 4×4 blocks. To this aim, only one pixel from left and one pixel from above are used. This is shown in FIG. 22. In addition to reduction in the number of operations for gradient computation, this property also simplifies the selection of best 2 modes from the HoG, as the resulting HoG cannot have more than two non-zero amplitudes. FIG. 22 illustrates HoG computation from a template of width 3 pixels.

### 2.18.3. Prediction Fusion

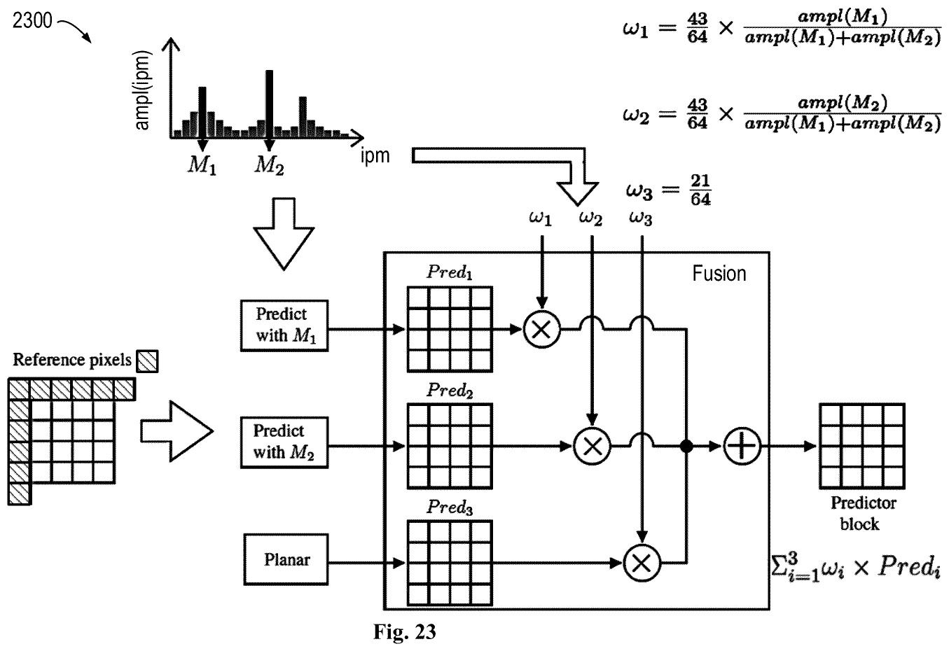

The current version of the method also uses a fusion of three predictors for each block. However, the choice of prediction modes is different and makes use of the combined hypothesis intra-prediction method proposed in [2], where the Planar mode is considered to be used in combination with other modes when computing an intra-predicted candidate. In the current version, the two IPMs corresponding to two tallest HoG bars are combined with the Planar mode.
The prediction fusion is applied as a weighted average of the above three predictors. To this aim, the weight of planar is fixed to 21/64 (˜⅓). The remaining weight of 43/64 (˜⅔) is then shared between the two HoG IPMs, proportionally to the amplitude of their HoG bars. FIG. 23 visualises this process. FIG. 23 illustrates prediction fusion by weighted averaging of two HoG modes and planar.

### 2.19. DIMD Chroma Mode

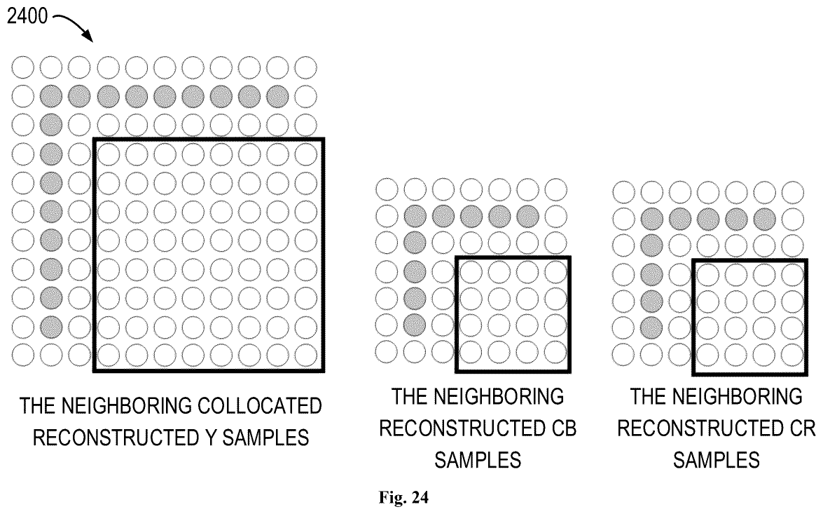

The DIMD chroma mode uses the DIMD derivation method to derive the chroma intra prediction mode of the current block based on the neighboring reconstructed Y, Cb and Cr samples in the second neighboring row and column as shown in FIG. 24. Specifically, a horizontal gradient and a vertical gradient are calculated for each collocated reconstructed luma sample of the current chroma block, as well as the reconstructed Cb and Cr samples, to build a HoG. Then the intra prediction mode with the largest histogram amplitude values is used for performing chroma intra prediction of the current chroma block. FIG. 24 illustrates neighboring reconstructed samples used for DIMD chroma mode.
When the intra prediction mode derived from the DIMD chroma mode is the same as the intra prediction mode derived from the DM mode, the intra prediction mode with the second largest histogram amplitude value is used as the DIMD chroma mode. A CU level flag is signaled to indicate whether the proposed DIMD chroma mode is applied.

### 2.20. Template-Based Intra Mode Derivation (TIMD)

This contribution proposes a template-based intra mode derivation (TIMD) method using MPMs, in which a TIMD mode is derived from MPMs using the neighbouring template. The TIMD mode is used as an additional intra prediction method for a CU.

### 2.20.1. TIMD Mode Derivation

For each intra prediction mode in MPMs, The SATD between the prediction and reconstruction samples of the template is calculated. The intra prediction mode with the minimum SATD is selected as the TIMD mode and used for intra prediction of current CU. Position dependent intra prediction combination (PDPC) is included in the derivation of the TIMD mode.

### 2.20.2. TIMD Signalling

A flag is signalled in sequence parameter set (SPS) to enable/disable the proposed method. When the flag is true, a CU level flag is signalled to indicate whether the proposed TIMD method is used. The TIMD flag is signalled right after the MIP flag. If the TIMD flag is equal to true, the remaining syntax elements related to luma intra prediction mode, including MRL, ISP, and normal parsing stage for luma intra prediction modes, are all skipped.
2.20.3. Interaction with New Coding Tools
A DIMD method with prediction fusion using Planar was integrated in EE2. When EE2 DIMD flag is equal to true, the proposed TIMD flag is not signalled and set equal to false.
Similar to PDPC, Gradient PDPC is also included in the derivation of the TIMD mode.
When secondary MPM is enabled, both the primary MPMs and the secondary MPMs are used to derive the TIMD mode.
6-tap interpolation filter is not used in the derivation of the TIMD mode.

### 2.20.4. Modification of MPM List Construction in the Derivation of TIMD Mode

During the construction of MPM list, intra prediction mode of a neighbouring block is derived as Planar when it is inter-coded. To improve the accuracy of MPM list, when a neighbouring block is inter-coded, a propagated intra prediction mode is derived using the motion vector and reference picture and used in the construction of MPM list. This modification is only applied to the derivation of the TIMD mode.
2.20.5. TIMD with Fusion
Instead of selecting the only one mode with the smallest SATD cost, this contribution proposes to choose the first two modes with the smallest SATD costs for the intra modes derived using TIMD method and then fuse them with the weights, and such weighted intra prediction is used to code the current CU.
The costs of the two selected modes are compared with a threshold, in the test the cost factor of 2 is applied as follows:

$$costMode 2 < 2 ’ costMode 1.$$

If this condition is true, the fusion is applied, otherwise the only mode1 is used.
Weights of the modes are computed from their SATD costs as follows:

$$\begin{matrix}weight 1 = costMode 2 / ( costMode 1 + costMode 2 ) ; \\ weight 2 = 1 - weight 1.\end{matrix}$$

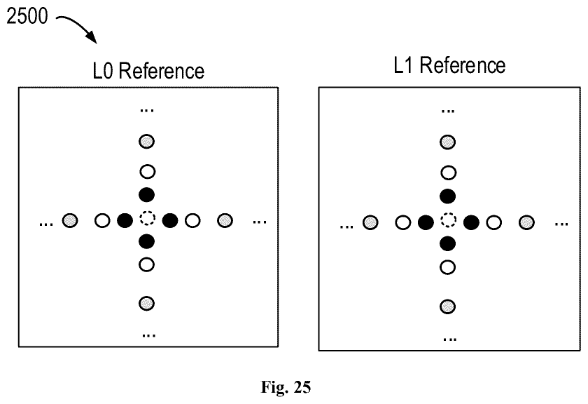

2.21. Merge Mode with MVD (MMVD)
In addition to merge mode, where the implicitly derived motion information is directly used for prediction samples generation of the current CU, the merge mode with motion vector differences (MMVD) is introduced in VVC. A MMVD flag is signalled right after sending a regular merge flag to specify whether MMVD mode is used for a CU.
In MMVD, after a merge candidate is selected, it is further refined by the signalled MVDs information. The further information includes a merge candidate flag, an index to specify motion magnitude, and an index for indication of motion direction. In MMVD mode, one for the first two candidates in the merge list is selected to be used as MV basis. The MMVD candidate flag is signalled to specify which one is used between the first and second merge candidates.
FIG. 25 illustrates MVD search point. Distance index specifies motion magnitude information and indicate the pre-defined offset from the starting point. As shown in FIG. 25, an offset is added to either horizontal component or vertical component of starting MV. The relation of distance index and pre-defined offset is specified in Table 6.

TABLE 6
The relation of distance index and pre-defined offset

| Distance IDX | 0 | 1 | 2 | 3 | 4 | 5 | 6 | 7 |
|---|---|---|---|---|---|---|---|---|
| Offset (in unit of | ¼ | ½ | 1 | 2 | 4 | 8 | 16 | 32 |
| luma sample) | | | | | | | | |

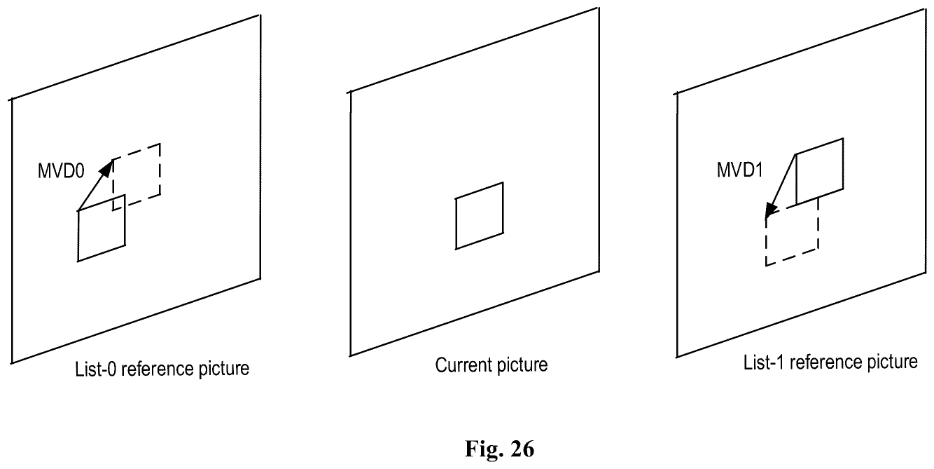

Direction index represents the direction of the MVD relative to the starting point. The direction index can represent of the four directions as shown in Table 7. It's noted that the meaning of MVD sign could be variant according to the information of starting MVs. When the starting MVs is an un-prediction MV or bi-prediction MVs with both lists point to the same side of the current picture (i.e. POCs of two references are both larger than the POC of the current picture, or are both smaller than the POC of the current picture), the sign in Table 7 specifies the sign of MV offset added to the starting MV. When the starting MVs is bi-prediction MVs with the two MVs point to the different sides of the current picture (i.e. the POC of one reference is larger than the POC of the current picture, and the POC of the other reference is smaller than the POC of the current picture), and the difference of POC in list 0 is greater than the one in list 1, the sign in Table 7 specifies the sign of MV offset added to the list0 MV component of starting MV and the sign for the list1 MV has opposite value. Otherwise, if the difference of POC in list 1 is greater than list 0, the sign in Table 7 specifies the sign of MV offset added to the list1 MV component of starting MV and the sign for the list0 MV has opposite value.
The MVD is scaled according to the difference of POCs in each direction. If the differences of POCs in both lists are the same, no scaling is needed. Otherwise, if the difference of POC in list 0 is larger than the one of list 1, the MVD for list 1 is scaled, by defining the POC difference of L0 as td and POC difference of L1 as tb, described in FIG. 26. If the POC difference of L1 is greater than L0, the MVD for list 0 is scaled in the same way. If the starting MV is uni-predicted, the MVD is added to the available MV.

TABLE 7
Sign of MV offset specified by direction index

Direction IDX

| | 00 | 01 | 10 | 11 |
|---|---|---|---|---|
| x-axis | + | − | N/A | N/A |
| y-axis | N/A | N/A | + | − |

### 2.22. Symmetric MVD Coding

In VVC, besides the normal unidirectional prediction and bi-directional prediction mode MVD signalling, symmetric MVD mode for bi-predictional MVD signalling is applied. In the symmetric MVD mode, motion information including reference picture indices of both list-0 and list-1 and MVD of list-1 are not signaled but derived.
The decoding process of the symmetric MVD mode is as follows:
1. At slice level, variables BiDirPredFlag, RefIdxSymL0 and RefIdxSymL1 are derived as follows:
   If mvd_11_zero_flag is 1, BiDirPredFlag is set equal to 0.
   Otherwise, if the nearest reference picture in list-0 and the nearest reference picture in list-1 form a forward and backward pair of reference pictures or a backward and forward pair of reference pictures, BiDirPredFlag is set to 1, and both list-0 and list-1 reference pictures are short-term reference pictures. Otherwise BiDirPredFlag is set to 0.
2. At CU level, a symmetrical mode flag indicating whether symmetrical mode is used or not is explicitly signaled if the CU is bi-prediction coded and BiDirPredFlag is equal to 1.
   When the symmetrical mode flag is true, only mvp_10_flag, mvp_11_flag and MVD0 are explicitly signaled. The reference indices for list-0 and list-1 are set equal to the pair of reference pictures, respectively. MVD1 is set equal to (−MVD0). The final motion vectors are shown in below formula.

$$\{ \begin{matrix}( {mvx}_{0} , {mvy}_{0} ) = ( {mvpx}_{0} + {mvdx}_{0} , {mvpy}_{0} + {mvdy}_{0} ) \\ ( {mvx}_{1} , {mvy}_{1} ) = ( {mvpx}_{1} - {mvdx}_{0} , {mvpy}_{1} - {mvdy}_{0} )\end{matrix} \qquad ( 2 - 16 )$$

FIG. 26 illustrates symmetrical MVD mode. In the encoder, symmetric MVD motion estimation starts with initial MV evaluation. A set of initial MV candidates comprising of the MV obtained from uni-prediction search, the MV obtained from bi-prediction search and the MVs from the AMVP list. The one with the lowest rate-distortion cost is chosen to be the initial MV for the symmetric MVD motion search.

### 2.23. Bi-Directional Optical Flow (BDOF)

The bi-directional optical flow (BDOF) tool is included in VVC. BDOF, previously referred to as BIO, was included in the JEM. Compared to the JEM version, the BDOF in VVC is a simpler version that requires much less computation, especially in terms of number of multiplications and the size of the multiplier.
BDOF is used to refine the bi-prediction signal of a CU at the 4×4 subblock level. BDOF is applied to a CU if it satisfies all the following conditions:
The CU is coded using “true” bi-prediction mode, i.e., one of the two reference pictures is prior to the current picture in display order and the other is after the current picture in display order.
The distances (i.e. POC difference) from two reference pictures to the current picture are same.
Both reference pictures are short-term reference pictures.
The CU is not coded using affine mode or the SbTMVP merge mode.
CU has more than 64 luma samples.
Both CU height and CU width are larger than or equal to 8 luma samples.
BCW weight index indicates equal weight.
WP is not enabled for the current CU.
CIIP mode is not used for the current CU.
   BDOF is only applied to the luma component. As its name indicates, the BDOF mode is based on the optical flow concept, which assumes that the motion of an object is smooth. For each 4×4 subblock, a motion refinement (vₓ, v_{y}) is calculated by minimizing the difference between the L0 and L1 prediction samples. The motion refinement is then used to adjust the bi-predicted sample values in the 4×4 subblock. The following steps are applied in the BDOF process.
   First, the horizontal and vertical gradients,

$$\frac{\partial {I}^{( k )}}{\partial x} ( i , j ) \frac{\partial {I}^{( k )}}{\partial y} ( i , j ) ,$$

k=0, 1, of the two prediction signals are computed by directly calculating the difference between two neighboring samples, i.e.,

$$\begin{matrix}\frac{\partial {I}^{( k )}}{\partial x} ( i , j ) = ( ( {I}^{( k )} ( i + 1 , j ) >> shift 1 ) - ( {I}^{( k )} ( i - 1 , j ) >> shift 1 ) ) \\ \frac{\partial {I}^{( k )}}{\partial y} ( i , j ) = ( ( {I}^{( k )} ( i , j + 1 ) >> shift 1 ) - ( {I}^{( k )} ( i , j - 1 ) >> shift 1 ) )\end{matrix} \qquad ( 2 - 17 )$$

where I^{(k)}(i, j) are the sample value at coordinate (i, j) of the prediction signal in list k, k=0, 1, and shift1 is calculated based on the luma bit depth, bitDepth, as shift1=max(6, bitDepth−6).
Then, the auto- and cross-correlation of the gradients, S₁, S₂, S₃, S₅ and S₆, are calculated as

$$\begin{matrix}\begin{matrix}{S}_{1} = {\sum }_{( i , j ) ∈ Ω} Abs ( {ψ}_{x} ( i , j ) ) , & {S}_{3} = {\sum }_{( i , j ) ∈ Ω} θ ( i , j ) \cdot Sign ( {ψ}_{x} ( i , j ) )\end{matrix} \\ {S}_{2} = {\sum }_{( i , j ) ∈ Ω} {ψ}_{x} ( i , j ) \cdot Sign ( {ψ}_{y} ( i , j ) ) \\ \begin{matrix}{S}_{5} = {\sum }_{( i , j ) ∈ Ω} Abs ( {ψ}_{y} ( i , j ) ) , & {S}_{6} = {\sum }_{( i , j ) ∈ Ω} θ ( i , j ) \cdot Sign ( {ψ}_{y} ( i , j ) )\end{matrix}\end{matrix} \qquad ( 2 - 18 )$$

$$where$$

$$\begin{matrix}{ψ}_{x} ( i , j ) = ( \frac{\partial {I}^{( 1 )}}{\partial x} ( i , j ) + \frac{\partial {I}^{( 0 )}}{\partial x} ( i , j ) ) ≫ {n}_{a} \\ {ψ}_{y} ( i , j ) = ( \frac{\partial {I}^{( 1 )}}{\partial y} ( i , j ) + \frac{\partial {I}^{( 0 )}}{\partial y} ( i , j ) ) ≫ {n}_{a} \\ θ ( i , j ) = ( {I}^{( 1 )} ( i , j ) ≫ {n}_{b} ) - ( {I}^{( 0 )} ( i , j ) ≫ {n}_{b} )\end{matrix} \qquad ( 2 - 19 )$$

where Ω is a 6×6 window around the 4×4 subblock, and the values of nₐ and n_{b} are set equal to min(1, bitDepth—11) and min(4, bitDepth—8), respectively.
The motion refinement (vₓ, v_{y}) is then derived using the cross- and auto-correlation terms using the following:

$${v}_{x} = {S}_{1} > 0 ? clip 3 ( - {th}_{BIO}^{′} , {th}_{BIO}^{′} , - ( ( {S}_{3} \cdot {2}^{{n}_{b} - {n}_{α}} ) ≫ ⌊ {log}_{2} {S}_{1} ⌋ ) ) : 0 \qquad ( 2 - 20 )$$

$${v}_{y} = {S}_{5} > 0 ? clip 3 ( - {th}_{BIO}^{′} , {th}_{BIO}^{′} , - ( ( {S}_{6} \cdot {2}^{{n}_{b} - {n}_{α}} - ( ( {v}_{x} {S}_{2 , m} ) ≪ {n}_{{S}_{2}} + {v}_{x} {S}_{2 , s} ) / 2 ) ≫ ⌊ {log}_{2} {S}_{5} ⌋ ) ) : 0$$

where

$${S}_{2 , m} = {S}_{2} ≫ {n}_{{S}_{2}} , {S}_{2 , s} = {S}_{2} \& ( {2}^{{n}_{{S}_{2}}} - 1 ) ,$$

th′_{BIO}=2^{max(5,BD-7)}. └⋅┘ is the floor function, and n_{S}_{₂}=12. Based on the motion refinement and the gradients, the following adjustment is calculated for each sample in the 4×4 subblock:

$$b ( x , y ) = rnd ( ( {v}_{x} ( \frac{\partial {I}^{( 1 )} ( x , y )}{\partial x} - \frac{\partial {I}^{( 0 )} ( x , y )}{\partial x} ) + {v}_{y} ( \frac{\partial {I}^{( 1 )} ( x , y )}{\partial y} - \frac{\partial {I}^{( 0 )} ( x , y )}{\partial y} ) + 1 ) / 2 ) \qquad ( 2 - 21 )$$

Finally, the BDOF samples of the CU are calculated by adjusting the bi-prediction samples as follows:

$${pred}_{BDOF} ( x , y ) = ( {I}^{( 0 )} ( x , y ) + {I}^{( 1 )} ( x , y ) + b ( x , y ) + {o}_{offset} ) >> shift \qquad ( 2 - 22 )$$

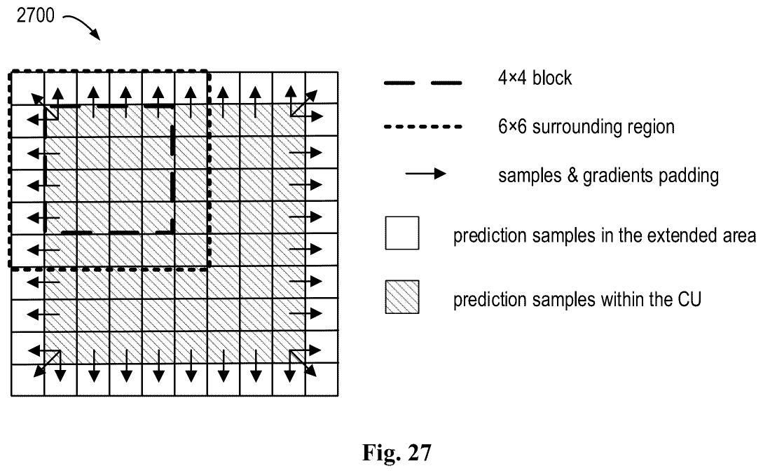

These values are selected such that the multipliers in the BDOF process do not exceed 15-bit, and the maximum bit-width of the intermediate parameters in the BDOF process is kept within 32-bit.
In order to derive the gradient values, some prediction samples I^{(k)}(i, j) in list k (k=0, 1) outside of the current CU boundaries need to be generated. As depicted in FIG. 25, the BDOF in VVC uses one extended row/column around the CU's boundaries. In order to control the computational complexity of generating the out-of-boundary prediction samples, prediction samples in the extended area (white positions) are generated by taking the reference samples at the nearby integer positions (using floor( ) operation on the coordinates) directly without interpolation, and the normal 8-tap motion compensation interpolation filter is used to generate prediction samples within the CU (gray positions). These extended sample values are used in gradient calculation only. For the remaining steps in the BDOF process, if any sample and gradient values outside of the CU boundaries are needed, they are padded (i.e. repeated) from their nearest neighbors.
FIG. 27 illustrates Extended CU region used in BDOF.
When the width and/or height of a CU are larger than 16 luma samples, it will be split into subblocks with width and/or height equal to 16 luma samples, and the subblock boundaries are treated as the CU boundaries in the BDOF process. The maximum unit size for BDOF process is limited to 16×16. For each subblock, the BDOF process could skipped. When the SAD of between the initial L0 and L1 prediction samples is smaller than a threshold, the BDOF process is not applied to the subblock. The threshold is set equal to (8*W*(H>>1), where W indicates the subblock width, and H indicates subblock height. To avoid the additional complexity of SAD calculation, the SAD between the initial L0 and L1 prediction samples calculated in DVMR process is reused here.
If BCW is enabled for the current block, i.e., the BCW weight index indicates unequal weight, then bi-directional optical flow is disabled. Similarly, if WP is enabled for the current block, i.e., the luma_weight_1x_flag is 1 for either of the two reference pictures, then BDOF is also disabled. When a CU is coded with symmetric MVD mode or CIIP mode, BDOF is also disabled.

### 2.24. Combined Inter and Intra Prediction (CIIP)

### 2.25. Affine Motion Compensated Prediction

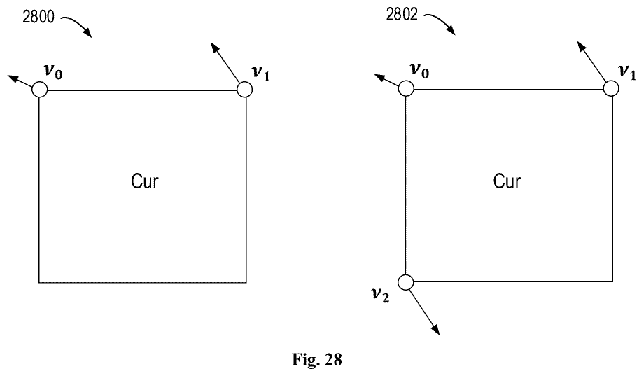

In HEVC, only translation motion model is applied for motion compensation prediction (MCP). While in the real world, there are many kinds of motion, e.g., zoom in/out, rotation, perspective motions and the other irregular motions. In VVC, a block-based affine transform motion compensation prediction is applied. As shown FIG. 28, the affine motion field of the block is described by motion information of two control point (4-parameter) or three control point motion vectors (6-parameter).
FIG. 28 illustrates control point based affine motion model. In FIG. 28, both 4-parameter affine model and 6-parameter affine model are shown.
For 4-parameter affine motion model, motion vector at sample location (x, y) in a block is derived as:

$$\{ \begin{matrix}{mv}_{x} = \frac{{mv}_{1 x} - {mv}_{0 x}}{W} x + \frac{{mv}_{1 y} - {mv}_{0 y}}{W} y + {mv}_{0 x} \\ {mv}_{y} = \frac{{mv}_{1 y} - {mv}_{0 y}}{W} x + \frac{{mv}_{1 y} - {mv}_{0 x}}{W} y + {mv}_{0 y}\end{matrix} \qquad ( 2 - 23 )$$

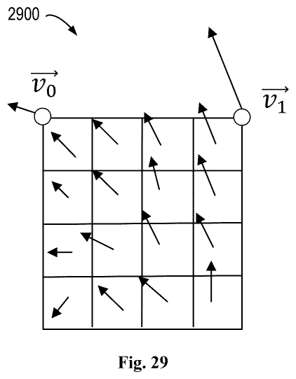

For 6-parameter affine motion model, motion vector at sample location (x, y) in a block is derived as:

$$\{ \begin{matrix}{mv}_{x} = \frac{{mv}_{1 x} - {mv}_{0 x}}{W} x + \frac{{mv}_{2 x} - {mv}_{0 x}}{H} y + {mv}_{0 x} \\ {mv}_{y} = \frac{{mv}_{1 y} - {mv}_{0 y}}{W} x + \frac{{mv}_{2 y} - {mv}_{0 y}}{H} y + {mv}_{0 y}\end{matrix} \qquad ( 2 - 24 )$$

Where (mv₀ₓ, mv_{0y}) is motion vector of the top-left corner control point, (mv₁ₓ, mv_{1y}) is motion vector of the top-right corner control point, and (mv₂ₓ, mv_{2y}) is motion vector of the bottom-left corner control point.
In order to simplify the motion compensation prediction, block based affine transform prediction is applied. To derive motion vector of each 4×4 luma subblock, the motion vector of the center sample of each subblock, as shown in FIG. 29 is calculated according to above equations, and rounded to 1/16 fraction accuracy. Then the motion compensation interpolation filters are applied to generate the prediction of each subblock with derived motion vector. The subblock size of chroma-components is also set to be 4×4. The MV of a 4×4 chroma subblock is calculated as the average of the MVs of the four corresponding 4×4 luma subblocks. FIG. 29 illustrates Affine MVF per subblock.
As done for translational motion inter prediction, there are also two affine motion inter prediction modes: affine merge mode and affine AMVP mode.

### 2.25.1. Affine Merge Prediction

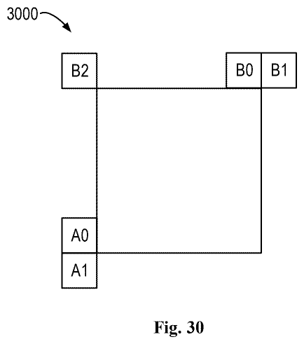

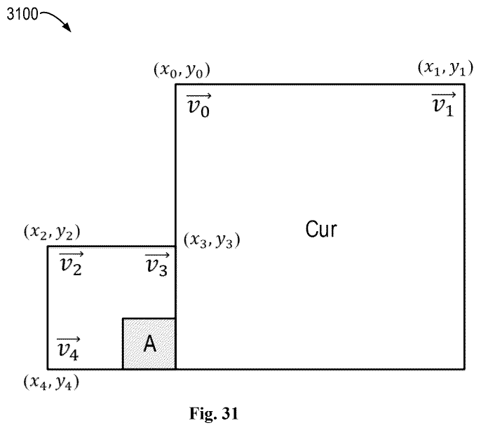

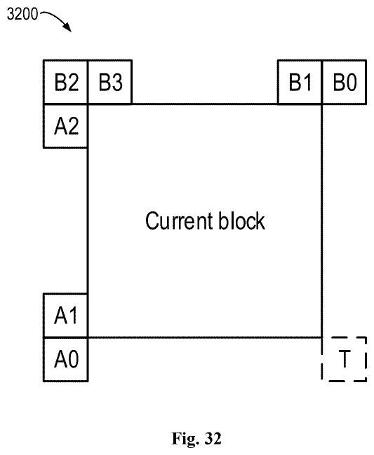

AF_MERGE mode can be applied for CUs with both width and height larger than or equal to 8. In this mode the CPMVs of the current CU is generated based on the motion information of the spatial neighbouring CUs. There can be up to five CPMVP candidates and an index is signalled to indicate the one to be used for the current CU. The following three types of CPVM candidate are used to form the affine merge candidate list:
Inherited affine merge candidates that extrapolated from the CPMVs of the neighbour CUs.
Constructed affine merge candidates CPMVPs that are derived using the translational MVs of the neighbour CUs.
Zero MVs.
   In VVC, there are maximum two inherited affine candidates, which are derived from affine motion model of the neighbouring blocks, one from left neighbouring CUs and one from above neighbouring CUs. The candidate blocks are shown in FIG. 30. For the left predictor, the scan order is A0->A1, and for the above predictor, the scan order is B0->B1->B2. Only the first inherited candidate from each side is selected. No pruning check is performed between two inherited candidates. When a neighbouring affine CU is identified, its control point motion vectors are used to derive the CPMVP candidate in the affine merge list of the current CU. As shown in, if the neighbour left bottom block A is coded in affine mode, the motion vectors v₂, v₃ and v₄ of the top left corner, above right corner and left bottom corner of the CU which contains the block A are attained. When block A is coded with 4-parameter affine model, the two CPMVs of the current CU are calculated according to v₂, and v₃. In case that block A is coded with 6-parameter affine model, the three CPMVs of the current CU are calculated according to v₂, v₃ and v₄. FIG. 30 illustrates locations of inherited affine motion predictors. FIG. 31 illustrates control point motion vector inheritance.
   Constructed affine candidate means the candidate is constructed by combining the neighbour translational motion information of each control point. The motion information for the control points is derived from the specified spatial neighbours and temporal neighbour shown in FIG. 31. CPMVₖ (k=1, 2, 3, 4) represents the k-th control point. For CPMV₁, the B2->B3->A2 blocks are checked and the MV of the first available block is used. For CPMV₂, the B1->B0 blocks are checked and for CPMV₃, the A1->A0 blocks are checked. For TMVP is used as CPMV₄ if it's available.
   After MVs of four control points are attained, affine merge candidates are constructed based on that motion information. The following combinations of control point MVs are used to construct in order:
{CPMV₁, CPMV₂, CPMV₃}, {CPMV₁, CPMV₂, CPMV₄}, {CPMV₁, CPMV₃, CPMV₄},
{CPMV₂, CPMV₃, CPMV₄}, {CPMV₁, CPMV₂}, {CPMV₁, CPMV₃}.
   The combination of 3 CPMVs constructs a 6-parameter affine merge candidate and the combination of 2 CPMVs constructs a 4-parameter affine merge candidate. To avoid motion scaling process, if the reference indices of control points are different, the related combination of control point MVs is discarded. FIG. 32 illustrates Locations of Candidates position for constructed affine merge mode.
   After inherited affine merge candidates and constructed affine merge candidate are checked, if the list is still not full, zero MVs are inserted to the end of the list.

### 2.25.2. Affine AMVP Prediction

Affine AMVP mode can be applied for CUs with both width and height larger than or equal to 16. An affine flag in CU level is signalled in the bitstream to indicate whether affine AMVP mode is used and then another flag is signalled to indicate whether 4-parameter affine or 6-parameter affine. In this mode, the difference of the CPMVs of current CU and their predictors CPMVPs is signalled in the bitstream. The affine AVMP candidate list size is 2 and it is generated by using the following four types of CPVM candidate in order:
Inherited affine AMVP candidates that extrapolated from the CPMVs of the neighbour CUs.
Constructed affine AMVP candidates CPMVPs that are derived using the translational MVs of the neighbour CUs.
Translational MVs from neighbouring CUs.
Zero MVs.
   The checking order of inherited affine AMVP candidates is same to the checking order of inherited affine merge candidates. The only difference is that, for AVMP candidate, only the affine CU that has the same reference picture as in current block is considered. No pruning process is applied when inserting an inherited affine motion predictor into the candidate list.
   Constructed AMVP candidate is derived from the specified spatial neighbours shown in FIG. 15. The same checking order is used as done in affine merge candidate construction. In addition, reference picture index of the neighbouring block is also checked. The first block in the checking order that is inter coded and has the same reference picture as in current CUs is used. There is only one When the current CU is coded with 4-parameter affine mode, and mv₀ and mv₁ are both available, they are added as one candidate in the affine AMVP list. When the current CU is coded with 6-parameter affine mode, and all three CPMVs are available, they are added as one candidate in the affine AMVP list. Otherwise, constructed AMVP candidate is set as unavailable.
   If affine AMVP list candidates is still less than 2 after inherited affine AMVP candidates and Constructed AMVP candidate are checked, mv₀, mv₁, and mv₂ will be added, in order, as the translational MVs to predict all control point MVs of the current CU, when available. Finally, zero MVs are used to fill the affine AMVP list if it is still not full.

### 2.25.3. Affine Motion Information Storage

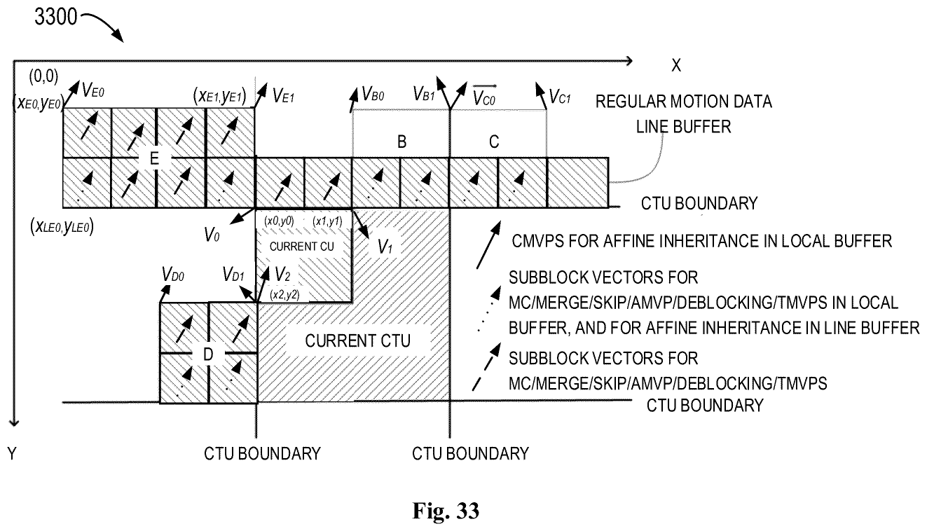

In VVC, the CPMVs of affine CUs are stored in a separate buffer. The stored CPMVs are only used to generate the inherited CPMVPs in affine merge mode and affine AMVP mode for the lately coded CUs. The subblock MVs derived from CPMVs are used for motion compensation, MV derivation of merge/AMVP list of translational MVs and de-blocking.
To avoid the picture line buffer for the additional CPMVs, affine motion data inheritance from the CUs from above CTU is treated differently to the inheritance from the normal neighbouring CUs. If the candidate CU for affine motion data inheritance is in the above CTU line, the bottom-left and bottom-right subblock MVs in the line buffer instead of the CPMVs are used for the affine MVP derivation. In this way, the CPMVs are only stored in local buffer. If the candidate CU is 6-parameter affine coded, the affine model is degraded to 4-parameter model. As shown in FIG. 16, along the top CTU boundary, the bottom-left and bottom right subblock motion vectors of a CU are used for affine inheritance of the CUs in bottom CTUs. FIG. 33 illustrates Illustration of motion vector usage for proposed combined method.
2.25.4. Prediction Refinement with Optical Flow for Affine Mode
Subblock based affine motion compensation can save memory access bandwidth and reduce computation complexity compared to pixel-based motion compensation, at the cost of prediction accuracy penalty. To achieve a finer granularity of motion compensation, prediction refinement with optical flow (PROF) is used to refine the subblock based affine motion compensated prediction without increasing the memory access bandwidth for motion compensation. In VVC, after the subblock based affine motion compensation is performed, luma prediction sample is refined by adding a difference derived by the optical flow equation. The PROF is described as following four steps:
Step 1) The subblock-based affine motion compensation is performed to generate subblock prediction I(i, j).
Step 2) The spatial gradients gₓ(i, j) and g_{y}(i, j) of the subblock prediction are calculated at each sample location using a 3-tap filter [−1, 0, 1]. The gradient calculation is exactly the same as gradient calculation in BDOF.

$${g}_{x} ( i , j ) = ( I ( i + 1 , j ) >> shift 1 ) - ( I ( i - 1 , j ) >> shift1 ) \qquad ( 2 - 25 )$$

$${g}_{y} ( i , j ) = ( I ( i , j + 1 ) >> shift 1 ) - ( I ( i , j - 1 ) >> shift1 ) \qquad ( 2 - 26 )$$

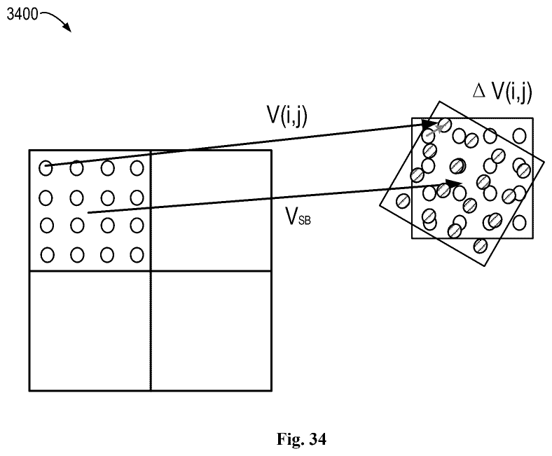

shift1 is used to control the gradient's precision. The subblock (i.e. 4×4) prediction is extended by one sample on each side for the gradient calculation. To avoid additional memory bandwidth and additional interpolation computation, those extended samples on the extended borders are copied from the nearest integer pixel position in the reference picture.
Step 3) The luma prediction refinement is calculated by the following optical flow equation.

$$Δ I ( i , j ) = {g}_{x} ( i , j ) * Δ {v}_{x} ( i , j ) + {g}_{y} ( i , j ) * Δ {v}_{y} ( i , j ) \qquad ( 2 - 27 )$$

where the Δv(i, j) is the difference between sample MV computed for sample location (i, j), denoted by v(i, j), and the subblock MV of the subblock to which sample (i, j) belongs, as shown in FIG. 34. The Δv(i, j) is quantized in the unit of 1/32 luma sample precision. FIG. 34 illustrates Subblock MV V_{SB} and pixel Δv(i, j) (shown by gray arrow).
Since the affine model parameters and the sample location relative to the subblock center are not changed from subblock to subblock, Δv(i, j) can be calculated for the first subblock, and reused for other subblocks in the same CU. Let dx(i, j) and dy(i, j) be the horizontal and vertical offset from the sample location (i, j) to the center of the subblock (x_{SB}, y_{SB}), Δv(x, y) can be derived by the following equation.

$$\{ \begin{matrix}dx ( i , j ) = i - {x}_{SB} \\ dy ( i , j ) = j - {y}_{SB}\end{matrix} \qquad ( 2 - 28 )$$

$$\{ \begin{matrix}Δ {v}_{x} ( i , j ) = C * dx ( i , j ) + D * dy ( i , j ) \\ Δ {v}_{y} ( i , j ) = E * dx ( i , j ) + F * dy ( i , j )\end{matrix} \qquad ( 2 - 29 )$$

In order to keep accuracy, the enter of the subblock (x_{SB}, y_{SB}) is calculated as ((W_{SB}−1)/2, (H_{SB}−1)/2), where W_{SB} and H_{SB} are the subblock width and height, respectively.
For 4-parameter affine model,

$$\{ \begin{matrix}C = F = \frac{{v}_{1 x} - {v}_{0 x}}{w} \\ E = - D = \frac{{v}_{1 y} - {v}_{0 y}}{w}\end{matrix} \qquad ( 2 - 30 )$$

For 6-parameter affine model,

$$\{ \begin{matrix}C = \frac{{v}_{1 x} - {v}_{ox}}{w} \\ D = \frac{{v}_{2 x} - {v}_{ox}}{h} \\ E = \frac{{v}_{1 y} - {v}_{0 y}}{w} \\ F = \frac{{v}_{2 y} - {v}_{0 y}}{h}\end{matrix} \qquad ( 2 - 31 )$$

where (v₀ₓ, v_{0y}), (v₁ₓ, v_{1y}), (v₂ₓ, v_{2y}) are the top-left, top-right and bottom-left control point motion vectors, w and h are the width and height of the CU.
Step 4) Finally, the luma prediction refinement ΔI(i, j) is added to the subblock prediction I(i, j). The final prediction I′ is generated as the following equation.

$${I}^{′} ( i , j ) = I ( i , j ) + Δ I ( i , j ) \qquad ( 2 - 32 )$$

PROF is not be applied in two cases for an affine coded CU: 1) all control point MVs are the same, which indicates the CU only has translational motion; 2) the affine motion parameters are greater than a specified limit because the subblock based affine MC is degraded to CU based MC to avoid large memory access bandwidth requirement.
A fast encoding method is applied to reduce the encoding complexity of affine motion estimation with PROF. PROF is not applied at affine motion estimation stage in following two situations: a) if this CU is not the root block and its parent block does not select the affine mode as its best mode, PROF is not applied since the possibility for current CU to select the affine mode as best mode is low; b) if the magnitude of four affine parameters (C, D, E, F) are all smaller than a predefined threshold and the current picture is not a low delay picture, PROF is not applied because the improvement introduced by PROF is small for this case. In this way, the affine motion estimation with PROF can be accelerated.

### 2.26. Subblock-Based Temporal Motion Vector Prediction (SbTMVP)

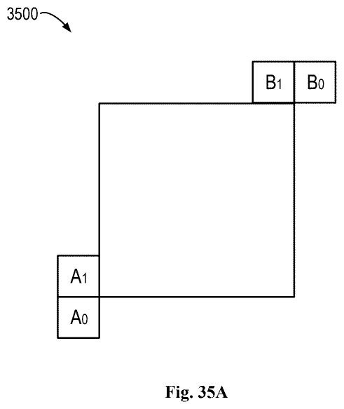

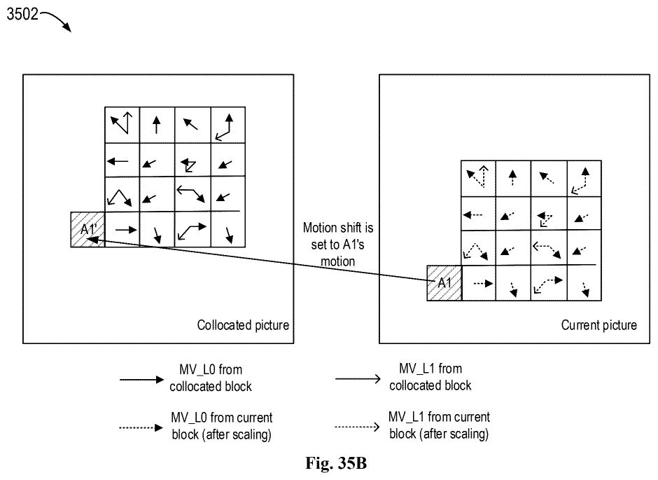

VVC supports the subblock-based temporal motion vector prediction (SbTMVP) method. Similar to the temporal motion vector prediction (TMVP) in HEVC, SbTMVP uses the motion field in the collocated picture to improve motion vector prediction and merge mode for CUs in the current picture. The same collocated picture used by TMVP is used for SbTVMP. SbTMVP differs from TMVP in the following two main aspects:
TMVP predicts motion at CU level, but SbTMVP predicts motion at sub-CU level;
Whereas TMVP fetches the temporal motion vectors from the collocated block in the collocated picture (the collocated block is the bottom-right or center block relative to the current CU), SbTMVP applies a motion shift before fetching the temporal motion information from the collocated picture, where the motion shift is obtained from the motion vector from one of the spatial neighboring blocks of the current CU.
   The SbTVMP process is illustrated in FIG. 18A. SbTMVP predicts the motion vectors of the sub-CUs within the current CU in two steps. In the first step, the spatial neighbor A1 in FIG. 18A is examined. If A1 has a motion vector that uses the collocated picture as its reference picture, this motion vector is selected to be the motion shift to be applied. If no such motion is identified, then the motion shift is set to (0, 0).
   In the second step, the motion shift identified in Step 1 is applied (i.e., added to the current block's coordinates) to obtain sub-CU-level motion information (motion vectors and reference indices) from the collocated picture as shown in FIG. 18B. The example in FIG. 18B assumes the motion shift is set to block A1's motion. Then, for each sub-CU, the motion information of its corresponding block (the smallest motion grid that covers the center sample) in the collocated picture is used to derive the motion information for the sub-CU. After the motion information of the collocated sub-CU is identified, it is converted to the motion vectors and reference indices of the current sub-CU in a similar way as the TMVP process of HEVC, where temporal motion scaling is applied to align the reference pictures of the temporal motion vectors to those of the current CU. FIG. 35A and FIG. 35B illustrate The SbTMVP process in VVC. FIG. 35A illustrates Spatial neighboring blocks used by ATVMP. FIG. 35B illustrates Deriving sub-CU motion field by applying a motion shift from spatial neighbor and scaling the motion information from the corresponding collocated sub-CUs.
   In VVC, a combined subblock based merge list which contains both SbTVMP candidate and affine merge candidates is used for the signalling of subblock based merge mode. The SbTVMP mode is enabled/disabled by a sequence parameter set (SPS) flag. If the SbTMVP mode is enabled, the SbTMVP predictor is added as the first entry of the list of subblock based merge candidates, and followed by the affine merge candidates. The size of subblock based merge list is signalled in SPS and the maximum allowed size of the subblock based merge list is 5 in VVC.
   The sub-CU size used in SbTMVP is fixed to be 8×8, and as done for affine merge mode, SbTMVP mode is only applicable to the CU with both width and height are larger than or equal to 8.
   The encoding logic of the additional SbTMVP merge candidate is the same as for the other merge candidates, that is, for each CU in P or B slice, an additional RD check is performed to decide whether to use the SbTMVP candidate.

### 2.27. Adaptive Motion Vector Resolution (AMVR)

In HEVC, motion vector differences (MVDs) (between the motion vector and predicted motion vector of a CU) are signalled in units of quarter-luma-sample when use_integer_mv_flag is equal to 0 in the slice header. In VVC, a CU-level adaptive motion vector resolution (AMVR) scheme is introduced. AMVR allows MVD of the CU to be coded in different precision. Dependent on the mode (normal AMVP mode or affine AVMP mode) for the current CU, the MVDs of the current CU can be adaptively selected as follows:
Normal AMVP mode: quarter-luma-sample, half-luma-sample, integer-luma-sample or four-luma-sample.
Affine AMVP mode: quarter-luma-sample, integer-luma-sample or 1/16 luma-sample.
   The CU-level MVD resolution indication is conditionally signalled if the current CU has at least one non-zero MVD component. If all MVD components (that is, both horizontal and vertical MVDs for reference list L0 and reference list L1) are zero, quarter-luma-sample MVD resolution is inferred.
   For a CU that has at least one non-zero MVD component, a first flag is signalled to indicate whether quarter-luma-sample MVD precision is used for the CU. If the first flag is 0, no further signaling is needed and quarter-luma-sample MVD precision is used for the current CU. Otherwise, a second flag is signalled to indicate half-luma-sample or other MVD precisions (integer or four-luma sample) is used for normal AMVP CU. In the case of half-luma-sample, a 6-tap interpolation filter instead of the default 8-tap interpolation filter is used for the half-luma sample position. Otherwise, a third flag is signalled to indicate whether integer-luma-sample or four-luma-sample MVD precision is used for normal AMVP CU. In the case of affine AMVP CU, the second flag is used to indicate whether integer-luma-sample or 1/16 luma-sample MVD precision is used. In order to ensure the reconstructed MV has the intended precision (quarter-luma-sample, half-luma-sample, integer-luma-sample or four-luma-sample), the motion vector predictors for the CU will be rounded to the same precision as that of the MVD before being added together with the MVD. The motion vector predictors are rounded toward zero (that is, a negative motion vector predictor is rounded toward positive infinity and a positive motion vector predictor is rounded toward negative infinity).
   The encoder determines the motion vector resolution for the current CU using RD check. To avoid always performing CU-level RD check four times for each MVD resolution, in VTM11, the RD check of MVD precisions other than quarter-luma-sample is only invoked conditionally. For normal AVMP mode, the RD cost of quarter-luma-sample MVD precision and integer-luma sample MV precision is computed first. Then, the RD cost of integer-luma-sample MVD precision is compared to that of quarter-luma-sample MVD precision to decide whether it is necessary to further check the RD cost of four-luma-sample MVD precision. When the RD cost for quarter-luma-sample MVD precision is much smaller than that of the integer-luma-sample MVD precision, the RD check of four-luma-sample MVD precision is skipped. Then, the check of half-luma-sample MVD precision is skipped if the RD cost of integer-luma-sample MVD precision is significantly larger than the best RD cost of previously tested MVD precisions. For affine AMVP mode, if affine inter mode is not selected after checking rate-distortion costs of affine merge/skip mode, merge/skip mode, quarter-luma-sample MVD precision normal AMVP mode and quarter-luma-sample MVD precision affine AMVP mode, then 1/16 luma-sample MV precision and 1-pel MV precision affine inter modes are not checked. Furthermore, affine parameters obtained in quarter-luma-sample MV precision affine inter mode is used as starting search point in 1/16 luma-sample and quarter-luma-sample MV precision affine inter modes.
   2.28. Bi-Prediction with CU-Level Weight (BCW)
   In HEVC, the bi-prediction signal is generated by averaging two prediction signals obtained from two different reference pictures and/or using two different motion vectors. In VVC, the bi-prediction mode is extended beyond simple averaging to allow weighted averaging of the two prediction signals.

$${P}_{bi - pred} = ( ( 8 - w ) * {P}_{0} + w * {P}_{1} + 4 ) >> 3 \qquad ( 2 - 33 )$$

Five weights are allowed in the weighted averaging bi-prediction, w∈{−2, 3, 4, 5, 10}. For each bi-predicted CU, the weight w is determined in one of two ways: 1) for a non-merge CU, the weight index is signalled after the motion vector difference; 2) for a merge CU, the weight index is inferred from neighbouring blocks based on the merge candidate index. BCW is only applied to CUs with 256 or more luma samples (i.e., CU width times CU height is greater than or equal to 256). For low-delay pictures, all 5 weights are used. For non-low-delay pictures, only 3 weights (w∈{3,4,5}) are used.
At the encoder, fast search algorithms are applied to find the weight index without significantly increasing the encoder complexity. These algorithms are summarized as follows. When combined with AMVR, unequal weights are only conditionally checked for 1-pel and 4-pel motion vector precisions if the current picture is a low-delay picture.
When combined with affine, affine ME will be performed for unequal weights if and only if the affine mode is selected as the current best mode.
When the two reference pictures in bi-prediction are the same, unequal weights are only conditionally checked.
Unequal weights are not searched when certain conditions are met, depending on the POC distance between current picture and its reference pictures, the coding QP, and the temporal level.
   The BCW weight index is coded using one context coded bin followed by bypass coded bins. The first context coded bin indicates if equal weight is used; and if unequal weight is used, additional bins are signalled using bypass coding to indicate which unequal weight is used.
   Weighted prediction (WP) is a coding tool supported by the H.264/AVC and HEVC standards to efficiently code video content with fading. Support for WP was also added into the VVC standard. WP allows weighting parameters (weight and offset) to be signalled for each reference picture in each of the reference picture lists L0 and L1. Then, during motion compensation, the weight(s) and offset(s) of the corresponding reference picture(s) are applied. WP and BCW are designed for different types of video content. In order to avoid interactions between WP and BCW, which will complicate VVC decoder design, if a CU uses WP, then the BCW weight index is not signalled, and w is inferred to be 4 (i.e. equal weight is applied). For a merge CU, the weight index is inferred from neighbouring blocks based on the merge candidate index. This can be applied to both normal merge mode and inherited affine merge mode. For constructed affine merge mode, the affine motion information is constructed based on the motion information of up to 3 blocks. The BCW index for a CU using the constructed affine merge mode is simply set equal to the BCW index of the first control point MV.
   In VVC, CIIP and BCW cannot be jointly applied for a CU. When a CU is coded with CIIP mode, the BCW index of the current CU is set to 2, e.g., equal weight.

### 2.29. Local Illumination Compensation (LIC)

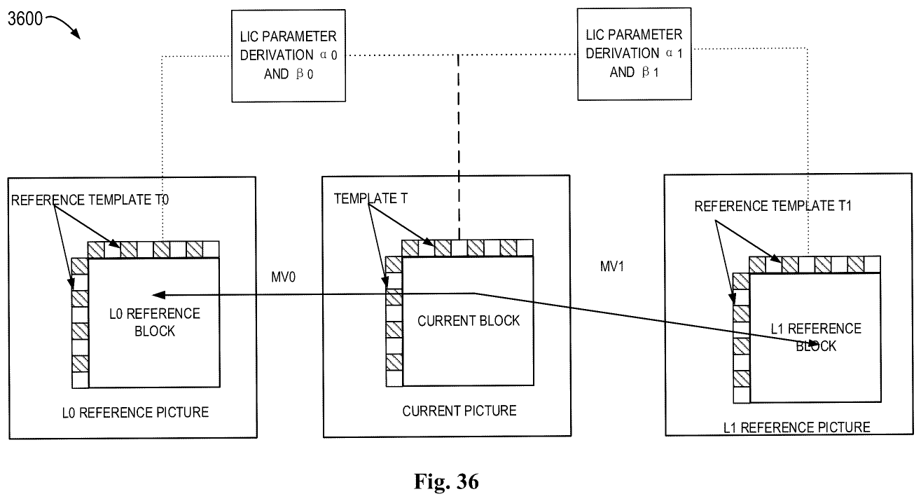

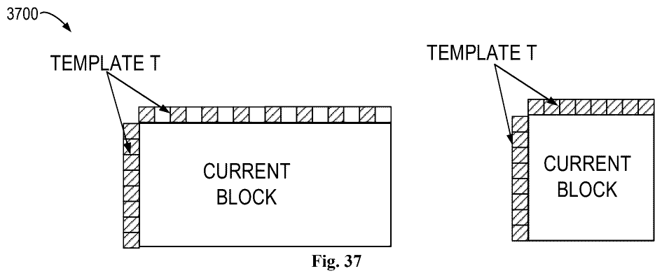

Local illumination compensation (LIC) is a coding tool to address the issue of local illumination changes between current picture and its temporal reference pictures. The LIC is based on a linear model where a scaling factor and an offset are applied to the reference samples to obtain the prediction samples of a current block. Specifically, the LIC can be mathematically modeled by the following equation:

$$P ( x , y ) = α \cdot {P}_{r} ( x + {v}_{x} , y + {v}_{y} ) + β$$

where P(x, y) is the prediction signal of the current block at the coordinate (x, y); Pᵣ(x+vₓ, y+v_{y}) is the reference block pointed by the motion vector (vₓ, v_{y}); α and β are the corresponding scaling factor and offset that are applied to the reference block. FIG. 36 illustrates the LIC process. In FIG. 36, when the LIC is applied for a block, a least mean square error (LMSE) method is employed to derive the values of the LIC parameters (i.e., α and β) by minimizing the difference between the neighboring samples of the current block (i.e., the template T in FIG. 36) and their corresponding reference samples in the temporal reference pictures (i.e., either T0 or T1 in FIG. 36). Additionally, to reduce the computational complexity, both the template samples and the reference template samples are subsampled (adaptive subsampling) to derive the LIC parameters, i.e., only the shaded samples in FIG. 36 are used to derive α and β.
To improve the coding performance, no subsampling for the short side is performed as shown in FIG. 37. FIG. 36 illustrates local illumination compensation. FIG. 37 illustrates no subsampling for the short side.

### 2.30. Decoder Side Motion Vector Refinement (DMVR)

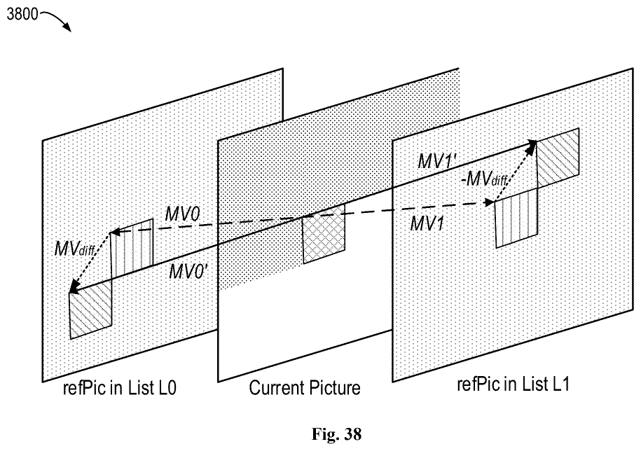

In order to increase the accuracy of the MVs of the merge mode, a bilateral-matching (BM) based decoder side motion vector refinement is applied in VVC. In bi-prediction operation, a refined MV is searched around the initial MVs in the reference picture list L0 and reference picture list L1. The BM method calculates the distortion between the two candidate blocks in the reference picture list L0 and list L1. As illustrated in FIG. 21, the SAD between the two blocks based on each MV candidate (e.g., MV0′ and MV1′) around the initial MV is calculated. The MV candidate with the lowest SAD becomes the refined MV and used to generate the bi-predicted signal. FIG. 38 illustrates Decoding side motion vector refinement. In VVC, the application of DMVR is restricted and is only applied for the CUs which are coded with following modes and features:
CU level merge mode with bi-prediction MV.
One reference picture is in the past and another reference picture is in the future with respect to the current picture.
The distances (i.e. POC difference) from two reference pictures to the current picture are same.
Both reference pictures are short-term reference pictures.
CU has more than 64 luma samples.
Both CU height and CU width are larger than or equal to 8 luma samples.
BCW weight index indicates equal weight.
WP is not enabled for the current block.
CIIP mode is not used for the current block.
   The refined MV derived by DMVR process is used to generate the inter prediction samples and also used in temporal motion vector prediction for future pictures coding. While the original MV is used in deblocking process and also used in spatial motion vector prediction for future CU coding.
   The additional features of DMVR are mentioned in the following sub-clauses.

### 2.30.1. Searching Scheme

In DVMR, the search points are surrounding the initial MV and the MV offset obey the MV difference mirroring rule. In other words, any points that are checked by DMVR, denoted by candidate MV pair (MV0, MV1) obey the following two equations:

$$MV {0}^{′} = MV 0 + MV\_offset \qquad ( 2 - 34 )$$

$$MV {1}^{′} = MV 1 - MV\_offset \qquad ( 2 - 35 )$$

Where MV_offset represents the refinement offset between the initial MV and the refined MV in one of the reference pictures. The refinement search range is two integer luma samples from the initial MV. The searching includes the integer sample offset search stage and fractional sample refinement stage.
25 points full search is applied for integer sample offset searching. The SAD of the initial MV pair is first calculated. If the SAD of the initial MV pair is smaller than a threshold, the integer sample stage of DMVR is terminated. Otherwise SADs of the remaining 24 points are calculated and checked in raster scanning order. The point with the smallest SAD is selected as the output of integer sample offset searching stage. To reduce the penalty of the uncertainty of DMVR refinement, it is proposed to favor the original MV during the DMVR process. The SAD between the reference blocks referred by the initial MV candidates is decreased by ¼ of the SAD value.
The integer sample search is followed by fractional sample refinement. To save the calculational complexity, the fractional sample refinement is derived by using parametric error surface equation, instead of additional search with SAD comparison. The fractional sample refinement is conditionally invoked based on the output of the integer sample search stage. When the integer sample search stage is terminated with center having the smallest SAD in either the first iteration or the second iteration search, the fractional sample refinement is further applied.
In parametric error surface based sub-pixel offsets estimation, the center position cost and the costs at four neighboring positions from the center are used to fit a 2-D parabolic error surface equation of the following form:

$$E ( x , y ) = {A ( x - {x}_{min} )}^{2} + {B ( y - {y}_{min} )}^{2} + C \qquad ( 2 - 36 )$$

where (xₘᵢₙ, yₘᵢₙ) corresponds to the fractional position with the least cost and C corresponds to the minimum cost value. By solving the above equations by using the cost value of the five search points, the (xₘᵢₙ, yₘᵢₙ) is computed as:

$${x}_{min} = ( E ( - 1 , 0 ) - E ( 1 , 0 ) ) / ( 2 ( E ( - 1 , 0 ) + E ( 1 , 0 ) - 2 E ( 0 , 0 ) ) ) \qquad ( 2 - 37 )$$

$${y}_{min} = ( E ( 0 , - 1 ) - E ( 0 , 1 ) ) / ( 2 ( ( E ( 0 , - 1 ) + E ( 0 , 1 ) - 2 E ( 0 , 0 ) ) ) \qquad ( 2 - 38 )$$

The value of xₘᵢₙ and yₘᵢₙ are automatically constrained to be between−8 and 8 since all cost values are positive and the smallest value is E(0,0). This corresponds to half peal offset with 1/16th-pel MV accuracy in VVC. The computed fractional (xₘᵢₙ, yₘᵢₙ) are added to the integer distance refinement MV to get the sub-pixel accurate refinement delta MV.

### 2.30.2. Bilinear-Interpolation and Sample Padding

In VVC, the resolution of the MVs is 1/16 luma samples. The samples at the fractional position are interpolated using an 8-tap interpolation filter. In DMVR, the search points are surrounding the initial fractional-pel MV with integer sample offset, therefore the samples of those fractional position need to be interpolated for DMVR search process. To reduce the calculation complexity, the bi-linear interpolation filter is used to generate the fractional samples for the searching process in DMVR. Another important effect is that by using bi-linear filter is that with 2-sample search range, the DVMR does not access more reference samples compared to the normal motion compensation process. After the refined MV is attained with DMVR search process, the normal 8-tap interpolation filter is applied to generate the final prediction. In order to not access more reference samples to normal MC process, the samples, which is not needed for the interpolation process based on the original MV but is needed for the interpolation process based on the refined MV, will be padded from those available samples.

### 2.30.3. Maximum DMVR Processing Unit

When the width and/or height of a CU are larger than 16 luma samples, it will be further split into subblocks with width and/or height equal to 16 luma samples. The maximum unit size for DMVR searching process is limit to 16×16.

### 2.31. Multi-Pass Decoder-Side Motion Vector Refinement

In this contribution, a multi-pass decoder-side motion vector refinement is applied instead of DMVR. In the first pass, bilateral matching (BM) is applied to a coding block. In the second pass, BM is applied to each 16×16 subblock within the coding block. In the third pass, MV in each 8×8 subblock is refined by applying bi-directional optical flow (BDOF). The refined MVs are stored for both spatial and temporal motion vector prediction.

### 2.31.1. First Pass—Block Based Bilateral Matching MV Refinement

In the first pass, a refined MV is derived by applying BM to a coding block. Similar to decoder-side motion vector refinement (DMVR), the refined MV is searched around the two initial MVs (MV0 and MV1) in the reference picture lists L0 and L1. The refined MVs (MV0_pass1 and MV1_pass1) are derived around the initiate MVs based on the minimum bilateral matching cost between the two reference blocks in L0 and L1.
BM performs local search to derive integer sample precision intDeltaMV and half-pel sample precision halfDeltaMv. The local search applies a 3×3 square search pattern to loop through the search range [−sHor, sHor] in a horizontal direction and [−sVer, sVer] in a vertical direction, wherein, the values of sHor and sVer are determined by the block dimension, and the maximum value of sHor and sVer is 8.
The bilateral matching cost is calculated as: bilCost=mvDistanceCost+sadCost. When the block size cbW*cbH is greater than 64, MRSAD cost function is applied to remove the DC effect of the distortion between the reference blocks. When the bilCost at the center point of the 3×3 search pattern has the minimum cost, the intDeltaMV or halfDeltaMV local search is terminated. Otherwise, the current minimum cost search point becomes the new center point of the 3×3 search pattern and the search for the minimum cost continues, until it reaches the end of the search range.
The existing fractional sample refinement is further applied to derive the final deltaMV. The refined MVs after the first pass are then derived as:

$$MV 0 \_pass 1 = MV 0 + deltaMV ; \\ MV 1 \_pass 1 = MV 1 + deltaMV .$$

### 2.31.2. Second Pass—Subblock Based Bilateral Matching MV Refinement

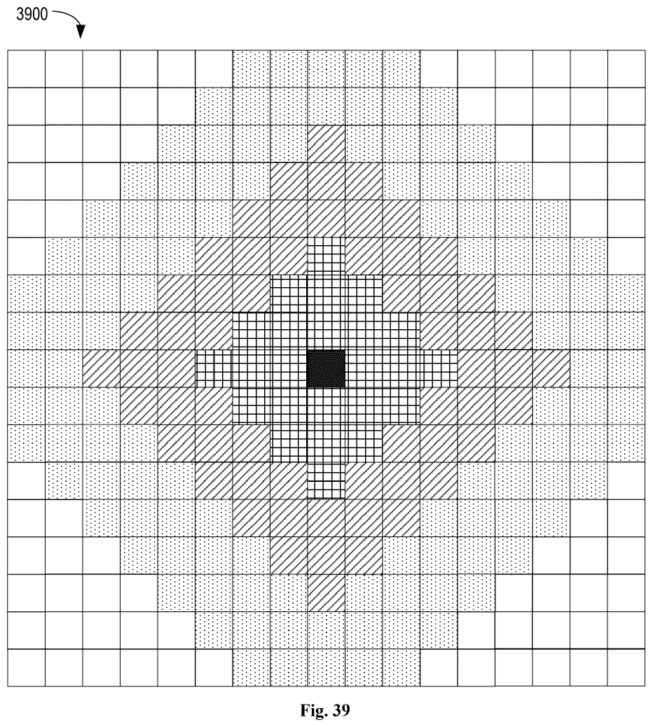

In the second pass, a refined MV is derived by applying BM to a 16×16 grid subblock. For each subblock, the refined MV is searched around the two MVs (MV0_pass1 and MV1_pass1), obtained on the first pass for the reference picture list L0 and L1. The refined MVs (MV0_pass2(sbIdx2) and MV1_pass2(sbIdx2)) are derived based on the minimum bilateral matching cost between the two reference subblocks in L0 and L1.
For each subblock, BM performs full search to derive integer sample precision intDeltaMV. The full search has a search range [−sHor, sHor] in a horizontal direction and [−sVer, sVer] in a vertical direction, wherein, the values of sHor and sVer are determined by the block dimension, and the maximum value of sHor and sVer is 8. The bilateral matching cost is calculated by applying a cost factor to the SATD cost between the two reference subblocks, as: bilCost=satdCost*costFactor. The search area (2*sHor+1)*(2*sVer+1) is divided up to 5 diamond shape search regions shown on FIG. 22. Each search region is assigned a costFactor, which is determined by the distance (intDeltaMV) between each search point and the starting MV, and each diamond region is processed in the order starting from the center of the search area. In each region, the search points are processed in the raster scan order starting from the top left going to the bottom right corner of the region. When the minimum bilCost within the current search region is less than a threshold equal to sbW*sbH, the int-pel full search is terminated, otherwise, the int-pel full search continues to the next search region until all search points are examined.
FIG. 39 illustrates Diamond regions in the search area. BM performs local search to derive half sample precision halfDeltaMv. The search pattern and cost function are the same as defined in 2.9.1.
The existing VVC DMVR fractional sample refinement is further applied to derive the final deltaMV(sbIdx2). The refined MVs at second pass is then derived as:

$$MV0\_pass2 ( s b Idx 2 ) = MV0\_pass1 + deltaMV ( s b Idx 2 ) ;$$

$$MV1\_pass2 ( sb Idx 2 ) = MV1\_pass1 + deltaMV ( s b Idx 2 ) .$$

### 2.31.3. Third Pass—Subblock Based Bi-Directional Optical Flow MV Refinement

In the third pass, a refined MV is derived by applying BDOF to an 8×8 grid subblock. For each 8×8 subblock, BDOF refinement is applied to derive scaled Vx and Vy without clipping starting from the refined MV of the parent subblock of the second pass. The derived bioMv(Vx, Vy) is rounded to 1/16 sample precision and clipped between −32 and 32.
The refined MVs (MV0_pass3(sbIdx3) and MV1_pass3(sbIdx3)) at third pass are derived as:

$$MV0\_pass3 ( s b Idx 3 ) = MV0\_pass2 ( s b Idx 2 ) + bioMv ;$$

$$MV1\_pass3 ( sb Idx 3 ) = MV0\_pass2 ( s b Idx 2 ) - bioMv .$$

### 2.32. Sample-Based BDOF

In the sample-based BDOF, instead of deriving motion refinement (Vx, Vy) on a block basis, it is performed per sample.
The coding block is divided into 8×8 subblocks. For each subblock, whether to apply BDOF or not is determined by checking the SAD between the two reference subblocks against a threshold. If decided to apply BDOF to a subblock, for every sample in the subblock, a sliding 5×5 window is used and the existing BDOF process is applied for every sliding window to derive Vx and Vy. The derived motion refinement (Vx, Vy) is applied to adjust the bi-predicted sample value for the center sample of the window.

### 2.33. Extended Merge Prediction

In VVC, the merge candidate list is constructed by including the following five types of candidates in order:
(1) Spatial MVP from spatial neighbour CUs.
(2) Temporal MVP from collocated CUs.
(3) History-based MVP from a FIFO table.
(4) Pairwise average MVP.
(5) Zero MVs.
   The size of merge list is signalled in sequence parameter set header and the maximum allowed size of merge list is 6. For each CU code in merge mode, an index of best merge candidate is encoded using truncated unary binarization (TU). The first bin of the merge index is coded with context and bypass coding is used for other bins.
   The derivation process of each category of merge candidates is provided in this session. As done in HEVC, VVC also supports parallel derivation of the merging candidate lists for all CUs within a certain size of area.

### 2.33.1. Spatial Candidates Derivation

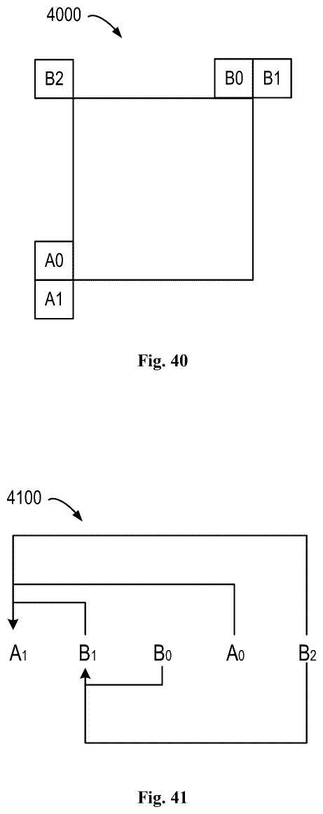

The derivation of spatial merge candidates in VVC is same to that in HEVC except the positions of first two merge candidates are swapped. A maximum of four merge candidates are selected among candidates located in the positions depicted in. The order of derivation is B0, A0, B1, A1 and B2. Position B2 is considered only when one or more than one CUs of position B0, A0, B1, A1 are not available (e.g. because it belongs to another slice or tile) or is intra coded. After candidate at position A1 is added, the addition of the remaining candidates is subject to a redundancy check which ensures that candidates with same motion information are excluded from the list so that coding efficiency is improved. To reduce computational complexity, not all possible candidate pairs are considered in the mentioned redundancy check. Instead only the pairs linked with an arrow in FIG. 24 are considered and a candidate is only added to the list if the corresponding candidate used for redundancy check has not the same motion information.
FIG. 40 illustrates Positions of spatial merge candidate.
FIG. 41 illustrates Candidate pairs considered for redundancy check of spatial merge candidates.

### 2.33.2. Temporal Candidates Derivation

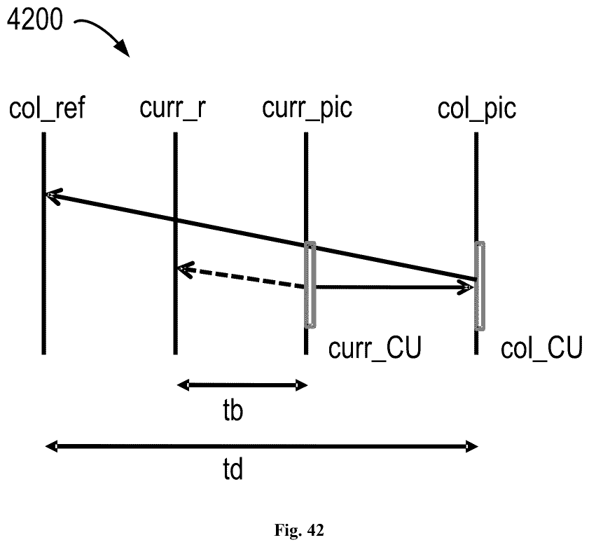

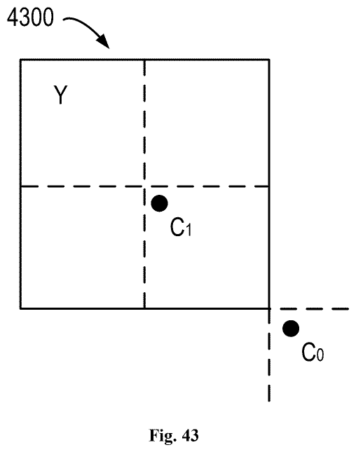

In this step, only one candidate is added to the list. Particularly, in the derivation of this temporal merge candidate, a scaled motion vector is derived based on co-located CU belonging to the collocated reference picture. The reference picture list to be used for derivation of the co-located CU is explicitly signalled in the slice header. The scaled motion vector for temporal merge candidate is obtained as illustrated by the dotted line in FIG. 25, which is scaled from the motion vector of the co-located CU using the POC distances, tb and td, where tb is defined to be the POC difference between the reference picture of the current picture and the current picture and td is defined to be the POC difference between the reference picture of the co-located picture and the co-located picture. The reference picture index of temporal merge candidate is set equal to zero.
FIG. 42 illustrates Illustration of motion vector scaling for temporal merge candidate.
The position for the temporal candidate is selected between candidates C0 and C1, as depicted in FIG. 26. If CU at position C0 is not available, is intra coded, or is outside of the current row of CTUs, position C1 is used. Otherwise, position C0 is used in the derivation of the temporal merge candidate. FIG. 43 illustrates Candidate positions for temporal merge candidate, C0 and C1.

### 2.33.3. History-Based Merge Candidates Derivation

The history-based MVP (HMVP) merge candidates are added to merge list after the spatial MVP and TMVP. In this method, the motion information of a previously coded block is stored in a table and used as MVP for the current CU. The table with multiple HMVP candidates is maintained during the encoding/decoding process. The table is reset (emptied) when a new CTU row is encountered. Whenever there is a non-subblock inter-coded CU, the associated motion information is added to the last entry of the table as a new HMVP candidate.
The HMVP table size S is set to be 6, which indicates up to 6 History-based MVP (HMVP) candidates may be added to the table. When inserting a new motion candidate to the table, a constrained first-in-first-out (FIFO) rule is utilized wherein redundancy check is firstly applied to find whether there is an identical HMVP in the table. If found, the identical HMVP is removed from the table and all the HMVP candidates afterwards are moved forward.
HMVP candidates could be used in the merge candidate list construction process. The latest several HMVP candidates in the table are checked in order and inserted to the candidate list after the TMVP candidate. Redundancy check is applied on the HMVP candidates to the spatial or temporal merge candidate.
To reduce the number of redundancy check operations, the following simplifications are introduced:
Number of HMPV candidates is used for merge list generation is set as (N<=4)?M:(8−N), wherein N indicates number of existing candidates in the merge list and M indicates number of available HMVP candidates in the table.
Once the total number of available merge candidates reaches the maximally allowed merge candidates minus 1, the merge candidate list construction process from HMVP is terminated.

### 2.33.4. Pair-Wise Average Merge Candidates Derivation

Pairwise average candidates are generated by averaging predefined pairs of candidates in the existing merge candidate list, and the predefined pairs are defined as {(0, 1), (0, 2), (1, 2), (0, 3), (1, 3), (2, 3)}, where the numbers denote the merge indices to the merge candidate list. The averaged motion vectors are calculated separately for each reference list. If both motion vectors are available in one list, these two motion vectors are averaged even when they point to different reference pictures; if only one motion vector is available, use the one directly; if no motion vector is available, keep this list invalid.
When the merge list is not full after pair-wise average merge candidates are added, the zero MVPs are inserted in the end until the maximum merge candidate number is encountered.

### 2.33.5. Merge Estimation Region

Merge estimation region (MER) allows independent derivation of merge candidate list for the CUs in the same merge estimation region (MER). A candidate block that is within the same MER to the current CU is not included for the generation of the merge candidate list of the current CU. In addition, the updating process for the history-based motion vector predictor candidate list is updated only if (xCb+cbWidth)>>Log 2ParMrgLevel is greater than xCb>>Log 2ParMrgLevel and (yCb+cbHeight)>>Log 2ParMrgLevel is great than (yCb>>Log 2ParMrgLevel) and where (xCb, yCb) is the top-left luma sample position of the current CU in the picture and (cbWidth, cbHeight) is the CU size. The MER size is selected at encoder side and signalled as log 2_parallel_merge_level_minus2 in the sequence parameter set.

### 2.34. New Merge Candidates

### 2.34.1. Non-Adjacent Merge Candidates Derivation

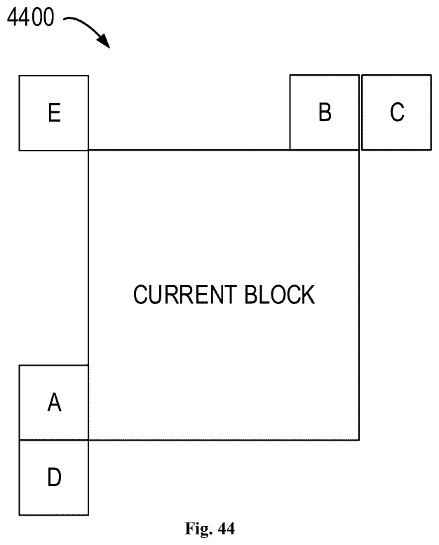

In VVC, five spatially neighboring blocks shown in FIG. 27 as well as one temporal neighbor are used to derive merge candidates.
It is proposed to derive the additional merge candidates from the positions non-adjacent to the current block using the same pattern as that in VVC. To achieve this, for each search round i, a virtual block is generated based on the current block as follows:
First, the relative position of the virtual block to the current block is calculated by:

$$Offsetx = - i \times gridX , Offsety = - i \times gridY$$

where the Offsetx and Offsety denote the offset of the top-left corner of the virtual block relative to the top-left corner of the current block, gridX and gridY are the width and height of the search grid.
Second, the width and height of the virtual block are calculated by:

$$newWidth = i \times 2 \times g r i dX + currWidth newHeight = i \times 2 \times gridY + currHeight .$$

where the currWidth and currHeight are the width and height of current block. The newWidth and newHeight are the width and height of new virtual block.
gridX and gridY are currently set to currWidth and currHeight, respectively.
FIG. 44 illustrates VVC spatial neighboring blocks of the current block. FIG. 28 illustrates the relationship between the virtual block and the current block. FIG. 45 illustrates Illustration of virtual block in the i-th search round.
After generating the virtual block, the blocks Aᵢ, Bᵢ, Cᵢ, Dᵢ and Eᵢ can be regarded as the VVC spatial neighboring blocks of the virtual block and their positions are obtained with the same pattern as that in VVC. Obviously, the virtual block is the current block if the search round i is 0. In this case, the blocks Aᵢ, Bᵢ, Cᵢ, Dᵢ and Eᵢ are the spatially neighboring blocks that are used in VVC merge mode.
When constructing the merge candidate list, the pruning is performed to guarantee each element in merge candidate list to be unique. The maximum search round is set to 1, which means that five non-adjacent spatial neighbor blocks are utilized.
Non-adjacent spatial merge candidates are inserted into the merge list after the temporal merge candidate in the order of B₁->A₁->C₁->D₁->E₁.

### 2.34.2. STMVP

It is proposed to derive an averaging candidate as STMVP candidate using three spatial merge candidates and one temporal merge candidate.
STMVP is inserted before the above-left spatial merge candidate.
The STMVP candidate is pruned with all the previous merge candidates in the merge list.
For the spatial candidates, the first three candidates in the current merge candidate list are used.
For the temporal candidate, the same position as VTM/HEVC collocated position is used.
For the spatial candidates, the first, second, and third candidates inserted in the current merge candidate list before STMVP are denoted as F, S, and T.
The temporal candidate with the same position as VTM/HEVC collocated position used in TMVP is denoted as Col.
The motion vector of the STMVP candidate in prediction direction X (denoted as mvLX) is derived as follows:
1) If the reference indices of the four merge candidates are all valid and are all equal to zero in prediction direction X (X=0 or 1),

mvLX=(mvLX_F+mvLX_S+mvLX_T+mvLX_Col)>>2
2) If reference indices of three of the four merge candidates are valid and are equal to zero in prediction direction X (X=0 or 1),

mvLX=(mvLX_F×3+mvLX_S×3+mvLX_Col×2)>>3 or

mvLX=(mvLX_F×3+mvLX_T×3+mvLX_Col×2)>>3 or

mvLX=(mvLX_S×3+mvLX_T×3+mvLX_Col×2)>>3
3) If reference indices of two of the four merge candidates are valid and are equal to zero in prediction direction X (X=0 or 1),

mvLX=(mvLX_F+mvLX_Col)>>1 or

mvLX=(mvLX_S+mvLX_Col)>>1 or

mvLX=(mvLX_T+mvLX_Col)>>1

Note: If the temporal candidate is unavailable, the STMVP mode is off.

### 2.34.3. Merge List Size

If considering both non-adjacent and STMVP merge candidates, the size of merge list is signalled in sequence parameter set header and the maximum allowed size of merge list is 8.

### 2.35. Geometric Partitioning Mode (GPM)

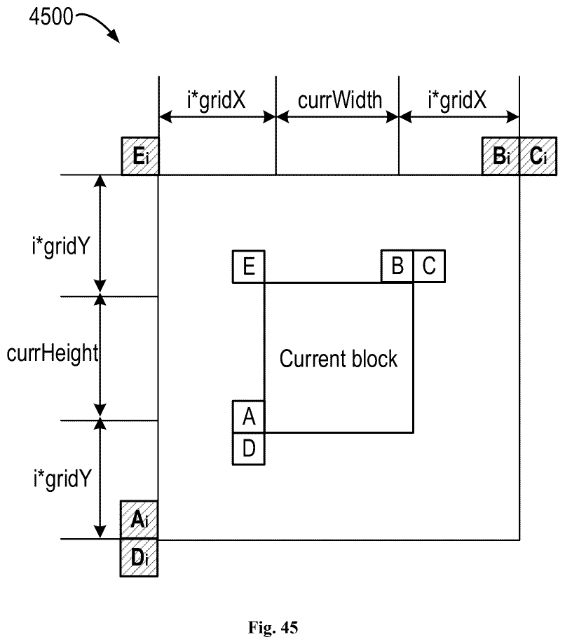

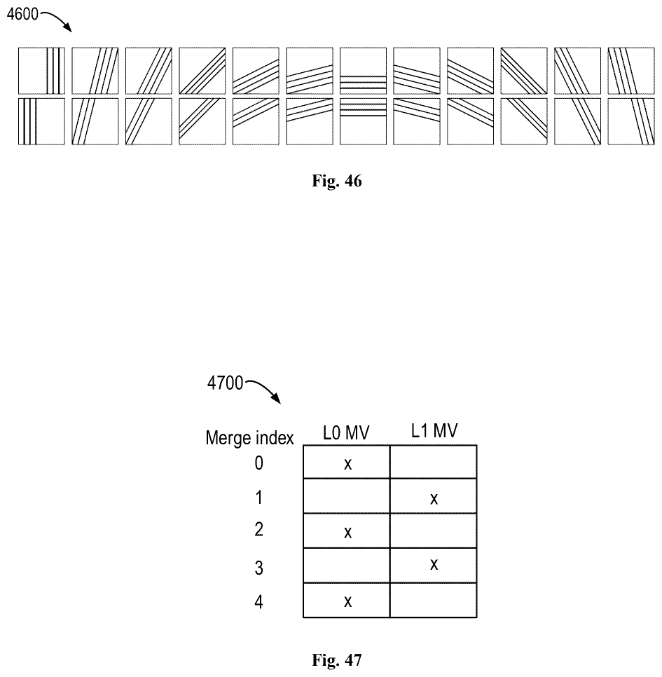

In VVC, a geometric partitioning mode is supported for inter prediction. The geometric partitioning mode is signalled using a CU-level flag as one kind of merge mode, with other merge modes including the regular merge mode, the MMVD mode, the CIIP mode and the subblock merge mode. In total 64 partitions are supported by geometric partitioning mode for each possible CU size w×h=2^{m}×2ⁿ with m, n∈{3 . . . 6} excluding 8×64 and 64×8.
When this mode is used, a CU is split into two parts by a geometrically located straight line (FIG. 29). The location of the splitting line is mathematically derived from the angle and offset parameters of a specific partition. Each part of a geometric partition in the CU is inter-predicted using its own motion; only uni-prediction is allowed for each partition, that is, each part has one motion vector and one reference index. The uni-prediction motion constraint is applied to ensure that same as the conventional bi-prediction, only two motion compensated prediction are needed for each CU. The uni-prediction motion for each partition is derived using the process described in 2.34.1. FIG. 46 illustrates Examples of the GPM splits grouped by identical angles.
If geometric partitioning mode is used for the current CU, then a geometric partition index indicating the partition mode of the geometric partition (angle and offset), and two merge indices (one for each partition) are further signalled. The number of maximum GPM candidate size is signalled explicitly in SPS and specifies syntax binarization for GPM merge indices. After predicting each of part of the geometric partition, the sample values along the geometric partition edge are adjusted using a blending processing with adaptive weights as in 2.34.2. This is the prediction signal for the whole CU, and transform and quantization process will be applied to the whole CU as in other prediction modes. Finally, the motion field of a CU predicted using the geometric partition modes is stored as in 2.34.3.

### 2.35.1. Uni-Prediction Candidate List Construction

The uni-prediction candidate list is derived directly from the merge candidate list constructed according to the extended merge prediction process in 2.32. Denote n as the index of the uni-prediction motion in the geometric uni-prediction candidate list. The LX motion vector of the n-th extended merge candidate, with X equal to the parity of n, is used as the n-th uni-prediction motion vector for geometric partitioning mode. These motion vectors are marked with “x” in FIG. 30. In case a corresponding LX motion vector of the n-the extended merge candidate does not exist, the L(1-X) motion vector of the same candidate is used instead as the uni-prediction motion vector for geometric partitioning mode. FIG. 47 illustrates Uni-prediction MV selection for geometric partitioning mode.

### 2.35.2. Blending Along the Geometric Partitioning Edge

After predicting each part of a geometric partition using its own motion, blending is applied to the two prediction signals to derive samples around geometric partition edge. The blending weight for each position of the CU are derived based on the distance between individual position and the partition edge.
The distance for a position (x, y) to the partition edge are derived as:

$$d ( x , y ) = ( 2 x + 1 - w ) cos ( {φ}_{i} ) + ( 2 y + 1 - h ) sin ( {φ}_{i} ) - {ρ}_{j} \qquad ( 2 - 39 )$$

$${ρ}_{j} = {ρ}_{x , j} cos ( {φ}_{i} ) + {ρ}_{y , j} sin ( {φ}_{i} ) \qquad ( 2 - 40 )$$

$${ρ}_{x , j} = \{ \begin{matrix}0 & i \% 16 = 8 or ( i \% 16 \neq 0 and h \geq w ) \\ \pm ( j \times w ) ≫ 2 & otherwise\end{matrix} \qquad ( 2 - 41 )$$

$${ρ}_{y , j} = \{ \begin{matrix}\pm ( j \times h ) ≫ 2 & i \% 16 = 8 or ( i \% 16 \neq 0 and h \geq w ) \\ 0 & otherwise\end{matrix} \qquad ( 2 - 42 )$$

where i, j are the indices for angle and offset of a geometric partition, which depend on the signaled geometric partition index. The sign of ρ_{x,j} and ρ_{y,j} depend on angle index i.
The weights for each part of a geometric partition are derived as following:

$$wIdxL ( x , y ) = partIdx ? 32 + d ( x , y ) : 32 - d ( x , y ) \qquad ( 2 - 43 )$$

$${w}_{0} ( x , y ) = \frac{C lip 3 ( 0 , 8 ( wIdx L ( x , y ) + 4 ) ≫ 3 )}{8} \qquad ( 2 - 44 )$$

$${w}_{1} ( x , y ) = 1 - {w}_{0} ( x , y ) \qquad ( 2 - 45 )$$

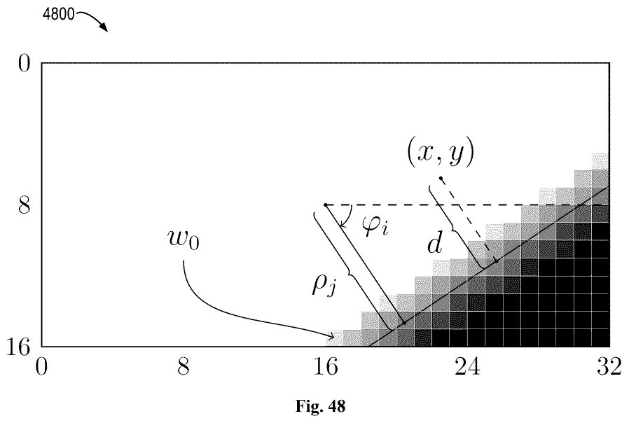

The partIdx depends on the angle index i. One example of weigh w₀ is illustrated in FIG. 31. FIG. 48 illustrates exemplified generation of a bending weight w₀ using geometric partitioning mode.

### 2.35.3. Motion Field Storage for Geometric Partitioning Mode

Mv1 from the first part of the geometric partition, Mv2 from the second part of the geometric partition and a combined Mv of Mv1 and Mv2 are stored in the motion filed of a geometric partitioning mode coded CU.
The stored motion vector type for each individual position in the motion filed are determined as:

$$sType = abs ( motionIdx ) < 32 ? 2 : ( motionIdx \leq 0 ? ( 1 - partIdx ) : partIdx ) \qquad ( 2 - 46 )$$

where motionIdx is equal to d(4x+2, 4y+2), which is recalculated from Equation (2-18). The partIdx depends on the angle index i.
If sType is equal to 0 or 1, Mv0 or Mv1 are stored in the corresponding motion field, otherwise if sType is equal to 2, a combined Mv from Mv0 and Mv2 are stored. The combined Mv are generated using the following process:
1) If Mv1 and Mv2 are from different reference picture lists (one from L0 and the other from L1), then Mv1 and Mv2 are simply combined to form the bi-prediction motion vectors.
   Otherwise, if Mv1 and Mv2 are from the same list, only uni-prediction motion Mv2 is stored.

### 2.36. Multi-Hypothesis Prediction

In multi-hypothesis prediction (MHP), up to two additional predictors are signalled on top of inter AMVP mode, regular merge mode, affine merge and MMVD mode. The resulting overall prediction signal is accumulated iteratively with each additional prediction signal.

$${p}_{n + 1} = ( 1 - {α}_{n + 1} ) {p}_{n} + {α}_{n + 1} {h}_{n + 1}$$

The weighting factor α is specified according to the following Table 8.

TABLE 8
weighting factor for MHP

| add_hyp_weight_idx | α |
|---|---|
| 0 | ¼ |
| 1 | −⅛ |

For inter AMVP mode, MHP is only applied if non-equal weight in BCW is selected in bi-prediction mode.
The additional hypothesis can be either merge or AMVP mode. In the case of merge mode, the motion information is indicated by a merge index, and the merge candidate list is the same as in the Geometric Partition Mode. In the case of AMVP mode, the reference index, MVP index, and MVD are signaled.

### 2.37. Non-Adjacent Spatial Candidate

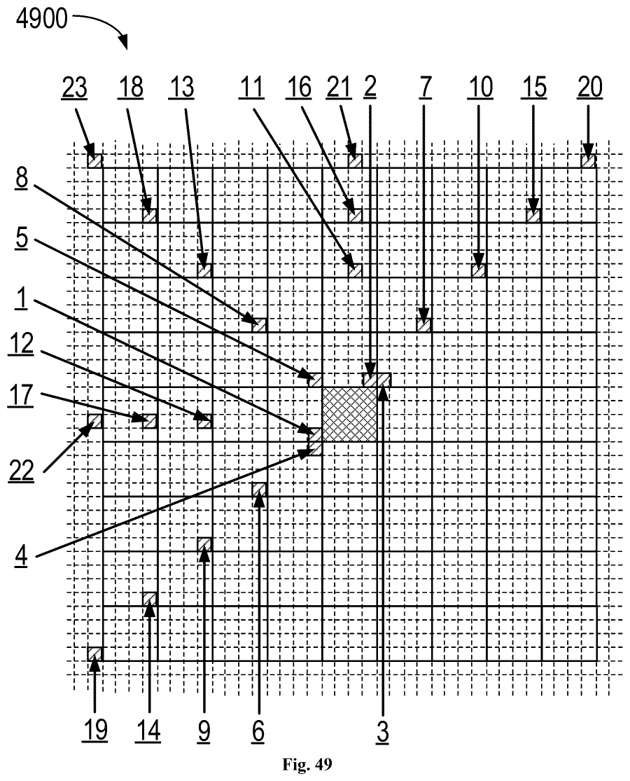

The non-adjacent spatial merge candidates are inserted after the TMVP in the regular merge candidate list. The pattern of the spatial merge candidates is shown on FIG. 32. The distances between the non-adjacent spatial candidates and the current coding block are based on the width and height of the current coding block.
FIG. 49 illustrates Spatial neighboring blocks used to derive the spatial merge candidates.

### 2.38. Template Matching (TM)

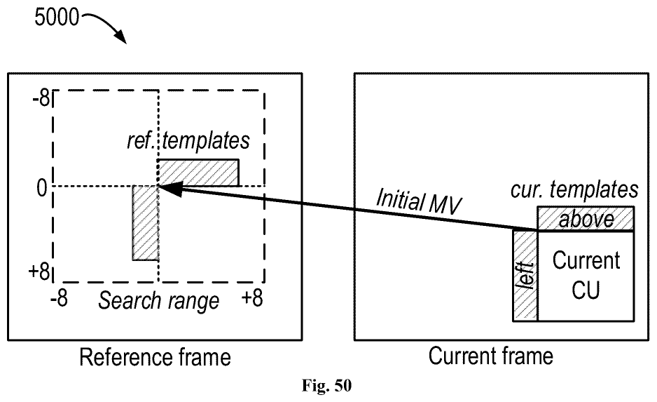

Template matching (TM) is a decoder-side MV derivation method to refine the motion information of the current CU by finding the closest match between a template (i.e., top and/or left neighbouring blocks of the current CU) in the current picture and a block (i.e., same size to the template) in a reference picture. As illustrated in FIG. 33, a better MV is to be searched around the initial motion of the current CU within a [−8, +8]-pel search range. The template matching is adopted in this contribution with two modifications: search step size is determined based on AMVR mode and TM can be cascaded with bilateral matching process in merge modes.
FIG. 50 illustrates Template matching performs on a search area around initial MV. In AMVP mode, an MVP candidate is determined based on template matching error to pick up the one which reaches the minimum difference between current block template and reference block template, and then TM performs only for this particular MVP candidate for MV refinement. TM refines this MVP candidate, starting from full-pel MVD precision (or 4-pel for 4-pel AMVR mode) within a [−8, +8]-pel search range by using iterative diamond search. The AMVP candidate may be further refined by using cross search with full-pel MVD precision (or 4-pel for 4-pel AMVR mode), followed sequentially by half-pel and quarter-pel ones depending on AMVR mode as specified in Table 9. This search process ensures that the MVP candidate still keeps the same MV precision as indicated by AMVR mode after TM process.

TABLE 9
Search patterns of AMVR and merge mode with AMVR.

| | AMVR mode | | | | Merge mode | |
|---|---|---|---|---|---|---|
| Search | | | | Quarter- | AltIF = | AltIF = |
| pattern | 4-pel | Full-pel | Half-pel | pel | 0 | 1 |
| 4-pel | v | | | | | |
| diamond | | | | | | |
| 4-pel | v | | | | | |
| cross | | | | | | |
| Full-pel | | v | v | v | v | v |
| diamond | | | | | | |
| Full-pel | | v | v | v | v | v |
| cross | | | | | | |
| Half-pel | | | v | v | v | v |
| cross | | | | | | |
| Quarter- | | | | v | v | |
| pel cross | | | | | | |
| ⅛-pel | | | | | v | |
| cross | | | | | | |

In merge mode, similar search method is applied to the merge candidate indicated by the merge index. As Table 9 shows, TM may perform all the way down to ⅛-pel MVD precision or skipping those beyond half-pel MVD precision, depending on whether the alternative interpolation filter (that is used when AMVR is of half-pel mode) is used according to merged motion information. Besides, when TM mode is enabled, template matching may work as an independent process or an extra MV refinement process between block-based and subblock-based bilateral matching (BM) methods, depending on whether BM can be enabled or not according to its enabling condition check.

### 2.39. Overlapped Block Motion Compensation (OBMC)

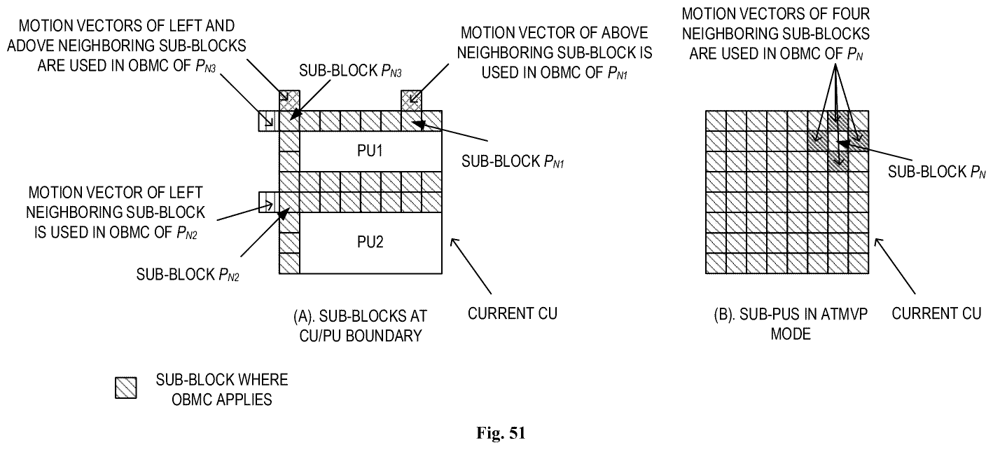

Overlapped Block Motion Compensation (OBMC) has previously been used in H.263. In the JEM, unlike in H.263, OBMC can be switched on and off using syntax at the CU level. When OBMC is used in the JEM, the OBMC is performed for all motion compensation (MC) block boundaries except the right and bottom boundaries of a CU. Moreover, it is applied for both the luma and chroma components. In the JEM, a MC block is corresponding to a coding block. When a CU is coded with sub-CU mode (includes sub-CU merge, affine and FRUC mode), each sub-block of the CU is a MC block. To process CU boundaries in a uniform fashion, OBMC is performed at sub-block level for all MC block boundaries, where sub-block size is set equal to 4×4, as illustrated in FIG. 34.
When OBMC applies to the current sub-block, besides current motion vectors, motion vectors of four connected neighbouring sub-blocks, if available and are not identical to the current motion vector, are also used to derive prediction block for the current sub-block. These multiple prediction blocks based on multiple motion vectors are combined to generate the final prediction signal of the current sub-block.
Prediction block based on motion vectors of a neighbouring sub-block is denoted as P_{N}, with N indicating an index for the neighbouring above, below, left and right sub-blocks and prediction block based on motion vectors of the current sub-block is denoted as P_{C}. When P_{N} is based on the motion information of a neighbouring sub-block that contains the same motion information to the current sub-block, the OBMC is not performed from P_{N}. Otherwise, every sample of P_{N} is added to the same sample in P_{C}, i.e., four rows/columns of P_{N} are added to P_{C}. The weighting factors {¼, ⅛, 1/16, 1/32} are used for P_{N} and the weighting factors {¾, ⅞, 15/16, 31/32} are used for P_{C}. The exception are small MC blocks, (i.e., when height or width of the coding block is equal to 4 or a CU is coded with sub-CU mode), for which only two rows/columns of P_{N} are added to P_{C}. In this case weighting factors {¼, ⅛} are used for P_{N} and weighting factors {¾, ⅞} are used for P_{C}. For P_{N} generated based on motion vectors of vertically (horizontally) neighbouring sub-block, samples in the same row (column) of P_{N} are added to P_{C} with a same weighting factor.
FIG. 51 illustrates Illustration of sub-blocks where OBMC applies. In the JEM, for a CU with size less than or equal to 256 luma samples, a CU level flag is signalled to indicate whether OBMC is applied or not for the current CU. For the CUs with size larger than 256 luma samples or not coded with AMVP mode, OBMC is applied by default. At the encoder, when OBMC is applied for a CU, its impact is taken into account during the motion estimation stage. The prediction signal formed by OBMC using motion information of the top neighbouring block and the left neighbouring block is used to compensate the top and left boundaries of the original signal of the current CU, and then the normal motion estimation process is applied.

### 2.40. Multiple Transform Selection (MTS) for Core Transform

In addition to DCT-II which has been employed in HEVC, a Multiple Transform Selection (MTS) scheme is used for residual coding both inter and intra coded blocks. It uses multiple selected transforms from the DCT8/DST7. The newly introduced transform matrices are DST-VII and DCT-VIII. Table 10 shows the basis functions of the selected DST/DCT.

TABLE 10
Transform basis functions of DCT-II/VIII and DSTVII for N-point input

| Transform Type | Basis function Tᵢ(j), i, j = 0, 1, . . . , N − 1 |
|---|---|
| DCT-II | ${T}_{i} ( j ) = {ω}_{0} \cdot \sqrt{\frac{2}{N}} \cdot cos ( \frac{π \cdot i \cdot ( 2 j + 1 )}{2 N} )$ |
| | $where , {ω}_{0} = \{ \begin{matrix}\sqrt{\frac{2}{N}} & i = 0 \\ 1 & i \neq 0\end{matrix}$ |
| DCT-VIII | ${T}_{i} ( j ) = \sqrt{\frac{4}{2 N + 1}} \cdot cos ( \frac{π \cdot ( 2 i + 1 ) \cdot ( 2 j + 1 )}{4 N + 2} )$ |
| DST-VII | ${T}_{i} ( j ) = \sqrt{\frac{4}{2 N + 1}} \cdot sin ( \frac{π \cdot ( 2 i + 1 ) \cdot ( j + 1 )}{2 N + 1} )$ |

In order to keep the orthogonality of the transform matrix, the transform matrices are quantized more accurately than the transform matrices in HEVC. To keep the intermediate values of the transformed coefficients within the 16-bit range, after horizontal and after vertical transform, all the coefficients are to have 10-bit.
In order to control MTS scheme, separate enabling flags are specified at SPS level for intra and inter, respectively. When MTS is enabled at SPS, a CU level flag is signalled to indicate whether MTS is applied or not. Here, MTS is applied only for luma. The MTS signaling is skipped when one of the below conditions is applied.
The position of the last significant coefficient for the luma TB is less than 1 (i.e., DC only).
The last significant coefficient of the luma TB is located inside the MTS zero-out region.
   If MTS CU flag is equal to zero, then DCT2 is applied in both directions. However, if MTS CU flag is equal to one, then two other flags are additionally signalled to indicate the transform type for the horizontal and vertical directions, respectively. Transform and signalling mapping table as shown in Table 11. Unified the transform selection for ISP and implicit MTS is used by removing the intra-mode and block-shape dependencies. If current block is ISP mode or if the current block is intra block and both intra and inter explicit MTS is on, then only DST7 is used for both horizontal and vertical transform cores. When it comes to transform matrix precision, 8-bit primary transform cores are used. Therefore, all the transform cores used in HEVC are kept as the same, including 4-point DCT-2 and DST-7, 8-point, 16-point and 32-point DCT-2. Also, other transform cores including 64-point DCT-2, 4-point DCT-8, 8-point, 16-point, 32-point DST-7 and DCT-8, use 8-bit primary transform cores.

TABLE 11
Transform and signalling mapping table

| | | | Intra/inter | |
|---|---|---|---|---|
| MTS_CU_flag | MTS_Hor_flag | MTS_Ver_flag | Horizontal | Vertical |
| 0 | | | DCT2 | |
| 1 | 0 | 0 | DST7 | DST7 |
| | 0 | 1 | DCT8 | DST7 |
| | 1 | 0 | DST7 | DCT8 |
| | 1 | 1 | DCT8 | DCT8 |

To reduce the complexity of large size DST-7 and DCT-8, High frequency transform coefficients are zeroed out for the DST-7 and DCT-8 blocks with size (width or height, or both width and height) equal to 32. Only the coefficients within the 16×16 lower-frequency region are retained.
As in HEVC, the residual of a block can be coded with transform skip mode. To avoid the redundancy of syntax coding, the transform skip flag is not signalled when the CU level MTS_CU_flag is not equal to zero. Note that implicit MTS transform is set to DCT2 when LFNST or MIP is activated for the current CU. Also the implicit MTS can be still enabled when MTS is enabled for inter coded blocks.

### 2.41. Subblock Transform (SBT)

In VTM, subblock transform is introduced for an inter-predicted CU. In this transform mode, only a sub-part of the residual block is coded for the CU. When inter-predicted CU with cu_cbf equal to 1, cu_sbt_flag may be signaled to indicate whether the whole residual block or a sub-part of the residual block is coded. In the former case, inter MTS information is further parsed to determine the transform type of the CU. In the latter case, a part of the residual block is coded with inferred adaptive transform and the other part of the residual block is zeroed out.
When SBT is used for an inter-coded CU, SBT type and SBT position information are signaled in the bitstream. There are two SBT types and two SBT positions, as indicated in FIG. 35A and FIG. 35B. For SBT-V (or SBT-H), the TU width (or height) may equal to half of the CU width (or height) or ¼ of the CU width (or height), resulting in 2:2 split or 1:3/3:1 split. The 2:2 split is like a binary tree (BT) split while the 1:3/3:1 split is like an asymmetric binary tree (ABT) split. In ABT splitting, only the small region contains the non-zero residual. If one dimension of a CU is 8 in luma samples, the 1:3/3:1 split along that dimension is disallowed. There are at most 8 SBT modes for a CU.
Position-dependent transform core selection is applied on luma transform blocks in SBT-V and SBT-H (chroma TB always using DCT-2). The two positions of SBT-H and SBT-V are associated with different core transforms. More specifically, the horizontal and vertical transforms for each SBT position is specified in FIGS. 35A and 35B. For example, the horizontal and vertical transforms for SBT-V position 0 is DCT-8 and DST-7, respectively. When one side of the residual TU is greater than 32, the transform for both dimensions is set as DCT-2. Therefore, the subblock transform jointly specifies the TU tiling, cbf, and horizontal and vertical core transform type of a residual block.
The SBT is not applied to the CU coded with combined inter-intra mode. FIG. 52 illustrates SBT position, type and transform type.

### 2.42. Template Matching Based Adaptive Merge Candidate Reorder

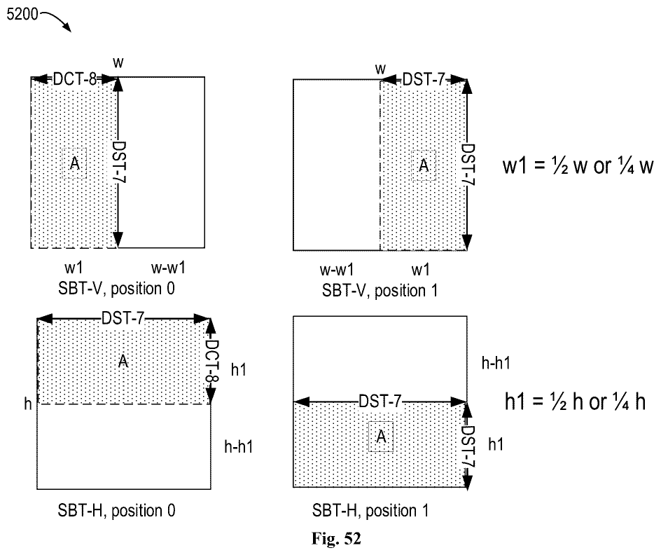

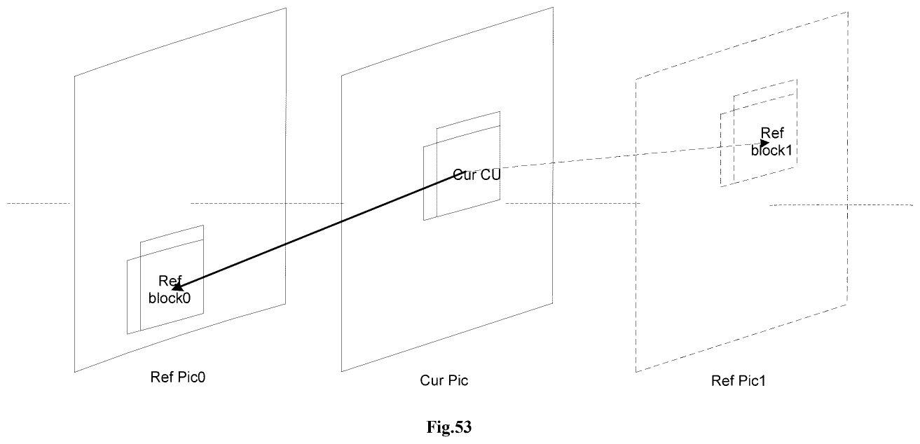

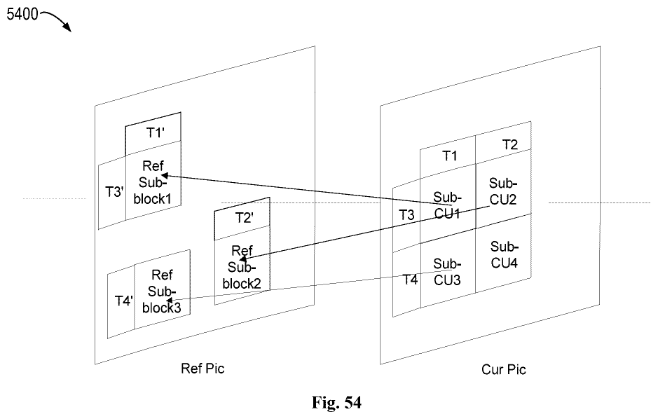

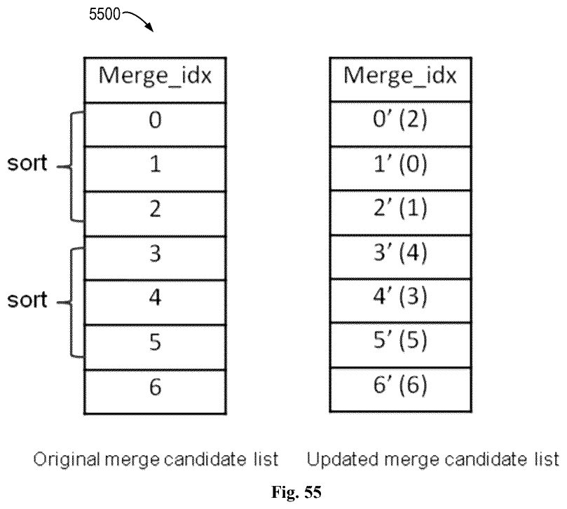

To improve the coding efficiency, after the merge candidate list is constructed, the order of each merge candidate is adjusted according to the template matching cost. The merge candidates are arranged in the list in accordance with the template matching cost of ascending order. It is operated in the form of sub-group.
The template matching cost is measured by the SAD (Sum of absolute differences) between the neighbouring samples of the current CU and their corresponding reference samples. If a merge candidate includes bi-predictive motion information, the corresponding reference samples are the average of the corresponding reference samples in reference list0 and the corresponding reference samples in reference list1, as illustrated in FIG. 36. If a merge candidate includes sub-CU level motion information, the corresponding reference samples consist of the neighbouring samples of the corresponding reference sub-blocks, as illustrated in FIG. 37.
The sorting process is operated in the form of sub-group, as illustrated in FIG. 38. The first three merge candidates are sorted together. The following three merge candidates are sorted together.
The template size (width of the left template or height of the above template) is 1. The sub-group size is 3. FIG. 53 illustrates neighbouring samples used for calculating SAD. FIG. 54 illustrates neighbouring samples used for calculating SAD for sub-CU level motion information. FIG. 55 illustrates the sorting process.

### 2.43. Adaptive Merge Candidate List

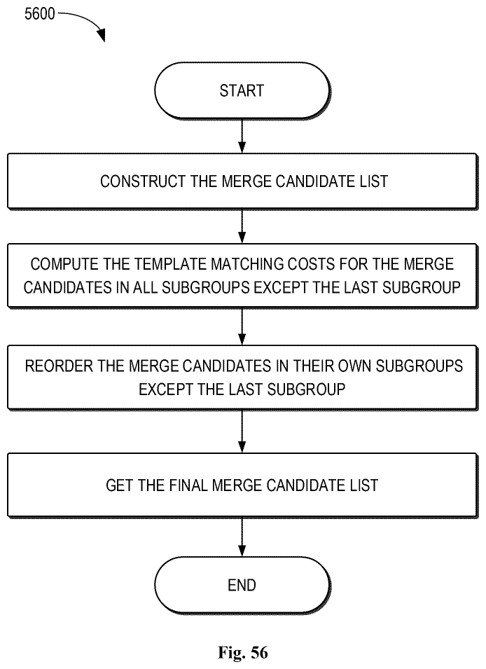

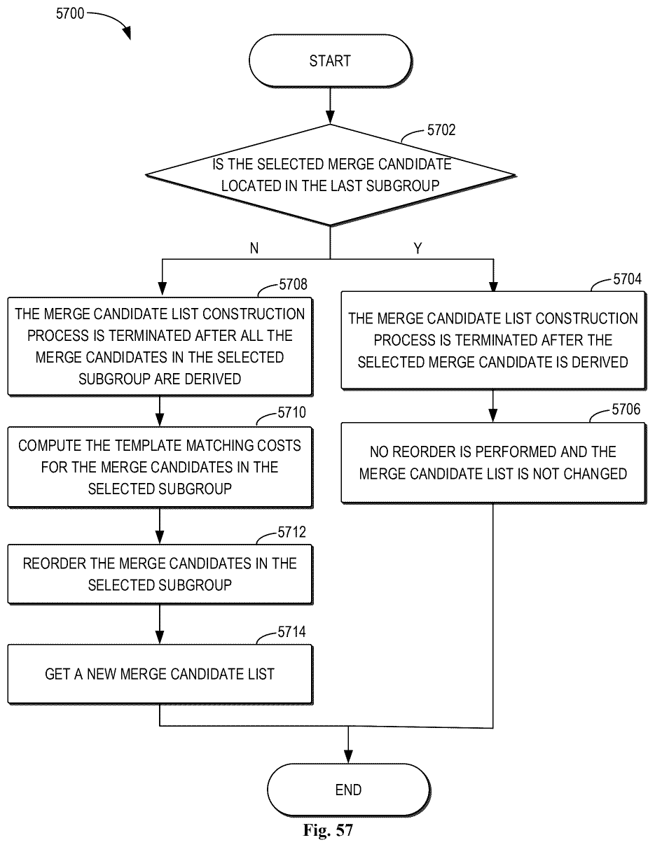

We can assume the number of the merge candidates is 8. We take the first 5 merge candidates as a first subgroup and take the following 3 merge candidates as a second subgroup (i.e., the last subgroup).
For the encoder, after the merge candidate list is constructed, some merge candidates are adaptively reordered in an ascending order of costs of merge candidates as shown in FIG. 39.
More specifically, the template matching costs for the merge candidates in all subgroups except the last subgroup are computed; then reorder the merge candidates in their own subgroups except the last subgroup; finally, the final merge candidate list will be got. FIG. 56 illustrates reorder process in encoder.
For the decoder, after the merge candidate list is constructed, some/no merge candidates are adaptively reordered in ascending order of costs of merge candidates as shown in FIG. 40. In FIG. 40, the subgroup the selected (signaled) merge candidate located in is called the selected subgroup. FIG. 57 illustrates reorder process in decoder.
More specifically, if the selected merge candidate is located in the last subgroup, the merge candidate list construction process is terminated after the selected merge candidate is derived, no reorder is performed and the merge candidate list is not changed; otherwise, the execution process is as follows:
The merge candidate list construction process is terminated after all the merge candidates in the selected subgroup are derived; compute the template matching costs for the merge candidates in the selected subgroup; reorder the merge candidates in the selected subgroup; finally, a new merge candidate list will be got.
For both encoder and decoder, a template matching cost is derived as a function of T and RT, wherein T is a set of samples in the template and RT is a set of reference samples for the template.
When deriving the reference samples of the template for a merge candidate, the motion vectors of the merge candidate are rounded to the integer pixel accuracy.
The reference samples of the template (RT) for bi-directional prediction are derived by weighted averaging of the reference samples of the template in reference list0 (RT₀) and the reference samples of the template in reference list1 (RT₁) as follows.

$$R T = ( ( 8 - w ) * R {T}_{0} + w * R {T}_{1} + 4 ) ≫ 3 \qquad ( 2 - 47 )$$

where the weight of the reference template in reference list0 (8−w) and the weight of the reference template in reference list1 (w) are decided by the BCW index of the merge candidate. BCW index equal to {0,1,2,3,4} corresponds to w equal to {−2,3,4,5,10}, respectively.
If the Local Illumination Compensation (LIC) flag of the merge candidate is true, the reference samples of the template are derived with LIC method.
The template matching cost is calculated based on the sum of absolute differences (SAD) of T and RT.
The template size is 1. That means the width of the left template and/or the height of the above template is 1. If the coding mode is MMVD, the merge candidates to derive the base merge candidates are not reordered.
If the coding mode is GPM, the merge candidates to derive the uni-prediction candidate list are not reordered.
2.44. Geometric Prediction Mode with Motion Vector Difference
In Geometric prediction mode with Motion Vector Difference (GMVD), each geometric partition in GPM can decide to use GMVD or not. If GMVD is chosen for a geometric region, the MV of the region is calculated as a sum of the MV of a merge candidate and an MVD. All other processing is kept the same as in GPM.
With GMVD, an MVD is signaled as a pair of direction and distance. There are nine candidate distances (¼-pel, ½-pel, 1-pel, 2-pel, 3-pel, 4-pel, 6-pel, 8-pel, 16-pel), and eight candidate directions (four horizontal/vertical directions and four diagonal directions) involved. In addition, when pic_fpel_mmvd_enabled_flag is equal to 1, the MVD in GMVD is also left shifted by 2 as in MMVD.

### 2.45. Affine MMVD

In affine MMVD, an affine merge candidate (which is called, base affine merge candidate) is selected, the MVs of the control points are further refined by the signalled MVD information.
The MVD information for the MVs of all the control points are the same in one prediction direction.
When the starting MVs is bi-prediction MVs with the two MVs point to the different sides of the current picture (i.e. the POC of one reference is larger than the POC of the current picture, and the POC of the other reference is smaller than the POC of the current picture), the MV offset added to the list0 MV component of starting MV and the MV offset for the list1 MV has opposite value; otherwise, when the starting MVs is bi-prediction MVs with both lists point to the same side of the current picture (i.e. POCs of two references are both larger than the POC of the current picture, or are both smaller than the POC of the current picture), the MV offset added to the list0 MV component of starting MV and the MV offset for the list1 MV are the same.

### 2.46. Adaptive Decoder Side Motion Vector Refinement (ADMVR)

In ECM-2.0, a multi-pass decoder-side motion vector refinement (DMVR) method is applied in regular merge mode if the selected merge candidate meets the DMVR conditions. In the first pass, bilateral matching (BM) is applied to the coding block. In the second pass, BM is applied to each 16×16 subblock within the coding block. In the third pass, MV in each 8×8 subblock is refined by applying bi-directional optical flow (BDOF).
Adaptive decoder side motion vector refinement method consists of the two new merge modes introduced to refine MV only in one direction, either L0 or L1, of the bi prediction for the merge candidates that meet the DMVR conditions. The multi-pass DMVR process is applied for the selected merge candidate to refine the motion vectors, however either MVD0 or MVD1 is set to zero in the 1st pass (i.e., PU level) DMVR.
Like the regular merge mode, merge candidates for the proposed merge modes are derived from the spatial neighboring coded blocks, TMVPs, non-adjacent blocks, HMVPs, and pair-wise candidate. The difference is that only those meet DMVR conditions are added into the candidate list. The same merge candidate list (i.e., ADMVR merge list) is used by the two proposed merge modes and merge index is coded as in regular merge mode.

### 2.47. Convolutional Cross-Component Model (CCCM) for Intra Prediction

It is proposed to apply convolutional cross-component model (CCCM) to predict chroma samples from reconstructed luma samples in a similar spirit as done by the current CCLM modes. As with CCLM, the reconstructed luma samples are down-sampled to match the lower resolution chroma grid when chroma subsampling is used.
Also, similarly to CCLM, there is an option of using a single model or multi-model variant of CCCM. The multi-model variant uses two models, one model derived for samples above the average luma reference value and another model for the rest of the samples (following the spirit of the CCLM design). Multi-model CCCM mode can be selected for PUs which have at least 128 reference samples available.

### 2.47.1. Convolutional Filter

The proposed convolutional 7-tap filter consist of a 5-tap plus sign shape spatial component, a nonlinear term and a bias term. The input to the spatial 5-tap component of the filter consists of a center (C) luma sample which is collocated with the chroma sample to be predicted and its above/north (N), below/south (S), left/west (W) and right/east (E) neighbors as illustrated below. FIG. 58 illustrates Spatial part of the convolutional filter.
The nonlinear term P is represented as power of two of the center luma sample C and scaled to the sample value range of the content:

$$P = ( C * C + midVal ) ≫ bitDepth .$$

That is, for 10-bit content it is calculated as:

$$P = ( C * C + 5 \; 12 ) ≫ 10.$$

The bias term B represents a scalar offset between the input and output (similarly to the offset term in CCLM) and is set to middle chroma value (512 for 10-bit content).
Output of the filter is calculated as a convolution between the filter coefficients cᵢ and the input values and clipped to the range of valid chroma samples:

$$predChromaVal = {c}_{0} C + {c}_{1} N + {c}_{2} S + {c}_{3} E + {c}_{4} W + {c}_{5} P + {c}_{6} B .$$

### 2.47.2. Calculation of Filter Coefficients

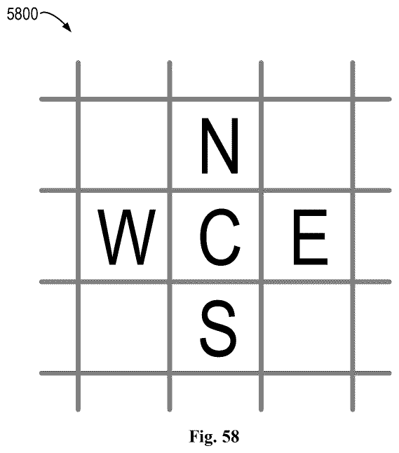

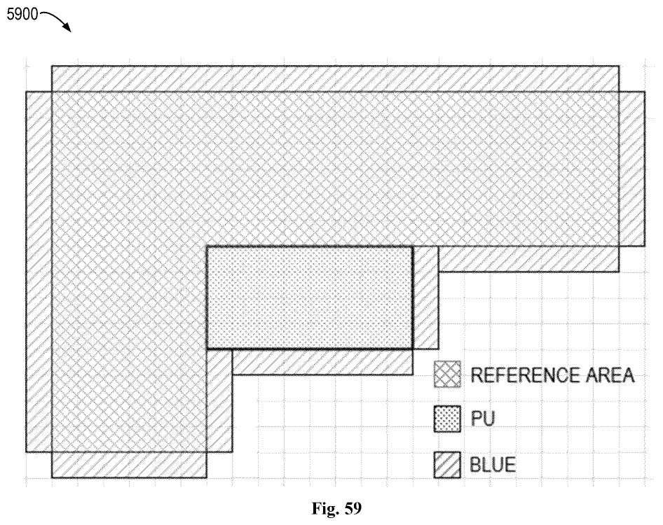

The filter coefficients cᵢ are calculated by minimising MSE between predicted and reconstructed chroma samples in the reference area. FIG. 59 illustrates the reference area which consists of 6 lines of chroma samples above and left of the PU. Reference area extends one PU width to the right and one PU height below the PU boundaries. Area is adjusted to include only available samples. The extensions to the area shown in blue are needed to support the “side samples” of the plus shaped spatial filter and are padded when in unavailable areas. FIG. 59 illustrates reference area (with its paddings) used to derive the filter coefficients.
The MSE minimization is performed by calculating autocorrelation matrix for the luma input and a cross-correlation vector between the luma input and chroma output. Autocorrelation matrix is LDL decomposed and the final filter coefficients are calculated using back-substitution. The process follows roughly the calculation of the ALF filter coefficients in ECM, however LDL decomposition was chosen instead of Cholesky decomposition to avoid using square root operations. The proposed approach uses only integer arithmetic.

### 2.47.3. Bitstream Signalling

Usage of the mode is signalled with a CABAC coded PU level flag. One new CABAC context was included to support this. When it comes to signalling, CCCM is considered a sub-mode of CCLM. That is, the CCCM flag is only signalled if intra prediction mode is LM_CHROMA_IDX (to enable single mode CCCM) or MMLM_CHROMA_IDX (to enable multi-model CCCM).

### 2.47.4. Encoder Operation

The encoder performs two new RD checks in the chroma prediction mode loop, one for checking single model CCCM mode and one for checking multi-model CCCM mode.

### 2.48. Chroma Fusion

2.48.1. Chroma Fusion with Modes of DM, Default, and MMLM
In ECM6.0, there is one chroma fusion method that the DM mode and the four default modes can be fused with the MMLM_LT mode as follows:

$$pred = ( w 0 * pred 0 + w 1 * pred 1 + ( 1 ≪ ( shift - 1 ) ) ) ≫ shift$$

where pred0 is the predictor obtained by applying the non-LM mode, pred1 is the predictor obtained by applying the MMLM_LT mode and pred is the final predictor of the current chroma block. The preset weight combination, {w0, w1} is equal to {1, 3}, {3, 1} or {2, 2}.
2.48.2. Chroma Fusion with LDL Decomposition
A new chroma fusion method is proposed as follows:

$$p r e {d}_{C} ( i , j ) = {α}_{0} \cdot {rec}_{L}^{′} ( i , j ) + {α}_{1} \cdot {pred}_{C}^{′} ( i , j ) + {α}_{2} \cdot midValue$$

where pred_{C}(i, j) represents the final predicted chroma sample, rec′_{L}(i, j) represents the reconstructed luma samples. pred′_{C}(i, j) represents the predicted chroma samples obtained by applying the non-LM mode. For 10-bit content, the midValue is set equal to 512. The model parameters α₀, α₁ and α₂ are derived from the same adjacent samples (two line) based on the LDL decomposition method used in CCCM.
There are three chroma fusion methods as shown in Table 12.

TABLE 12
The chroma fusion modes in the proposed method

| Value | Name |
|---|---|
| 0 | Disable |
| 1 | Preset weights |
| 2 | Single Linear model |
| 3 | Multiple Linear model |

### 3. PROBLEMS

1. In the current design of the codec, the sub-partition techniques such as ISP may be only applied in only luma component in the intra prediction. However, this way may limit the compression efficiency due to that other components have not been fully considered to partition deeper for compression especially when blocks or frames are with different signal and texture distributions.
2. In the current design of the codec, the sub-partition techniques such as ISP may have not been extended to other essential coding tools such as cross component tools in the chroma components. However, the sub-partitions combined with more coding tools may contribute a better trade-off between the reconstruction quality and bitrate cost.

### 4. DETAILED SOLUTIONS

The detailed solutions below should be considered as examples to explain general concepts. These solutions should not be interpreted in a narrow way. Furthermore, these solutions can be combined in any manner.
In this disclosure, the term ‘block’ may represent a coding block (CB), or a coding unit (CU), or a prediction block (PB), or a prediction unit (PU), or a transform block (TB), or a transform unit (TU), or a coding tree block (CTB), or a coding tree unit (CTU), or a rectangular region of samples/pixels.
In the following discussion, SatShift(x, n) is defined as:

$$SatShift ( x , n ) = \{ \begin{matrix}( x + offset 0 ) ≫ n & if x \geq 0 \\ - ( ( - x + offset 1 ) ≫ n ) & if x < 0\end{matrix}$$

Shift(x, n) is defined as Shift(x, n)=(x+offset0)>>n.
In one example, offset0 and/or offset1 are set to (1<<n)>>1 or (1<<(n−1)). In another example, offset0 and/or offset1 are set to 0.
In another example, offset0=offset1=((1<<n)>>1)−1 or ((1<<(n−1)))−1.
Clip3(min, max, x) is defined as:

$$Clip 3 ( Min , Max , x ) = \{ \begin{matrix}Min & if x < Min \\ Max & if x > Max \\ x & Otherwise\end{matrix}$$

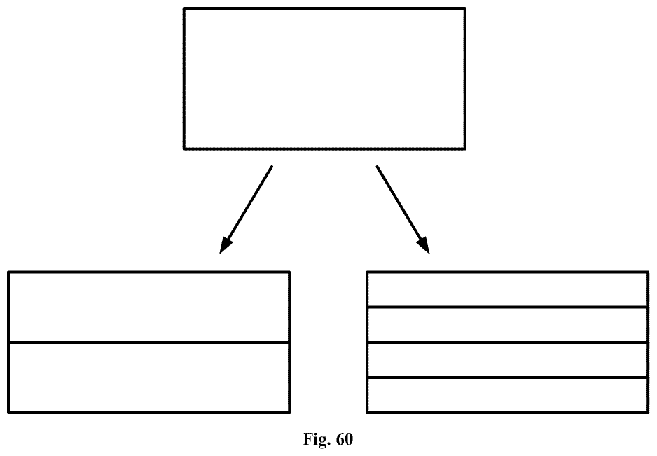

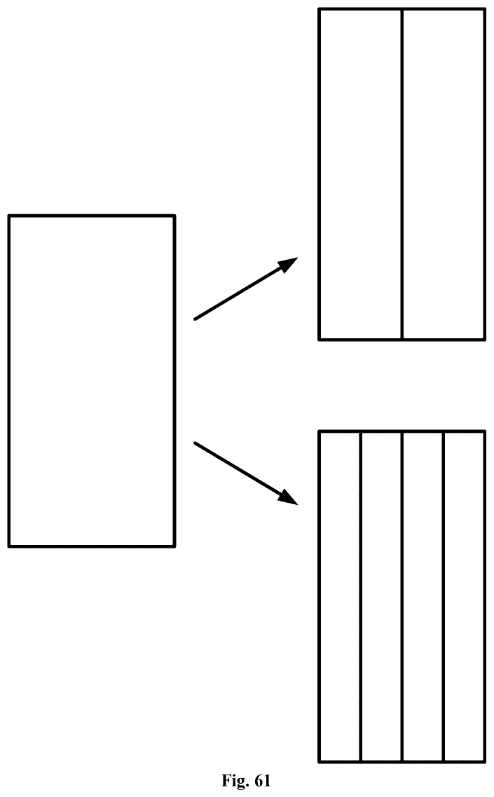

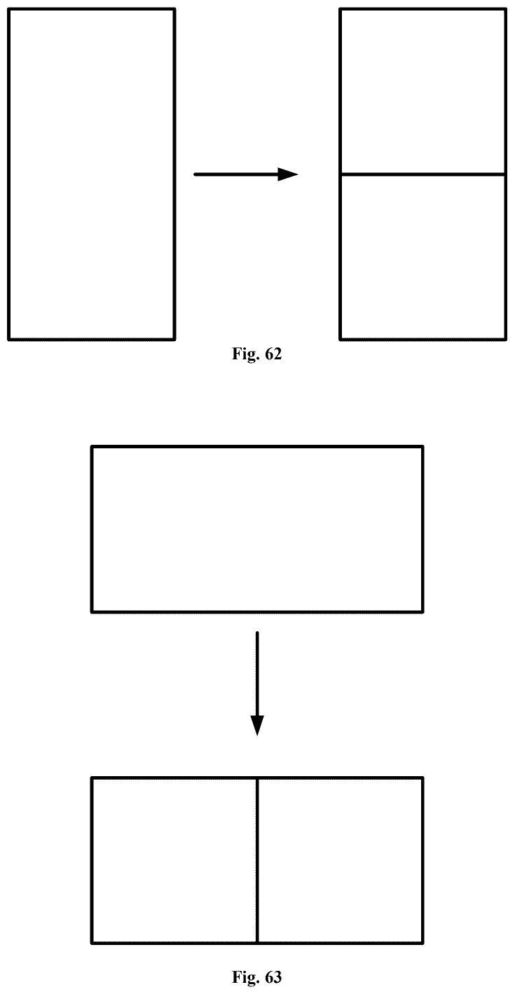

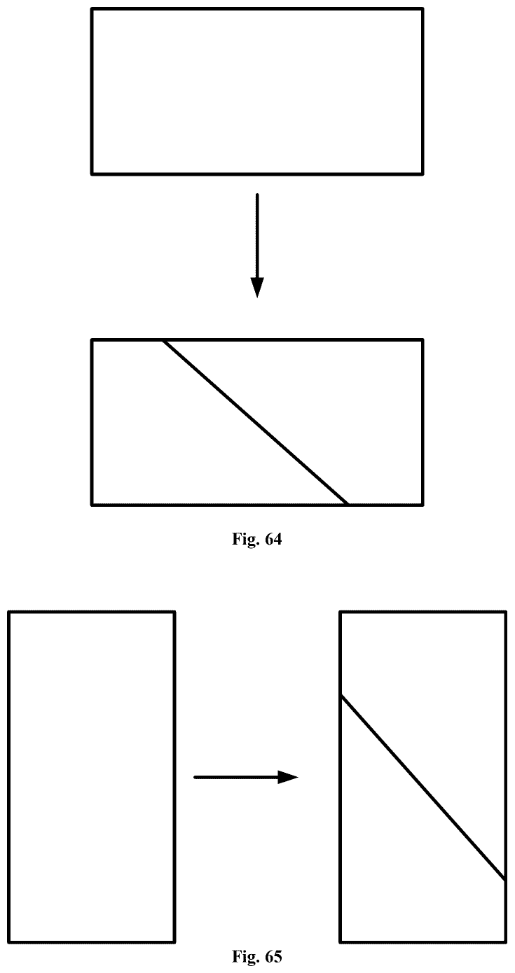

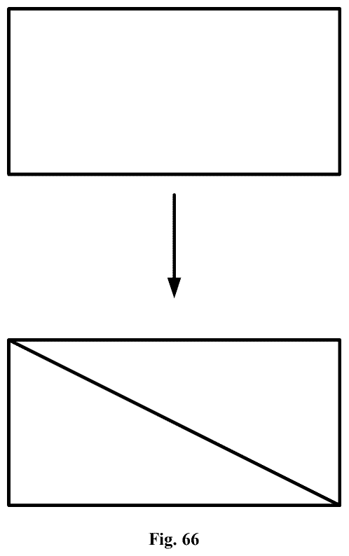

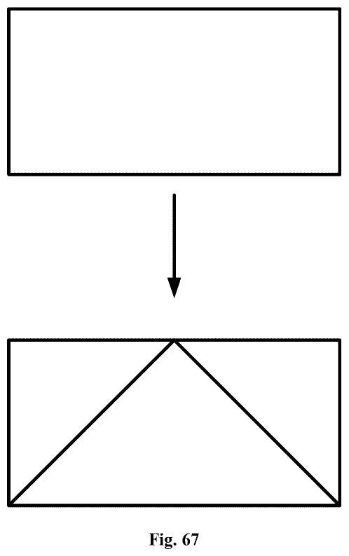

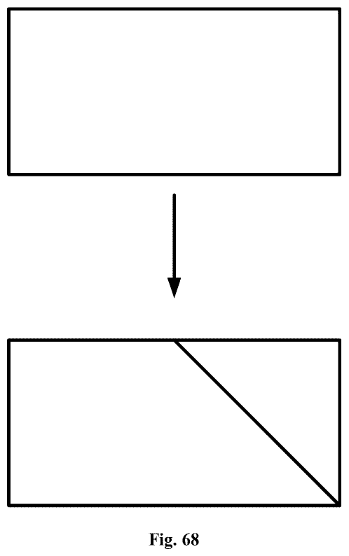

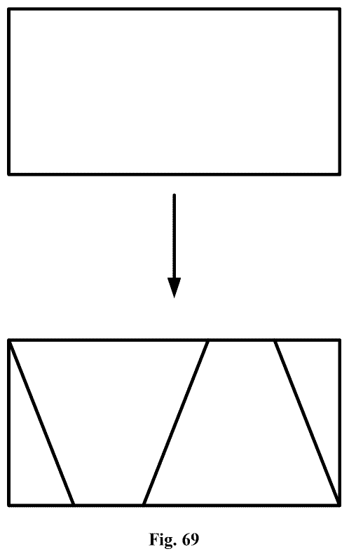

In the following discussion, a “picture”, an “image” and a “frame” may have the same meaning.
In the following discussion, “partition”, “split” and “divide” may have the same meaning.
FIGS. 60-69 illustrate several example partitioning modes in accordance with some embodiments of the present disclosure. In a partitioning mode shown in FIG. 60, a block may be partitioned horizontally into sub-rectangles. In a partitioning mode shown in FIG. 61, a block may be partitioned vertically into sub-rectangles. In a partitioning mode shown in FIG. 62, a block may be partitioned horizontally into sub-squares. In a partitioning mode shown in FIG. 63, a block may be partitioned vertically into sub-squares. In a partitioning mode shown in FIG. 64, a block may be partitioned into sub-trapezoids arranged horizontally. In a partitioning mode shown in FIG. 65, a block may be partitioned into sub-trapezoids arranged vertically. In a partitioning mode shown in FIG. 66, a block may be partitioned into two sub-triangles. In a partitioning mode shown in FIG. 67, a block may be partitioned into three sub-triangles. In a partitioning mode shown in FIG. 68, a block may be partitioned into a sub-trapezoid and a sub-triangle. In a partitioning mode shown in FIG. 69, a block may be partitioned into multiple sub-trapezoids and sub-triangles.

### Sub-Partitions

1. For a color component except luma, instead of predicting a block as a whole, multiple sub-partitions of split sub-blocks may be used for predicting with the proposed sub-partition method. Denote the sub-partitioning function as F( ), such as B=F(p₀, p₁, . . . , pₙ), where pₙ is the n-th sub-partition.
   a. In one example, more than one mode of sub-partitioning may be used.
      i. In one example, whether to and/or which sub-partition mode to be used may be signalled in the bitstream, or derived using the coding information.
      ii. In one example, the number of the sub-partition modes may depend on coding information such as:
         1) block dimensions, and/or block size, and/or block depth.
         2) slice/picture type, and/or partition tree type (single, or dual tree, or local dual tree).
         3) temporal layer identification.
         4) QP.
         5) The coding mode of the current block.
         6) The coding mode of a neighbouring block.
   b. In one example, one kind of sub-partition method may refer to a group of predictions of geometrical sub-partitions (p₀, p₁, . . . , pₙ) in a block.
      i. In one example,

$$B = F ( {p}_{0} , {p}_{1} , {p}_{2} , … , {p}_{i} ) \qquad ( 1 )$$

where pᵢ is the prediction of the No. i geometrical sub-partition, B represents the prediction of a block.
1) In one example, the total number of sub-partitions n is a fixed value.
2) In one example, the total number of sub-partitions n is a varied value depending on the context of the codec.
ii. In one example,

$$B = F ( {p}_{0} , {p}_{1} , {p}_{2} , … , {p}_{i} ) >> n \qquad ( 2 )$$

Where pᵢ is the prediction of the No. i geometrical sub-partition, B represents the prediction of a block, n is the number of right shift.
c. In one example, one kind of sub-partition method may refer to a non-linear method partitioning into a group of predictors (p₀, p₁, . . . , pₙ).
   i. In one example, the non-linear partitioning method may employ convolutional neural networks.
      1) In one example,

$$C ( {p}_{i} ) = c onv 2 ( {w}_{i} , {p}_{i} ) + {b}_{i} \qquad ( 3 )$$

where pᵢ is the prediction of the No. i sub-partition, wᵢ is the weight of the convolutional layer, bᵢ is the bias of the convolution layer.

$$B ( {p}_{i} ) = M ( C ( {p}_{1} ) , C ( {p}_{2} ) , … , C ( {p}_{i} ) ) \qquad ( 4 )$$

where M is the partitioning method of i kinds of sub-partitions.

$$R ( {p}_{i} ) = \{ \begin{matrix}C ( {p}_{i} ) , & C ( {p}_{i} ) \geq 0 \\ 0 , & C ( {p}_{i} ) \leq 0\end{matrix} ∈ [ 0 , + ∞ ) \qquad ( 5 )$$

R(pᵢ) is Rectified Linear Unit (ReLU), which is the activation function.
d. pᵢ disclosed above may be the prediction of a sub-partition of the current component.
   i. pᵢ disclosed above may be the prediction of a sub-partition of a different component.
   ii. pᵢ disclosed above may be the prediction of a sub-partition after filtering or rescaling.
e. In one example, the total number of the predictors n equals 2 in (1).
   i. In one example, these two predictors (p₀, p₁) are:

$$F ( {p}_{i} ) = ( {p}_{0} , {p}_{1} )$$

1) In one example, the partitioning method is a fixed pred-defined method.
2) In one example, the partitioning method is a varied one depending on the context of the codec.
f. In one example, one or more sets of splitting methods may be signalled in the bitstream.
   i. In one example, the one or more sets of partition modes may be signalled at block level/sequence level/group of pictures level/picture level/slice level/tile group level, such as in coding structures of CTU/CU/TU/PU/CTB/CB/TB/PB, or sequence header/picture header/SPS/VPS/DPS/DCI/PPS/APS/slice header/tile group header.
   ii. In one example, a first syntax element may be signaled to indicate whether the sub-partition method is applied or not.
   iii. In one example, a second syntax element may be signaled to indicate which group of sub-partition modes is applied or not.
      1) In one example, the second syntax element may be signaled only if the first syntax indicates the sub-partition is applied.
   iv. In one example, a single SE may be signaled, which indicates whether to use sub-partition and which group of modes is used.
   v. The Syntax Element (SE)(s) may be coded using fixed length coding, EG coding, truncated (unary) coding, etc.
   vi. The SE(s) may be coded with at least one context in arithmetic coding.
   vii. The SE(s) may be bypass coded.
   viii. The SE(s) may be signaled only if the sub-partition method is allowed to be used.
   ix. The SE(s) may be signaled in a SEI or VUI message.
   x. In one example, the one or more sets of sub-partition modes may be signalled in a predictive way.
      1) In one example, the sub-partition mode may be signalled in a predictive way.
   xi. In one example, the sets of sub-partition modes for a first video unit may be not signalled, instead one or more sets of sub-partition modes signalled for a second video unit may be used, wherein the second video unit is coded before the first video unit.
g. In one example, one or more sets of derived sub-partition modes may be used.
   i. In one example, the derived modes may be obtained using the reconstructed luma samples, and/or neighboring reconstructed luma/chroma samples, and/or predicted chroma samples.
h. In one example, the sets of sub-partition modes may depend on colour format and/or colour component.
   i. In one example, the sets of sub-partition modes may be same for the two chroma components.
      1) Alternatively, the sets of sub-partition modes may be different for the two chroma components.
   ii. In one example, how to obtain the derived sub-partition modes may be different for different colour formats.
      1) In one example, luma ISP modes may be used for 4:2:0/4:2:2 colour format, but they may not be used for 4:4:4 colour format.
i. The multiple sub-partition modes in the proposed methods may be different on coding information, context, and background.
   i. In one example, the sub-partition modes may depend on block size of subpicture, tiles, slice, or CTU/CU/PU/TU/CTB/CB/PB/TB.
      1) In one example, the sub-partition mode is p when the block size is 256×256, while it is q when the block size is 128×128.
   ii. In one example, the sub-partition modes may depend on video content of video units.
      1) In one example, the sub-partition mode is p when the video content is a kind of nature sequence, while it is q when the video content is a kind of screen content (SCC).
j. In one example, whether to and/or how to apply the sub-partition method and its weights may be signaled with at least one syntax elements (SE).
   i. In one example, the syntax element may be signalled in SPS/PPS/APS/picture header/slice header, etc.
   ii. In one example, a first SE may be signaled to indicate whether the sub-partition method is applied or not.
   iii. In one example, a group of SEs may be signaled to indicate how the sub-partition modes are pre-defined.
      1) In one example, each element of a group of SEs indicates different modes.
k. In one example, whether to and/or how to use one or more sets of sub-partition modes in above methods may be signalled in the bitstream, or derived using the coding information.
   i. In one example, one or more set indices indicating use which set of modes may be signalled in the bitstream.
      1) In one example, a single set index may be used to indicate the set of modes used for components.
      2) In one example, the indication of the set of modes for components may be signalled individually.
   ii. In one example, the set index may be derived using the coding information.
      1) In one example, template matching based method may be used.
      2) In one example, the set of modes index for components may be derived together.
      3) In one example, the set of modes index for components may be derived individually.
2. Instead of that ISP only dividing luma blocks horizontally or vertically into four or two sub-partitions depending on the block size in the intra prediction, it is proposed that blocks of luma or other components such as Cb or Cr may be partitioned into sub-partitions depending on the coding background, coding information, and coding context.
   a. In one example, a block may be partitioned into sub-partitions depending on the coding background, coding information, and coding context.
      i. In one example, the coding information may refer to the reconstructed luma samples, and/or neighbouring reconstructed luma samples, and/or neighbouring reconstructed chroma sample, and/or predicted chroma samples.
      ii. In one example, a block may be partitioned into sub-rectangles.
         1) In one example, as shown in FIG. 60, a block may be partitioned horizontally into sub-rectangles.
         2) In one example, as shown in FIG. 61, a block may be partitioned vertically into sub-rectangles.
      iii. In one example, a block may be partitioned into sub-squares.
         1) In one example, as shown in FIG. 62, a block may be partitioned horizontally into sub-squares.
         2) In one example, as shown in FIG. 63, a block may be partitioned vertically into sub-squares.
      iv. In one example, a block may be partitioned into sub-trapezoids.
         1) In one example, as shown in FIG. 64, a block may be partitioned into sub-trapezoids arranged horizontally.
         2) In one example, as shown in FIG. 65, a block may be partitioned into sub-trapezoids arranged vertically.
      v. In one example, a block may be partitioned into sub-triangles.
         1) In one example, as shown in FIG. 66, a block may be partitioned into two sub-triangles.
         2) In one example, a block may be partitioned into three sub-triangles.
         3) In one example, as shown in FIG. 67, a block may be partitioned into more than three sub-triangles.
      vi. In one example, a block may be partitioned into some sub-trapezoids and sub-triangles.
         1) In one example, as shown in FIG. 68, a block may be partitioned into a sub-triangle and a sub-trapezoid.
         2) In one example, as shown in FIG. 69, a block may be partitioned into some sub-triangles and sub-trapezoids.
   b. In one example, the mode of the sub-partition may be signalled in the bitstream.
      i. In one example, the mode of the sub-partition may be signalled at block level/sequence level/group of pictures level/picture level/slice level/tile group level, such as in coding structures of CTU/CU/TU/PU/CTB/CB/TB/PB, or sequence header/picture header/SPS/VPS/DPS/DCI/PPS/APS/slice header/tile group header.
      ii. In one example, a first syntax element may be signaled to indicate whether the sub-partition method is applied or not.
      iii. In one example, a second syntax element may be signaled to indicate which level of the sub-partition is applied or not.
         1) In one example, the second syntax element may be signaled only if the first syntax indicates the sub-partition is applied.
      iv. In one example, a single SE may be signaled, which indicates whether to use sub-partition and which level of the sub-partition is used.
      v. The SE(s) may be coded using fixed length coding, EG coding, truncated (unary) coding, etc.
      vi. The SE(s) may be coded with at least one context in arithmetic coding.
      vii. The SE(s) may be bypass coded.
      viii. The SE(s) may be signaled only if the chroma fusion with mid-value is allowed to be used.
      ix. The SE(s) may be signaled in a SEI or VUI message.
   c. In one example, a same sub-partition mode (such as prediction mode or transform mode) may be used for multiple different blocks.
      i. In one example, the mode may be signaled/derived in the same way as a whole-coded block.
      ii. In one example, the mode may be signaled/derived different to a whole-coded block.
         1) In one example, the allowed mode for a sub-partitioning block may be a sub-set of all modes.
         a) For example, the allowed mode for a sub-partitioning chroma block may be a cross-component prediction mode such as DM or DIMD or CCLM or CCCM.
         b) For example, a sub-partitioning chroma block must be coded with a specific mode such as CCLM, without signaling.
   d. There may be multiple modes of sub-partitions applied on the proposed sub-partition method.
      i. In one example, whether to and/or how to apply the sub-partition method and its multiple modes may be signaled with at least one syntax elements (SE).
         1) In one example, the syntax element may be signalled in SPS/PPS/APS/picture header/slice header/CTU/CU, etc.
         2) In one example, a first syntax element may be signaled to indicate whether the sub-partition with multiple modes is applied or not.
         3) In one example, a second syntax element may be signaled to indicate which group of sub-partition modes is applied or not.
         a) In one example, the second syntax element may be signaled only if the first syntax indicates the sub-partition method with multiple modes is applied.
         4) In one example, a single SE may be signaled, which indicates whether to use sub-partition and which group of modes is used.
         5) The SE(s) may be coded using fixed length coding, EG coding, truncated (unary) coding, etc.
         6) The SE(s) may be coded with at least one context in arithmetic coding.
         7) The SE(s) may be bypass coded.
         8) The SE(s) may be signaled only if the sub-partition with multiple modes is allowed to be used.
         9) The SE(s) may be signaled in a SEI or VUI message.
   e. In one example, blocks of Cr may be partitioned into sub-partitions depending on the coding background, coding information, and coding context.
   f. In one example, blocks in components of RGB format may be partitioned into sub-partitions depending on the coding background, coding information, and coding context.
   g. In one example, blocks of some components may be partitioned into sub-partitions in the intra prediction depending on the coding background, coding information, and coding context.
   h. In one example, blocks of some components may be partitioned into sub-partitions in the inter prediction depending on the coding background, coding information, and coding context.
3. In one example, sub-partitions may be coded/decoded sequentially.
   a. For example, a first sub-partition is coded/decoded then a second sub-partition can be coded/decoded, which may depend on reconstruction samples of the first sub-partition.
   b. Alternatively, sub-partitions may be coded/decoded in parallel.
      i. For example, a first sub-partition is coded/decoded and a second sub-partition can be coded/decoded independently, which does not depend on the first sub-partition.
4. In one example, the coding order of sub-partitions may be fixed.
   a. The coding order may be from left to right.
   b. The coding order may be from top to bottom.
   c. The coding order may be from right to left.
   d. The coding order may be from bottom to top.
   e. The coding order may be signaled in the bitstream.
   f. The coding order may be derived without signaling.
5. It is proposed that the sub-partition method may be combined with different predicting tools.
   a. In one example, predicting modes from a linear model or non-linear model may be used with the sub-partition method.
   b. In one example, Non-LM predicting modes may be used with the sub-partition method.
   c. In one example, CCLM predicting modes may be used with the sub-partition method.
   d. In one example, CCLM-Slope predicting modes may be used with the sub-partition method.
   e. In one example, GLM predicting modes may be used with the sub-partition method.
   f. In one example, CCCM predicting modes may be used with the sub-partition method.
   g. In one example, TMP/DIMD/TIMD/MRL/MIP predicting modes may be used with the sub-partition method.
6. Above methods may also be applied to sub-partition methods for luma component both in the decoder and encoder when uncompressing and compressing a video unit with predicting tools.

### General Claims

7. Whether to and/or how to apply the disclosed methods above may be signalled at block level/sequence level/group of pictures level/picture level/slice level/tile group level, such as in coding structures of CTU/CU/TU/PU/CTB/CB/TB/PB, or sequence header/picture header/SPS/VPS/DPS/DCI/PPS/APS/slice header/tile group header.
8. Whether to and/or how to apply the disclosed methods above may be dependent on coded information, such as block size, colour format, single/dual tree partitioning, colour component, slice/picture type.
9. The proposed methods disclosed in this document may be used in other coding tools which require sub-partition.

### 5. EMBODIMENT

More details of the embodiments of the present disclosure will be described below which are related to block partition. The embodiments of the present disclosure should be considered as examples to explain the general concepts and should not be interpreted in a narrow way. Furthermore, these embodiments can be applied individually or combined in any manner.

As used herein, the term “block” may represent a color component, a sub-picture, a picture, a slice, a tile, a coding tree unit (CTU), a CTU row, groups of CTU, a coding unit (CU), a prediction unit (PU), a transform unit (TU), a coding tree block (CTB), a coding block (CB), a prediction block (PB), a transform block (TB), a sub-block of a video block, a sub-region within a video block, a video processing unit comprising multiple samples/pixels, and/or the like. A block may be rectangular or non-rectangular.

Moreover, a chroma component may comprise a Cb component and/or a Cr component. For example, the Cb component may represent a blue-difference chroma component and the Cr component may represent a red-difference chroma component. In another example, Cb and Cr components may be substituted by U and V components. It should be understood that the Cb component and/or the Cr component may represent any other suitable color component. The scope of the present disclosure is not limited in this respect.

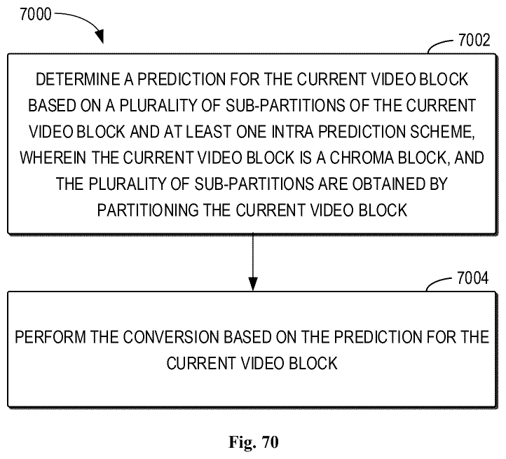

FIG. 70 illustrates a flowchart of a method 7000 for video processing in accordance with some embodiments of the present disclosure. The method 7000 may be implemented during a conversion between a current video block of a video and a bitstream of the video. The current video block is a chroma block. Alternatively, the current video block may be of a color component different from luma component. The scope of the present disclosure is not limited in this respect.

As shown in FIG. 70, the method 7000 starts at 7002 where a prediction for the current video block is determined based on a plurality of sub-partitions of the current video block and at least one intra prediction scheme. The plurality of sub-partitions are obtained by partitioning the current video block. For example, the plurality of sub-partitions may be obtained by partitioning the current video block based on at least one partitioning mode, which will be described in detail below. Hence, the terms “sub-partition” and “subblock” may be used interchangeably herein.

At 7004, the conversion is performed based on the determining. In some embodiments, the conversion may include encoding the current video block into the bitstream. Alternatively or additionally, the conversion may include decoding the current video block from the bitstream. It should be understood that the above illustrations and/or examples are described merely for purpose of description. The scope of the present disclosure is not limited in this respect.

In view of the above, a chroma block is divided into a plurality of sub-partitions, and a prediction for a chroma block is determined based on the plurality of sub-partitions and at least one intra prediction scheme. Thereby, the proposed method can advantageously improve coding efficiency and coding quality, especially when the block is of different signal and texture distributions.

In some embodiments, the at least one partitioning mode may comprise a plurality of partitioning modes. In one example, information regarding at least one of the following may be indicated in the bitstream: whether to use the plurality of partitioning modes, or one of the plurality of partitioning modes that is used. In another example, this information may be determined based on coding information of the current video block or coding information of a block coded before the current video block.

In some embodiments, the number of partitioning modes in the plurality of partitioning modes may be dependent on coding information of the current video block or coding information of a block coded before the current video block. By way of example rather than limitation, the coding information may comprise a block dimension, a block size, a block depth, a slice type, a picture type, a partition tree type, a temporal layer identification, a quantization parameter, a coding mode, and/or the like.

In some embodiments, the prediction for the current video block may be determined based on predictions for the plurality of sub-partitions and geometric positions of the plurality of sub-partitions in the current video block. The predictions for the plurality of sub-partitions may be determined based on the at least one intra prediction scheme.

In some embodiments, the prediction for the current video block may be determined as follows:

$$B = F ( {p}_{0} , {p}_{1} , … , {p}_{N - 1} )$$

where B represents the prediction for the current video block, pᵢ represents a prediction for an i-th sub-partition in the plurality of sub-partitions, N represents the number of sub-partitions in the plurality of sub-partitions, and F( ) represents a combination scheme for combining the predictions for the plurality of sub-partitions based on the geometric positions of the plurality of sub-partitions. By way of example rather than limitation, the predictions for the plurality of sub-partitions may be combined based on their geometric positions in the current video block, so as to obtain the prediction of the current video block.

In some embodiments, the prediction for the current video block may be determined as follows:

$$B = F ( {p}_{0} , {p}_{1} , … , {p}_{N - 1} ) >> k$$

where B represents the prediction for the current video block, pᵢ represents a prediction for an i-th sub-partition in the plurality of sub-partitions, N represents the number of sub-partitions in the plurality of sub-partitions, F( ) represents a combination scheme for combining the predictions for the plurality of sub-partitions based on the geometric positions of the plurality of sub-partitions, and k represents the number of right shift.

In some embodiments, the prediction for the current video block may be determined based on a non-linear combination scheme for combining predictions for the plurality of sub-partitions. The predictions for the plurality of sub-partitions may be determined based on the at least one intra prediction scheme. For example, a convolutional neural network may be used in the non-linear combination scheme.

In some embodiments, the prediction for the current video block may be determined as follows:

$$C ( {p}_{i} ) = conv 2 ( {w}_{i} , {p}_{i} ) + {b}_{i} , i = 0 , 1 , … , N - 1$$

$$B = M ( C ( {p}_{0} ) , C ( {p}_{1} ) , … , C ( {p}_{n} ) )$$

where B represents the prediction for the current video block, M( ) represents a combination scheme, pᵢ represents a prediction for an i-th sub-partition in the plurality of sub-partitions, C(pᵢ) represents an intermediate result corresponding the prediction for the i-th sub-partition, conv2( ) represents a two-dimensional convolution, wᵢ represents a weight of a convolutional layer for the prediction for the i-th sub-partition, bᵢ is a bias of the convolutional layer, and N represents the number of sub-partitions in the plurality of sub-partitions.

In some embodiments, a rectified linear unit (ReLU) may be used as an activation function for the convolutional neural network. By way of example, the rectified linear unit may be as follows:

$$R ( {p}_{i} ) = \{ \begin{matrix}C ( {p}_{i} ) , & C ( {p}_{i} ) \geq 0 \\ 0 , & C ( {p}_{i} ) \leq 0\end{matrix} ∈ [ 0 , + ∞ )$$

wherein R(pᵢ) represents the rectified linear unit corresponding the prediction for the i-th sub-partition.

In some embodiments, the number of sub-partitions in the plurality of sub-partitions may be fixed. Alternatively, the number of sub-partitions in the plurality of sub-partitions may be dependent on coding context of the current video block. For example, the number of sub-partitions may be a varied value depending on context of a codec for coding the current video block. By way of example rather than limitation, the number of sub-partitions in the plurality of sub-partitions may be 2. It should be understood that the specific values recited here are intended to be exemplary rather than limiting the scope of the present disclosure.

In some embodiments, the predictions for the plurality of sub-partitions may comprise a prediction for a sub-partition of a current color component. Alternatively, a prediction for a sub-partition of a further color component different from the current color component. In some further embodiments, a prediction for a first sub-partition in the plurality of sub-partitions may comprise a prediction for the first sub-partition after a filter process, a prediction for the first sub-partition after a rescaling process, or the like.

In some embodiments, the at least one partitioning mode may be fixed and predetermined. Alternatively, the at least one partitioning mode may be dependent on coding context of the current video block.

In some embodiments, the at least one partitioning mode may comprise one or more sets of partitioning modes. For example, the one or more sets of partitioning modes may be signaled in the bitstream. In one example, the one or more sets of partitioning modes may be indicated at one of the following: a block level, a sequence level, a group of pictures level, a picture level, a slice level, or a tile group level. Additionally or alternatively, the one or more sets of partitioning modes may be indicated in a coding structure of a coding tree unit (CTU), a coding structure of a coding unit (CU), a coding structure of a transform unit (TU), a coding structure of a prediction unit (PU), a coding structure of a coding tree block (CTB), a coding structure of a coding block (CB), a coding structure of a transform block (TB), a coding structure of a prediction block (PB), a sequence header, a picture header, a sequence parameter set (SPS), a video parameter set (VPS), a dependency parameter set (DPS), a decoding capability information (DCI), a picture parameter set (PPS), an adaptation parameter sets (APS), a slice header, a tile group header, or the like.

In some embodiments, the bitstream may comprise a first syntax element indicating whether to partition the current video block. Additionally or alternatively, the bitstream may comprise a second syntax element indicating one set of partitioning modes in the one or more sets of partitioning modes that is used to partition the current video block. In some further embodiments, if the first syntax element indicates that the current video block is partitioned, the bitstream may comprise the second syntax element.

In some alternative embodiments, the bitstream may comprise a single syntax element indicating whether to partition the current video block and one set of partitioning modes in the one or more sets of partitioning modes that is used to partition the current video block.

In some embodiments, a syntax element may be coded with a fixed length coding, an exponential Golomb (EG) coding, a truncated unary coding, a unary coding, or the like. Alternatively, a syntax element may be coded with at least one context in arithmetic coding. In some further embodiments, a syntax element may be bypass coded.

In some embodiments, if the current video block is allowed to be partitioned, a syntax element associated with the partitioning may be indicated in the bitstream. Additionally or alternatively, a syntax element may be comprised in a supplemental enhancement information (SEI) message or a video usability information (VUI) message.

In some embodiments, the one or more sets of partitioning modes may be indicated in a predictive way. For example, a partitioning mode in the one or more sets of partitioning modes may be indicated in a predictive way.

In some embodiments, the at least one partitioning mode may be not signaled for the current video block. In this case, the at least one partitioning mode used for the current video block may be reused from a block coded before the current video block.

In some embodiments, the one or more sets of partitioning modes may be determined at an encoder or a decoder. For example, the one or more sets of partitioning modes may be determined based on reconstructed luma samples, neighboring reconstructed luma samples, neighboring reconstructed chroma samples, predicted chroma samples, and/or the like.

In some embodiments, the at least one partitioning mode may be dependent on at least one of a color format or a color component of the current video block. In one example, the at least one partitioning mode may be the same for a plurality of chroma components. In another example, the at least one partitioning mode may be different for a plurality of chroma components.

In some embodiments, how to obtain the at least one partitioning mode may be different for different color formats. For example, if the color format for the current video block is 4:2:0 color format or 4:2:2 color format, the at least one partitioning mode may comprise a partitioning mode for a luma intra sub-partitions (ISP) mode. If the color format for the current video block is 4:4:4 color format, the at least one partitioning mode does not may comprise a partitioning mode for the luma ISP mode.

In some embodiments, the at least one partitioning mode may be different for different coding information, different coding context, or different coding background. For example, the at least one partitioning mode may be dependent on at least one of the following: a block size of a subpicture, a block size of a tile, a block size of a slice, a block size of a CTU, a block size of a CU, a block size of a PU, a block size of a TU, a block size of a CTB, a block size of a CB, a block size of a PB, or a block size of a TB.

In some embodiments, if the block size is a first size (such as 256×256, or the like), the at least one partitioning mode may comprise a first partitioning mode. For example, if the block size is a second size (such as 128×128, or the like) different from the first size, the at least one partitioning mode may comprise a second partitioning mode different from the first partitioning mode.

In some embodiments, the at least one partitioning mode may be dependent on video content of the current video block. For example, if a type of the video content is nature sequence, the at least one partitioning mode may comprise a first partitioning mod. If the type of the video content may be screen content, the at least one partitioning mode may comprise a second partitioning mode different from the first partitioning mode.

In some embodiments, the bitstream may comprise at least one syntax element indicating at least one of the following: whether to partition the current video block, how to partition the current video block, or weights for the plurality of sub-partitions. For example, the at least one syntax element may be indicated in one of the following: an SPS, a PPS, an APS, a picture header, or a slice header.

In some embodiments, the at least one syntax element may comprise a syntax element indicating whether to partition the current video block. Additionally or alternatively, the at least one syntax element may comprise a set of syntax elements indicating how may be the at least one partitioning mode predetermined. For example, each of the set of syntax elements indicates a partitioning mode.

In some embodiments, whether to use the one or more sets of partitioning modes and/or how to use the one or more sets of partitioning modes may be indicated in the bitstream or determined based on coding information of the current video block or coding information of a block coded before the current video block.

In some embodiments, the bitstream may comprise one or more set indices indicating a set of partitioning modes in the one or more sets of partitioning modes that is used. In one example, a single set index may be used to indicate the set of partitioning modes used for a plurality of color components. In another example, indications of the set of partitioning modes used for the plurality of color components may be signaled individually.

In some embodiments, the one or more set indices may be determined based on coding information of the current video block or coding information of a block coded before the current video block. Alternatively, the one or more set indices may be determined based on a template matching based scheme. In some further embodiments, set indices for a plurality of color components may be determined together. Alternatively, set indices for a plurality of color components may be determined individually.

In some embodiments, the plurality of sub-partitions may be coded sequentially. For example, a first sub-partition in the plurality of sub-partitions may be coded before a second sub-partition in the plurality of sub-partitions. In addition, the second sub-partition may be coded based on reconstruction samples of the first sub-partition. In some alternative embodiments, the plurality of sub-partitions may be coded in parallel. For example, a first sub-partition and a second sub-partition in the plurality of sub-partitions may be coded independently from each other.

In some embodiments, a coding order of the plurality of sub-partitions may be fixed. In one example, the plurality of sub-partitions may be coded from left to right. In another example, the plurality of sub-partitions may be coded from top to bottom. In a further example, the plurality of sub-partitions may be coded from right to left. In a still further example, the plurality of sub-partitions may be coded from bottom to top. It should be understood that the above examples are described merely for purpose of description. The scope of the present disclosure is not limited in this respect.

In some embodiments, the coding order may be indicated in the bitstream. Alternatively, the coding order may be absent from the bitstream and determined at an encoder or a decoder.

In some embodiments, the at least one intra prediction scheme may be allowed to may comprise one or more predetermined predicting tools. For example, the proposed method may be used in combination with different predicting tools. In some embodiments, the at least one intra prediction scheme may comprise a predicting mode based on a liner model and/or a predicting mode based on a non-linear model.

In some embodiments, the at least one intra prediction scheme may comprise a cross-component linear model (CCLM) mode, a CCLM-Slope mode, a gradient linear model (GLM) mode, a convolutional cross-component model (CCCM) mode, a template matching prediction (TMP) mode, a decoder-side intra mode derivation (DIMD) mode, a template-based intra mode derivation (TIMD) mode, a multiple reference line (MRL) mode, a matrix weighted intra prediction (MIP) mode, and/or the like.

In some embodiments, the method may be applicable to a luma component. For example, the proposed method may also be applied to a sub-partition scheme for luma component in the decoder or the encoder when uncompressing and compressing a video unit with predicting tools.

In some embodiments, whether to and/or how to apply the method may be indicated at one of the following: a block level, a sequence level, a group of pictures level, a picture level, a slice level, or a tile group level. Alternatively, whether to and/or how to apply the method may be indicated in one of the following: a coding structure of CTU, a coding structure of CU, a coding structure of TU, a coding structure of PU, a coding structure of CTB, a coding structure of CB, a coding structure of TB, a coding structure of PB, a sequence header, a picture header, a sequence parameter set (SPS), a video parameter set (VPS), a dependency parameter set (DPS), a decoding capability information (DCI), a picture parameter set (PPS), an adaptation parameter sets (APS), a slice header, or a tile group header.

In some embodiments, whether to and/or how to apply the method may be dependent on coded information of the current video block. By way of example rather than limitation, the coded information may comprise a block size, a color format, a single tree partitioning, a dual tree partitioning, a color component, a slice type, a picture type, and/or the like.

In some embodiments, the method may be also applicable in a coding tool requiring sub-partition. The scope of the present disclosure is not limited in this respect.

In view of the above, the solutions in accordance with some embodiments of the present disclosure can advantageously improve coding efficiency and coding quality, especially when the block is of different signal and texture distributions.

According to further embodiments of the present disclosure, a non-transitory computer-readable recording medium is provided. The non-transitory computer-readable recording medium stores a bitstream of a video which is generated by a method performed by an apparatus for video processing. In the method, a prediction for a current video block of the video is determined based on a plurality of sub-partitions of the current video block and at least one intra prediction scheme. The current video block is a chroma block, and the plurality of sub-partitions are obtained by partitioning the current video block. Moreover, the bitstream is generated based on the prediction for the current video block.

According to still further embodiments of the present disclosure, a method for storing bitstream of a video is provided. In the method, a prediction for a current video block of the video is determined based on a plurality of sub-partitions of the current video block and at least one intra prediction scheme. The current video block is a chroma block, and the plurality of sub-partitions are obtained by partitioning the current video block. Moreover, the bitstream is generated based on the prediction for the current video block, and stored in a non-transitory computer-readable recording medium.

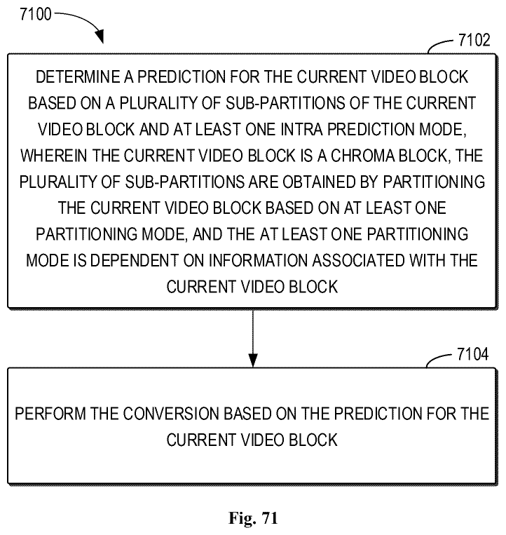

FIG. 71 illustrates a flowchart of a method 7100 for video processing in accordance with some embodiments of the present disclosure. The method 7100 may be implemented during a conversion between a current video block of a video and a bitstream of the video. The current video block is a chroma block. Alternatively, the current video block may be of a color component different from luma component. The scope of the present disclosure is not limited in this respect.

As shown in FIG. 71, the method 7100 starts at 7102 where a prediction for the current video block is determined based on a plurality of sub-partitions of the current video block and at least one intra prediction mode. The plurality of sub-partitions are obtained by partitioning the current video block based on at least one partitioning mode. Moreover, the at least one partitioning mode is dependent on information associated with the current video block.

In some embodiments, the information associated with the current video block may comprise coding background of the current video block, coding background of a block coded before the current video block, coding information of the current video block, coding information of the block coded before the current video block, coding context of the current video block, coding context of the block coded before the current video block, and/or the like.

By way of example rather than limitation, the coding information may comprise reconstructed luma samples, neighboring reconstructed luma samples, neighboring reconstructed chroma samples, and/or predicted chroma samples. It should be understood that the above illustrations are described merely for purpose of description. The scope of the present disclosure is not limited in this respect.

At 7104, the conversion is performed based on the determining. In some embodiments, the conversion may include encoding the current video block into the bitstream. Alternatively or additionally, the conversion may include decoding the current video block from the bitstream.

In view of the above, a chroma block is divided into a plurality of sub-partitions based on at least one partitioning mode that is dependent on information associated with the current video block. Then, a prediction for a chroma block is determined based on the plurality of sub-partitions and at least one intra prediction scheme. Thereby, the proposed method can advantageously improve coding efficiency and coding quality, especially when the block is of different signal and texture distributions.

In some embodiments, in one of the at least one partitioning mode, shapes of the plurality of sub-partitions may comprise a rectangle, a square, a trapezoid, a triangle, and/or the like. In addition, the plurality of sub-partitions may be arranged horizontally in the current video block, and/or the plurality of sub-partitions may be arranged vertically in the current video block.

For purpose of illustration rather than limitation, FIGS. 60-69 illustrate several example partitioning modes in accordance with some embodiments of the present disclosure. In a partitioning mode shown in FIG. 60, a block may be partitioned horizontally into sub-rectangles. In a partitioning mode shown in FIG. 61, a block may be partitioned vertically into sub-rectangles. In a partitioning mode shown in FIG. 62, a block may be partitioned horizontally into sub-squares. In a partitioning mode shown in FIG. 63, a block may be partitioned vertically into sub-squares. In a partitioning mode shown in FIG. 64, a block may be partitioned into sub-trapezoids arranged horizontally. In a partitioning mode shown in FIG. 65, a block may be partitioned into sub-trapezoids arranged vertically. In a partitioning mode shown in FIG. 66, a block may be partitioned into two sub-triangles. In a partitioning mode shown in FIG. 67, a block may be partitioned into three sub-triangles. In a partitioning mode shown in FIG. 68, a block may be partitioned into a sub-trapezoid and a sub-triangle. In a partitioning mode shown in FIG. 69, a block may be partitioned into multiple sub-trapezoids and sub-triangles. In aid of these partitioning modes, the proposed method can advantageously improve coding efficiency and coding quality, especially when the block is of different signal and texture distributions.

In some embodiments, the at least one partitioning mode may be indicated in the bitstream. In one example, the at least one partitioning mode may be indicated at one of the following: a block level, a sequence level, a group of pictures level, a picture level, a slice level, or a tile group level. In another example, the at least one partitioning mode may be indicated in one of the following: a coding structure of a coding tree unit (CTU), a coding structure of a coding unit (CU), a coding structure of a transform unit (TU), a coding structure of a prediction unit (PU), a coding structure of a coding tree block (CTB), a coding structure of a coding block (CB), a coding structure of a transform block (TB), a coding structure of a prediction block (PB), a sequence header, a picture header, a sequence parameter set (SPS), a video parameter set (VPS), a dependency parameter set (DPS), a decoding capability information (DCI), a picture parameter set (PPS), an adaptation parameter sets (APS), a slice header, or a tile group header.

In some embodiments, the bitstream may comprise a first syntax element indicating whether to partition the current video block. Additionally or alternatively, the bitstream may comprise a second syntax element indicating one of the at least one partitioning mode that is used to partition the current video block. In some further embodiments, if the first syntax element indicates that the current video block is partitioned, the bitstream may comprise the second syntax element.

In some alternative embodiments, the bitstream may comprise a single syntax element indicating whether to partition the current video block and one of the at least one partitioning mode that is used to partition the current video block.

In some embodiments, a syntax element may be coded with a fixed length coding, an exponential Golomb (EG) coding, a truncated unary coding, or a unary coding. Alternatively, a syntax element may be coded with at least one context in arithmetic coding. In some further embodiments, a syntax element may be bypass coded.

In some embodiments, if the current video block is allowed to be partitioned, a syntax element associated with the partitioning may be indicated in the bitstream. For example, a syntax element may be comprised in a supplemental enhancement information (SEI) message or a video usability information (VUI) message.

In some embodiments, a same coding mode may be used for different sub-partitions in the plurality of sub-partitions. In one example, a coding mode may be a prediction mode, which may also be referred to as a prediction scheme. In another example, a coding mode may be a transform mode. It should be understood that the possible implementations of the coding mode described here are merely illustrative and therefore should not be construed as limiting the present disclosure in any way.

In some embodiments, a coding mode used for a first sub-partition in the plurality of sub-partitions may be the same as a coding mode used for the current video block. Alternatively, a coding mode used for a first sub-partition in the plurality of sub-partitions may be different from a coding mode used for the current video block.

In some embodiments, one or more coding modes allowed to be used for the first sub-partition may be a subset of a plurality of predetermined coding modes. For example, the plurality of predetermined coding modes may comprise all available coding modes.

In some embodiments, the one or more coding modes may comprise a cross component prediction mode, such as a derived mode (DM), DIMD, CCLM, CCCM, or the like. Alternatively, the first sub-partition may be coded with a first coding mode without may be indicated in the bitstream. For example, all of the plurality of sub-partitions are required to be coded with this first coding mode, such as CCLM or the like.

In some embodiments, a plurality of coding modes may be applied on the plurality of sub-partitions. For example, the plurality of coding modes may comprise a first coding mode applied on a first sub-partition in the plurality of sub-partitions and a second coding mode applied on a second sub-partition in the plurality of sub-partitions. The first sub-partition may be different from the second sub-partition, and the first coding mode may be different from the second coding mode. In addition, different sub-partitions may be coded with different coding modes.

In some embodiments, the bitstream may comprise at least one syntax element indicating at least one of the following: whether to apply a plurality of coding modes on the plurality of sub-partitions, how to apply a plurality of coding modes on the plurality of sub-partitions, or a set of coding modes in the plurality of coding modes that is applied on the plurality of sub-partitions. By way of example, the at least one syntax element may be indicated in an SPS, a PPS, an APS, a picture header, a slice header, or the like.

In some embodiments, the at least one syntax element may comprise a first syntax element indicating whether to apply the plurality of coding modes on the plurality of sub-partitions. Additionally or alternatively, the at least one syntax element may comprise a second syntax element indicating a set of coding modes in the plurality of coding modes that is applied on the plurality of sub-partitions. In some further embodiments, if the first syntax element indicates that the plurality of coding modes are applied on the plurality of sub-partitions, the at least one syntax element may comprise the second syntax element.

In some alternative embodiments, the at least one syntax element may comprise a single syntax element indicates whether to apply a plurality of coding modes on the plurality of sub-partitions and a set of coding modes in the plurality of coding modes that is applied on the plurality of sub-partitions.

In some embodiments, a syntax element in the at least one syntax element may be coded with a fixed length coding, an exponential Golomb (EG) coding, a truncated unary coding, or a unary coding. Alternatively, a syntax element in the at least one syntax element may be coded with at least one context in arithmetic coding. In some further embodiments, a syntax element in the at least one syntax element may be bypass coded.

In some embodiments, if the plurality of coding modes are allowed to be applied on the plurality of sub-partitions, a syntax element in the at least one syntax element may be indicated in the bitstream. By way of example, a syntax element in the at least one syntax element may be comprised in a supplemental enhancement information (SEI) message or a video usability information (VUI) message.

In some embodiments, the proposed method may also be applicable to a red-green-blue (RGB) format, an intra prediction, or an inter prediction. The scope of the present disclosure is not limited in this respect.

In view of the above, the solutions in accordance with some embodiments of the present disclosure can advantageously improve coding efficiency and coding quality, especially when the block is of different signal and texture distributions.

According to further embodiments of the present disclosure, a non-transitory computer-readable recording medium is provided. The non-transitory computer-readable recording medium stores a bitstream of a video which is generated by a method performed by an apparatus for video processing. In the method, a prediction for a current video block of the video is determined based on a plurality of sub-partitions of the current video block and at least one intra prediction mode. The current video block is a chroma block. The plurality of sub-partitions are obtained by partitioning the current video block based on at least one partitioning mode, and the at least one partitioning mode is dependent on information associated with the current video block. Moreover, the bitstream is generated based on the prediction for the current video block.

According to still further embodiments of the present disclosure, a method for storing bitstream of a video is provided. In the method, a prediction for a current video block of the video is determined based on a plurality of sub-partitions of the current video block and at least one intra prediction mode. The current video block is a chroma block. The plurality of sub-partitions are obtained by partitioning the current video block based on at least one partitioning mode, and the at least one partitioning mode is dependent on information associated with the current video block. Moreover, the bitstream is generated based on the prediction for the current video block, and stored in a non-transitory computer-readable recording medium.

Implementations of the present disclosure can be described in view of the following clauses, the features of which can be combined in any reasonable manner.

Clause 1. A method for video processing, comprising: determining, for a conversion between a current video block of a video and a bitstream of the video, a prediction for the current video block based on a plurality of sub-partitions of the current video block and at least one intra prediction scheme, wherein the current video block is a chroma block, and the plurality of sub-partitions are obtained by partitioning the current video block; and performing the conversion based on the prediction for the current video block.

Clause 2. The method of clause 1, wherein the plurality of sub-partitions are obtained by partitioning the current video block based on at least one partitioning mode.

Clause 3. The method of clause 2, wherein the at least one partitioning mode comprise a plurality of partitioning modes.

Clause 4. The method of clause 3, wherein information regarding at least one of the following is indicated in the bitstream: whether to use the plurality of partitioning modes, or one of the plurality of partitioning modes that is used.

Clause 5. The method of clause 3, wherein information regarding at least one of the following is determined based on coding information of the current video block or coding information of a block coded before the current video block: whether to use the plurality of partitioning modes, or one of the plurality of partitioning modes that is used.

Clause 6. The method of any of clauses 3-5, wherein the number of partitioning modes in the plurality of partitioning modes is dependent on coding information of the current video block or coding information of a block coded before the current video block.

Clause 7. The method of any of clauses 5-6, wherein the coding information comprises at least one of the following: a block dimension, a block size, a block depth, a slice type, a picture type, a partition tree type, a temporal layer identification, a quantization parameter, or a coding mode.

Clause 8. The method of any of clauses 1-7, wherein the prediction for the current video block is determined based on predictions for the plurality of sub-partitions and geometric positions of the plurality of sub-partitions in the current video block, and the predictions for the plurality of sub-partitions are determined based on the at least one intra prediction scheme.

Clause 9. The method of clause 8, wherein the prediction for the current video block is determined as follows:

$$B = F ( {p}_{0} , {p}_{1} , … , {p}_{N - 1} )$$

where B represents the prediction for the current video block, pᵢ represents a prediction for an i-th sub-partition in the plurality of sub-partitions, N represents the number of sub-partitions in the plurality of sub-partitions, and F( ) represents a combination scheme for combining the predictions for the plurality of sub-partitions based on the geometric positions of the plurality of sub-partitions.

Clause 10. The method of clause 8, wherein the prediction for the current video block is determined as follows:

$$B = F ( {p}_{0} , {p}_{1} , … , {p}_{N - 1} ) >> k$$

where B represents the prediction for the current video block, pᵢ represents a prediction for an i-th sub-partition in the plurality of sub-partitions, N represents the number of sub-partitions in the plurality of sub-partitions, F( ) represents a combination scheme for combining the predictions for the plurality of sub-partitions based on the geometric positions of the plurality of sub-partitions, and k represents the number of right shift.

Clause 11. The method of any of clauses 1-7, wherein the prediction for the current video block is determined based on a non-linear combination scheme for combining predictions for the plurality of sub-partitions, and the predictions for the plurality of sub-partitions are determined based on the at least one intra prediction scheme.

Clause 12. The method of clause 11, wherein a convolutional neural network is used in the non-linear combination scheme.

Clause 13. The method of clause 12, wherein the prediction for the current video block is determined as follows:

$$C ( {p}_{i} ) = conv 2 ( {w}_{i} , {p}_{i} ) + {b}_{i} , i = 0 , 1 , … , N - 1$$

$$B = M ( C ( {p}_{0} ) , C ( {p}_{1} ) , … , C ( {p}_{n} ) )$$

where B represents the prediction for the current video block, M( ) represents a combination scheme, pᵢ represents a prediction for an i-th sub-partition in the plurality of sub-partitions, C(pᵢ) represents an intermediate result corresponding the prediction for the i-th sub-partition, conv2( ) represents a two-dimensional convolution, wᵢ represents a weight of a convolutional layer for the prediction for the i-th sub-partition, bᵢ is a bias of the convolutional layer, and N represents the number of sub-partitions in the plurality of sub-partitions.

Clause 14. The method of clause 13, wherein a rectified linear unit (ReLU) is used as an activation function for the convolutional neural network.

Clause 15. The method of clause 14, wherein the rectified linear unit is as follows:

$$R ( {p}_{i} ) = \{ \begin{matrix}C ( {p}_{i} ) , & C ( {p}_{i} ) \geq 0 \\ 0 , & C ( {p}_{i} ) \leq 0\end{matrix} ∈ [ 0 , + ∞ )$$

wherein R(pᵢ) represents the rectified linear unit corresponding the prediction for the i-th sub-partition.

Clause 16. The method of any of clauses 1-15, wherein the number of sub-partitions in the plurality of sub-partitions is fixed, or the number of sub-partitions in the plurality of sub-partitions is dependent on coding context of the current video block.

Clause 17. The method of any of clauses 8-16, wherein the predictions for the plurality of sub-partitions comprise a prediction for a sub-partition of a current color component, or a prediction for a sub-partition of a further color component different from the current color component.

Clause 18. The method of any of clauses 8-17, wherein a prediction for a first sub-partition in the plurality of sub-partitions comprises one of the following: a prediction for the first sub-partition after a filter process, or a prediction for the first sub-partition after a rescaling process.

Clause 19. The method of any of clauses 1-18, wherein the number of sub-partitions in the plurality of sub-partitions is 2.

Clause 20. The method of any of clauses 2-19, wherein the at least one partitioning mode is fixed and predetermined, or the at least one partitioning mode is dependent on coding context of the current video block.

Clause 21. The method of any of clauses 2-20, wherein the at least one partitioning mode comprise one or more sets of partitioning modes.

Clause 22. The method of clause 21, wherein the one or more sets of partitioning modes are signaled in the bitstream.

Clause 23. The method of clause 22, wherein the one or more sets of partitioning modes are indicated at one of the following: a block level, a sequence level, a group of pictures level, a picture level, a slice level, or a tile group level.

Clause 24. The method of clause 22, wherein the one or more sets of partitioning modes are indicated in one of the following: a coding structure of a coding tree unit (CTU), a coding structure of a coding unit (CU), a coding structure of a transform unit (TU), a coding structure of a prediction unit (PU), a coding structure of a coding tree block (CTB), a coding structure of a coding block (CB), a coding structure of a transform block (TB), a coding structure of a prediction block (PB), a sequence header, a picture header, a sequence parameter set (SPS), a video parameter set (VPS), a dependency parameter set (DPS), a decoding capability information (DCI), a picture parameter set (PPS), an adaptation parameter sets (APS), a slice header, or a tile group header.

Clause 25. The method of any of clauses 21-24, wherein the bitstream comprises a first syntax element indicating whether to partition the current video block.

Clause 26. The method of any of clauses 21-25, wherein the bitstream comprises a second syntax element indicating one set of partitioning modes in the one or more sets of partitioning modes that is used to partition the current video block.

Clause 27. The method of clause 25, wherein if the first syntax element indicates that the current video block is partitioned, the bitstream comprises a second syntax element indicating one set of partitioning modes in the one or more sets of partitioning modes that is used to partition the current video block.

Clause 28. The method of any of clauses 21-24, wherein the bitstream comprises a single syntax element indicating whether to partition the current video block and one set of partitioning modes in the one or more sets of partitioning modes that is used to partition the current video block.

Clause 29. The method of any of clauses 25-28, wherein a syntax element is coded with one of the following: a fixed length coding, an exponential Golomb (EG) coding, a truncated unary coding, or a unary coding.

Clause 30. The method of any of clauses 25-28, wherein a syntax element is coded with at least one context in arithmetic coding.

Clause 31. The method of any of clauses 25-28, wherein a syntax element is bypass coded.

Clause 32. The method of any of clauses 25-31, wherein if the current video block is allowed to be partitioned, a syntax element associated with the partitioning is indicated in the bitstream.

Clause 33. The method of any of clauses 25-32, wherein a syntax element is comprised in a supplemental enhancement information (SEI) message or a video usability information (VUI) message.

Clause 34. The method of any of clauses 22-33, wherein the one or more sets of partitioning modes are indicated in a predictive way.

Clause 35. The method of any of clauses 22-34, wherein a partitioning mode in the one or more sets of partitioning modes is indicated in a predictive way.

Clause 36. The method of any of clauses 2-21, wherein the at least one partitioning mode is not signaled for the current video block, and the at least one partitioning mode is reused from a block coded before the current video block.

Clause 37. The method of any of clauses 21-36, wherein the one or more sets of partitioning modes are determined at an encoder or a decoder.

Clause 38. The method of clause 37, wherein the one or more sets of partitioning modes are determined based on at least one of the following: reconstructed luma samples, neighboring reconstructed luma samples, neighboring reconstructed chroma samples, or predicted chroma samples.

Clause 39. The method of any of clauses 2-38, wherein the at least one partitioning mode is dependent on at least one of a color format or a color component of the current video block.

Clause 40. The method of any of clauses 2-38, wherein the at least one partitioning mode is the same for a plurality of chroma components, or the at least one partitioning mode is different for a plurality of chroma components.

Clause 41. The method of clause 40, wherein how to obtain the at least one partitioning mode is different for different color formats.

Clause 42. The method of clause 41, wherein if the color format for the current video block is 4:2:0 color format or 4:2:2 color format, the at least one partitioning mode comprises a partitioning mode for a luma intra sub-partitions (ISP) mode, or if the color format for the current video block is 4:4:4 color format, the at least one partitioning mode does not comprise a partitioning mode for the luma ISP mode.

Clause 43. The method of any of clauses 2-42, wherein the at least one partitioning mode is different for different coding information, different coding context, or different coding background.

Clause 44. The method of any of clauses 2-42, wherein the at least one partitioning mode is dependent on at least one of the following: a block size of a subpicture, a block size of a tile, a block size of a slice, a block size of a CTU, a block size of a CU, a block size of a PU, a block size of a TU, a block size of a CTB, a block size of a CB, a block size of a PB, or a block size of a TB.

Clause 45. The method of clause 44, wherein if the block size is a first size, the at least one partitioning mode comprises a first partitioning mode, or if the block size is a second size different from the first size, the at least one partitioning mode comprises a second partitioning mode different from the first partitioning mode.

Clause 46. The method of any of clauses 2-42, wherein the at least one partitioning mode is dependent on video content of the current video block.

Clause 47. The method of clause 46, wherein if a type of the video content is nature sequence, the at least one partitioning mode comprises a first partitioning mode, or if the type of the video content is screen content, the at least one partitioning mode comprises a second partitioning mode different from the first partitioning mode.

Clause 48. The method of any of clauses 1-47, wherein the bitstream comprises at least one syntax element indicating at least one of the following: whether to partition the current video block, how to partition the current video block, or weights for the plurality of sub-partitions.

Clause 49. The method of clause 48, wherein the at least one syntax element is indicated in one of the following: an SPS, a PPS, an APS, a picture header, or a slice header.

Clause 50. The method of any of clauses 48-49, wherein the at least one syntax element comprises a syntax element indicating whether to partition the current video block.

Clause 51. The method of any of clauses 48-50, wherein the at least one syntax element comprises a set of syntax elements indicating how are the at least one partitioning mode predetermined.

Clause 52. The method of clause 51, wherein each of the set of syntax elements indicates a partitioning mode.

Clause 53. The method of any of clauses 21-52, wherein at least one of the following is indicated in the bitstream or determined based on coding information of the current video block or coding information of a block coded before the current video block: whether to use the one or more sets of partitioning modes, or how to use the one or more sets of partitioning modes.

Clause 54. The method of any of clauses 21-54, wherein the bitstream comprises one or more set indices indicating a set of partitioning modes in the one or more sets of partitioning modes that is used.

Clause 55. The method of clause 54, wherein a single set index is used to indicate the set of partitioning modes used for a plurality of color components, or wherein indications of the set of partitioning modes used for the plurality of color components are signaled individually.

Clause 56. The method of clause 54, wherein the one or more set indices are determined based on coding information of the current video block or coding information of a block coded before the current video block, or the one or more set indices are determined based on a template matching based scheme, or set indices for a plurality of color components are determined together, or set indices for a plurality of color components are determined individually.

Clause 57. The method of any of clauses 1-56, wherein the plurality of sub-partitions are coded sequentially.

Clause 58. The method of clause 57, wherein a first sub-partition in the plurality of sub-partitions is coded before a second sub-partition in the plurality of sub-partitions, and the second sub-partition is coded based on reconstruction samples of the first sub-partition.

Clause 59. The method of any of clauses 1-56, wherein the plurality of sub-partitions are coded in parallel.

Clause 60. The method of clause 59, wherein a first sub-partition and a second sub-partition in the plurality of sub-partitions are coded independently from each other.

Clause 61. The method of any of clauses 1-58, wherein a coding order of the plurality of sub-partitions is fixed.

Clause 62. The method of clause 61, wherein the plurality of sub-partitions are coded from left to right, or the plurality of sub-partitions are coded from top to bottom, or the plurality of sub-partitions are coded from right to left, or the plurality of sub-partitions are coded from bottom to top.

Clause 63. The method of any of clauses 61-62, wherein the coding order is indicated in the bitstream, or the coding order is absent from the bitstream and determined at an encoder or a decoder.

Clause 64. The method of any of clauses 1-63, wherein the at least one intra prediction scheme is allowed to comprise one or more predetermined predicting tools.

Clause 65. The method of any of clauses 1-64, wherein the at least one intra prediction scheme comprises at least one of the following: a predicting mode based on a liner model, or a predicting mode based on a non-linear model.

Clause 66. The method of any of clauses 1-65, wherein the at least one intra prediction scheme comprises at least one of the following: a cross-component linear model (CCLM) mode, a CCLM-Slope mode, a gradient linear model (GLM) mode, a convolutional cross-component model (CCCM) mode, a template matching prediction (TMP) mode, a decoder-side intra mode derivation (DIMD) mode, a template-based intra mode derivation (TIMD) mode, a multiple reference line (MRL) mode, or a matrix weighted intra prediction (MIP) mode.

Clause 67. The method of any of clauses 1-66, wherein the method is applicable to a luma component.

Clause 68. The method of any of clauses 1-67, wherein whether to and/or how to apply the method is indicated at one of the following: a block level, a sequence level, a group of pictures level, a picture level, a slice level, or a tile group level.

Clause 69. The method of any of clauses 1-67, wherein whether to and/or how to apply the method is indicated in one of the following: a coding structure of CTU, a coding structure of CU, a coding structure of TU, a coding structure of PU, a coding structure of CTB, a coding structure of CB, a coding structure of TB, a coding structure of PB, a sequence header, a picture header, a sequence parameter set (SPS), a video parameter set (VPS), a dependency parameter set (DPS), a decoding capability information (DCI), a picture parameter set (PPS), an adaptation parameter sets (APS), a slice header, or a tile group header.

Clause 70. The method of any of clauses 1-69, wherein whether to and/or how to apply the method is dependent on coded information of the current video block.

Clause 71. The method of clause 70, wherein the coded information comprises at least one of the following: a block size, a color format, a single tree partitioning, a dual tree partitioning, a color component, a slice type, or a picture type.

Clause 72. The method of any of clauses 1-71, wherein the method is applicable in a coding tool requiring sub-partition.

Clause 73. The method of any of clauses 1-72, wherein the conversion includes encoding the current video block into the bitstream.

Clause 74. The method of any of clauses 1-72, wherein the conversion includes decoding the current video block from the bitstream.

Clause 75. An apparatus for video processing comprising a processor and a non-transitory memory with instructions thereon, wherein the instructions upon execution by the processor, cause the processor to perform a method in accordance with any of clauses 1-74.

Clause 76. A non-transitory computer-readable storage medium storing instructions that cause a processor to perform a method in accordance with any of clauses 1-74.

Clause 77. A non-transitory computer-readable recording medium storing a bitstream of a video which is generated by a method performed by an apparatus for video processing, wherein the method comprises: determining a prediction for a current video block of the video based on a plurality of sub-partitions of the current video block and at least one intra prediction scheme, wherein the current video block is a chroma block, and the plurality of sub-partitions are obtained by partitioning the current video block; and generating the bitstream based on the prediction for the current video block.

Clause 78. A method for storing a bitstream of a video, comprising: determining a prediction for a current video block of the video based on a plurality of sub-partitions of the current video block and at least one intra prediction scheme, wherein the current video block is a chroma block, and the plurality of sub-partitions are obtained by partitioning the current video block; generating the bitstream based on the prediction for the current video block; and storing the bitstream in a non-transitory computer-readable recording medium.

Clause 79. A method for video processing, comprising: determining, for a conversion between a current video block of a video and a bitstream of the video, a prediction for the current video block based on a plurality of sub-partitions of the current video block and at least one intra prediction mode, wherein the current video block is a chroma block, the plurality of sub-partitions are obtained by partitioning the current video block based on at least one partitioning mode, and the at least one partitioning mode is dependent on information associated with the current video block; and performing the conversion based on the prediction for the current video block.

Clause 80. The method of clause 79, wherein the information associated with the current video block comprises at least one of the following: coding background of the current video block, coding background of a block coded before the current video block, coding information of the current video block, coding information of the block coded before the current video block, coding context of the current video block, or coding context of the block coded before the current video block.

Clause 81. The method of clause 80, wherein the coding information comprises at least one of the following: reconstructed luma samples, neighboring reconstructed luma samples, neighboring reconstructed chroma samples, or predicted chroma samples.

Clause 82. The method of any of clauses 79-81, wherein in one of the at least one partitioning mode, shapes of the plurality of sub-partitions comprise at least one of the following: a rectangle, a square, a trapezoid, a triangle.

Clause 83. The method of clause 82, wherein the plurality of sub-partitions are arranged horizontally in the current video block, or the plurality of sub-partitions are arranged vertically in the current video block.

Clause 84. The method of any of clauses 79-83, wherein the at least one partitioning mode is indicated in the bitstream.

Clause 85. The method of clause 84, wherein the at least one partitioning mode is indicated at one of the following: a block level, a sequence level, a group of pictures level, a picture level, a slice level, or a tile group level.

Clause 86. The method of clause 84, wherein the at least one partitioning mode is indicated in one of the following: a coding structure of a coding tree unit (CTU), a coding structure of a coding unit (CU), a coding structure of a transform unit (TU), a coding structure of a prediction unit (PU), a coding structure of a coding tree block (CTB), a coding structure of a coding block (CB), a coding structure of a transform block (TB), a coding structure of a prediction block (PB), a sequence header, a picture header, a sequence parameter set (SPS), a video parameter set (VPS), a dependency parameter set (DPS), a decoding capability information (DCI), a picture parameter set (PPS), an adaptation parameter sets (APS), a slice header, or a tile group header.

Clause 87. The method of any of clauses 79-86, wherein the bitstream comprises a first syntax element indicating whether to partition the current video block.

Clause 88. The method of any of clauses 79-97, wherein the bitstream comprises a second syntax element indicating one of the at least one partitioning mode that is used to partition the current video block.

Clause 89. The method of clause 87, wherein if the first syntax element indicates that the current video block is partitioned, the bitstream comprises a second syntax element indicating one of the at least one partitioning mode that is used to partition the current video block.

Clause 90. The method of any of clauses 79-86, wherein the bitstream comprises a single syntax element indicating whether to partition the current video block and one of the at least one partitioning mode that is used to partition the current video block.

Clause 91. The method of any of clauses 87-90, wherein a syntax element is coded with one of the following: a fixed length coding, an exponential Golomb (EG) coding, a truncated unary coding, or a unary coding.

Clause 92. The method of any of clauses 87-90, wherein a syntax element is coded with at least one context in arithmetic coding.

Clause 93. The method of any of clauses 87-90, wherein a syntax element is bypass coded.

Clause 94. The method of any of clauses 87-93, wherein if the current video block is allowed to be partitioned, a syntax element associated with the partitioning is indicated in the bitstream.

Clause 95. The method of any of clauses 87-94, wherein a syntax element is comprised in a supplemental enhancement information (SEI) message or a video usability information (VUI) message.

Clause 96. The method of any of clauses 79-95, wherein a same coding mode is used for different sub-partitions in the plurality of sub-partitions.

Clause 97. The method of any of clauses 79-95, wherein a coding mode used for a first sub-partition in the plurality of sub-partitions is the same as a coding mode used for the current video block.

Clause 98. The method of any of clauses 79-96, wherein a coding mode used for a first sub-partition in the plurality of sub-partitions is different from a coding mode used for the current video block.

Clause 99. The method of clause 98, wherein one or more coding modes allowed to be used for the first sub-partition are a subset of a plurality of predetermined coding modes.

Clause 100. The method of clause 99, wherein the one or more coding modes comprises a cross component prediction mode.

Clause 101. The method of any of clauses 97-100, wherein the first sub-partition is coded with a first coding mode without being indicated in the bitstream.

Clause 102. The method of any of clauses 79-101, wherein a plurality of coding modes are applied on the plurality of sub-partitions.

Clause 103. The method of clause 102, wherein the plurality of coding modes comprise a first coding mode applied on a first sub-partition in the plurality of sub-partitions and a second coding mode applied on a second sub-partition in the plurality of sub-partitions, the first sub-partition is different from the second sub-partition, and the first coding mode is different from the second coding mode.

Clause 104. The method of any of clauses 79-103, wherein the bitstream comprises at least one syntax element indicating at least one of the following: whether to apply a plurality of coding modes on the plurality of sub-partitions, how to apply a plurality of coding modes on the plurality of sub-partitions, or a set of coding modes in the plurality of coding modes that is applied on the plurality of sub-partitions.

Clause 105. The method of clause 104, wherein the at least one syntax element is indicated in one of the following: an SPS, a PPS, an APS, a picture header, or a slice header.

Clause 106. The method of any of clauses 104-105, wherein the at least one syntax element comprises a first syntax element indicating whether to apply the plurality of coding modes on the plurality of sub-partitions.

Clause 107. The method of any of clauses 104-106, wherein the at least one syntax element comprises a second syntax element indicating a set of coding modes in the plurality of coding modes that is applied on the plurality of sub-partitions.

Clause 108. The method of clause 106, wherein if the first syntax element indicates that the plurality of coding modes are applied on the plurality of sub-partitions, the at least one syntax element comprises a second syntax element indicating a set of coding modes in the plurality of coding modes that is applied on the plurality of sub-partitions.

Clause 109. The method of clause 104, wherein the at least one syntax element comprises a single syntax element indicates whether to apply a plurality of coding modes on the plurality of sub-partitions and a set of coding modes in the plurality of coding modes that is applied on the plurality of sub-partitions.

Clause 110. The method of any of clauses 104-109, wherein a syntax element in the at least one syntax element is coded with one of the following: a fixed length coding, an exponential Golomb (EG) coding, a truncated unary coding, or a unary coding.

Clause 111. The method of any of clauses 104-109, wherein a syntax element in the at least one syntax element is coded with at least one context in arithmetic coding.

Clause 112. The method of any of clauses 104-109, wherein a syntax element in the at least one syntax element is bypass coded.

Clause 113. The method of any of clauses 104-112, wherein if the plurality of coding modes are allowed to be applied on the plurality of sub-partitions, a syntax element in the at least one syntax element is indicated in the bitstream.

Clause 114. The method of any of clauses 104-113, wherein a syntax element in the at least one syntax element is comprised in a supplemental enhancement information (SEI) message or a video usability information (VUI) message.

Clause 115. The method of any of clauses 96-114, wherein a coding mode comprises at least one of a prediction mode or a transform mode.

Clause 116. The method of any of clauses 79-115, wherein the chroma block is of Cr component.

Clause 117. The method of any of clauses 79-115, wherein the method is applicable to RGB format, intra prediction, or inter prediction.

Clause 118. The method of any of clauses 79-117, wherein the conversion includes encoding the current video block into the bitstream.

Clause 119. The method of any of clauses 79-117, wherein the conversion includes decoding the current video block from the bitstream.

Clause 120. An apparatus for video processing comprising a processor and a non-transitory memory with instructions thereon, wherein the instructions upon execution by the processor, cause the processor to perform a method in accordance with any of clauses 79-119.

Clause 121. A non-transitory computer-readable storage medium storing instructions that cause a processor to perform a method in accordance with any of clauses 79-119.

Clause 122. A non-transitory computer-readable recording medium storing a bitstream of a video which is generated by a method performed by an apparatus for video processing, wherein the method comprises: determining a prediction for a current video block of the video based on a plurality of sub-partitions of the current video block and at least one intra prediction mode, wherein the current video block is a chroma block, the plurality of sub-partitions are obtained by partitioning the current video block based on at least one partitioning mode, and the at least one partitioning mode is dependent on information associated with the current video block; and generating the bitstream based on the prediction for the current video block.

Clause 123. A method for storing a bitstream of a video, comprising: determining a prediction for a current video block of the video based on a plurality of sub-partitions of the current video block and at least one intra prediction mode, wherein the current video block is a chroma block, the plurality of sub-partitions are obtained by partitioning the current video block based on at least one partitioning mode, and the at least one partitioning mode is dependent on information associated with the current video block; generating the bitstream based on the prediction for the current video block; and storing the bitstream in a non-transitory computer-readable recording medium.

### Example Device

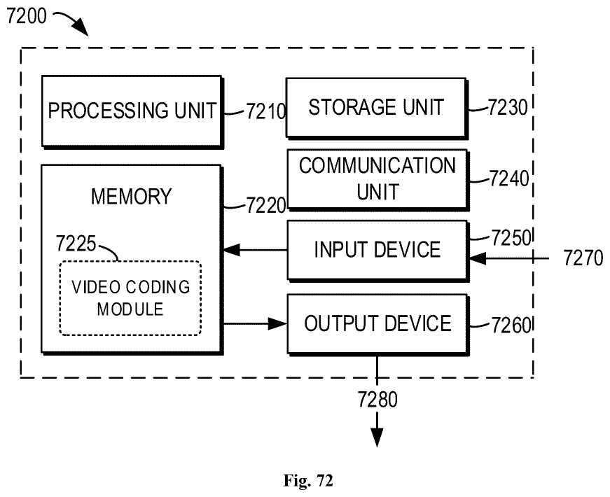

FIG. 72 illustrates a block diagram of a computing device 7200 in which various embodiments of the present disclosure can be implemented. The computing device 7200 may be implemented as or included in the source device 110 (or the video encoder 114 or 200) or the destination device 120 (or the video decoder 124 or 300).

It would be appreciated that the computing device 7200 shown in FIG. 72 is merely for purpose of illustration, without suggesting any limitation to the functions and scopes of the embodiments of the present disclosure in any manner.

As shown in FIG. 72, the computing device 7200 includes a general-purpose computing device 7200. The computing device 7200 may at least comprise one or more processors or processing units 7210, a memory 7220, a storage unit 7230, one or more communication units 7240, one or more input devices 7250, and one or more output devices 7260.

In some embodiments, the computing device 7200 may be implemented as any user terminal or server terminal having the computing capability. The server terminal may be a server, a large-scale computing device or the like that is provided by a service provider. The user terminal may for example be any type of mobile terminal, fixed terminal, or portable terminal, including a mobile phone, station, unit, device, multimedia computer, multimedia tablet, Internet node, communicator, desktop computer, laptop computer, notebook computer, netbook computer, tablet computer, personal communication system (PCS) device, personal navigation device, personal digital assistant (PDA), audio/video player, digital camera/video camera, positioning device, television receiver, radio broadcast receiver, E-book device, gaming device, or any combination thereof, including the accessories and peripherals of these devices, or any combination thereof. It would be contemplated that the computing device 7200 can support any type of interface to a user (such as “wearable” circuitry and the like).

The processing unit 7210 may be a physical or virtual processor and can implement various processes based on programs stored in the memory 7220. In a multi-processor system, multiple processing units execute computer executable instructions in parallel so as to improve the parallel processing capability of the computing device 7200. The processing unit 7210 may also be referred to as a central processing unit (CPU), a microprocessor, a controller or a microcontroller.

The computing device 7200 typically includes various computer storage medium. Such medium can be any medium accessible by the computing device 7200, including, but not limited to, volatile and non-volatile medium, or detachable and non-detachable medium. The memory 7220 can be a volatile memory (for example, a register, cache, Random Access Memory (RAM)), a non-volatile memory (such as a Read-Only Memory (ROM), Electrically Erasable Programmable Read-Only Memory (EEPROM), or a flash memory), or any combination thereof. The storage unit 7230 may be any detachable or non-detachable medium and may include a machine-readable medium such as a memory, flash memory drive, magnetic disk or another other media, which can be used for storing information and/or data and can be accessed in the computing device 7200.

The computing device 7200 may further include additional detachable/non-detachable, volatile/non-volatile memory medium. Although not shown in FIG. 72, it is possible to provide a magnetic disk drive for reading from and/or writing into a detachable and non-volatile magnetic disk and an optical disk drive for reading from and/or writing into a detachable non-volatile optical disk. In such cases, each drive may be connected to a bus (not shown) via one or more data medium interfaces.

The communication unit 7240 communicates with a further computing device via the communication medium. In addition, the functions of the components in the computing device 7200 can be implemented by a single computing cluster or multiple computing machines that can communicate via communication connections. Therefore, the computing device 7200 can operate in a networked environment using a logical connection with one or more other servers, networked personal computers (PCs) or further general network nodes.

The input device 7250 may be one or more of a variety of input devices, such as a mouse, keyboard, tracking ball, voice-input device, and the like. The output device 7260 may be one or more of a variety of output devices, such as a display, loudspeaker, printer, and the like. By means of the communication unit 7240, the computing device 7200 can further communicate with one or more external devices (not shown) such as the storage devices and display device, with one or more devices enabling the user to interact with the computing device 7200, or any devices (such as a network card, a modem and the like) enabling the computing device 7200 to communicate with one or more other computing devices, if required. Such communication can be performed via input/output (I/O) interfaces (not shown).

In some embodiments, instead of being integrated in a single device, some or all components of the computing device 7200 may also be arranged in cloud computing architecture. In the cloud computing architecture, the components may be provided remotely and work together to implement the functionalities described in the present disclosure. In some embodiments, cloud computing provides computing, software, data access and storage service, which will not require end users to be aware of the physical locations or configurations of the systems or hardware providing these services. In various embodiments, the cloud computing provides the services via a wide area network (such as Internet) using suitable protocols. For example, a cloud computing provider provides applications over the wide area network, which can be accessed through a web browser or any other computing components. The software or components of the cloud computing architecture and corresponding data may be stored on a server at a remote position. The computing resources in the cloud computing environment may be merged or distributed at locations in a remote data center. Cloud computing infrastructures may provide the services through a shared data center, though they behave as a single access point for the users. Therefore, the cloud computing architectures may be used to provide the components and functionalities described herein from a service provider at a remote location. Alternatively, they may be provided from a conventional server or installed directly or otherwise on a client device.

The computing device 7200 may be used to implement video encoding/decoding in embodiments of the present disclosure. The memory 7220 may include one or more video coding modules 7225 having one or more program instructions. These modules are accessible and executable by the processing unit 7210 to perform the functionalities of the various embodiments described herein.

In the example embodiments of performing video encoding, the input device 7250 may receive video data as an input 7270 to be encoded. The video data may be processed, for example, by the video coding module 7225, to generate an encoded bitstream. The encoded bitstream may be provided via the output device 7260 as an output 7280.

In the example embodiments of performing video decoding, the input device 7250 may receive an encoded bitstream as the input 7270. The encoded bitstream may be processed, for example, by the video coding module 7225, to generate decoded video data. The decoded video data may be provided via the output device 7260 as the output 7280.

While this disclosure has been particularly shown and described with references to preferred embodiments thereof, it will be understood by those skilled in the art that various changes in form and details may be made therein without departing from the spirit and scope of the present application as defined by the appended claims. Such variations are intended to be covered by the scope of this present application. As such, the foregoing description of embodiments of the present application is not intended to be limiting.

I/We claim:

1. A method for video processing, comprising:
determining, for a conversion between a current video block of a video and a bitstream of the video, a prediction for the current video block based on a plurality of sub-partitions of the current video block and at least one intra prediction scheme, wherein the current video block is a chroma block, and the plurality of sub-partitions are obtained by partitioning the current video block; and
performing the conversion based on the prediction for the current video block.

2. The method of claim 1, wherein the plurality of sub-partitions are obtained by partitioning the current video block based on at least one partitioning mode.

3. The method of claim 2, wherein the at least one partitioning mode comprise a plurality of partitioning modes.

4. The method of claim 3, wherein information regarding at least one of the following is indicated in the bitstream: whether to use the plurality of partitioning modes, or one of the plurality of partitioning modes that is used, or
information regarding at least one of the following is determined based on coding information of the current video block or coding information of a block coded before the current video block: whether to use the plurality of partitioning modes, or one of the plurality of partitioning modes that is used, or
wherein the number of partitioning modes in the plurality of partitioning modes is dependent on coding information of the current video block or coding information of a block coded before the current video block.

5. The method of claim 1, wherein the prediction for the current video block is determined based on predictions for the plurality of sub-partitions and geometric positions of the plurality of sub-partitions in the current video block, and the predictions for the plurality of sub-partitions are determined based on the at least one intra prediction scheme, or
wherein the prediction for the current video block is determined based on a non-linear combination scheme for combining predictions for the plurality of sub-partitions, and the predictions for the plurality of sub-partitions are determined based on the at least one intra prediction scheme.

6. The method of claim 5, wherein the predictions for the plurality of sub-partitions comprise a prediction for a sub-partition of a current color component, or a prediction for a sub-partition of a further color component different from the current color component, or
wherein a prediction for a first sub-partition in the plurality of sub-partitions comprises one of the following:
a prediction for the first sub-partition after a filter process, or
a prediction for the first sub-partition after a rescaling process.

7. The method of claim 1, wherein the number of sub-partitions in the plurality of sub-partitions is 2.

8. The method of claim 2, wherein the at least one partitioning mode comprise one or more sets of partitioning modes.

9. The method of claim 8, wherein the one or more sets of partitioning modes are signaled in the bitstream, or
wherein the one or more sets of partitioning modes are determined at an encoder or a decoder.

10. The method of claim 2, wherein the at least one partitioning mode is dependent on at least one of a color format or a color component of the current video block.

11. The method of claim 2, wherein the at least one partitioning mode is the same for a plurality of chroma components, or the at least one partitioning mode is different for a plurality of chroma components.

12. The method of claim 11, wherein if the color format for the current video block is 4:2:0 color format or 4:2:2 color format, the at least one partitioning mode comprises a partitioning mode for a luma intra sub-partitions (ISP) mode, or
if the color format for the current video block is 4:4:4 color format, the at least one partitioning mode does not comprise a partitioning mode for the luma ISP mode.

13. The method of claim 1, wherein the bitstream comprises at least one syntax element indicating at least one of the following:
whether to partition the current video block,
how to partition the current video block, or
weights for the plurality of sub-partitions.

14. The method of claim 8, wherein at least one of the following is indicated in the bitstream or determined based on coding information of the current video block or coding information of a block coded before the current video block: whether to use the one or more sets of partitioning modes, or how to use the one or more sets of partitioning modes, or
wherein the bitstream comprises one or more set indices indicating a set of partitioning modes in the one or more sets of partitioning modes that is used.

15. The method of claim 1, wherein the plurality of sub-partitions are coded sequentially, or
wherein the plurality of sub-partitions are coded in parallel, or
wherein a coding order of the plurality of sub-partitions is fixed, or
wherein the at least one intra prediction scheme is allowed to comprise one or more predetermined predicting tools, or
wherein the method is applicable to a luma component, or
wherein the method is applicable in a coding tool requiring sub-partition.

16. The method of claim 1, wherein the conversion includes encoding the current video block into the bitstream.

17. The method of claim 1, wherein the conversion includes decoding the current video block from the bitstream.

18. An apparatus for video processing comprising a processor and a non-transitory memory with instructions thereon, wherein the instructions upon execution by the processor, cause the processor to perform acts comprising:
determining, for a conversion between a current video block of a video and a bitstream of the video, a prediction for the current video block based on a plurality of sub-partitions of the current video block and at least one intra prediction scheme, wherein the current video block is a chroma block, and the plurality of sub-partitions are obtained by partitioning the current video block; and
performing the conversion based on the prediction for the current video block.

19. A non-transitory computer-readable storage medium storing instructions that cause a processor to perform acts comprising:
determining, for a conversion between a current video block of a video and a bitstream of the video, a prediction for the current video block based on a plurality of sub-partitions of the current video block and at least one intra prediction scheme, wherein the current video block is a chroma block, and the plurality of sub-partitions are obtained by partitioning the current video block; and
performing the conversion based on the prediction for the current video block.

20. A non-transitory computer-readable recording medium storing a bitstream of a video which is generated by a method performed by an apparatus for video processing, wherein the method comprises:
determining a prediction for a current video block of the video based on a plurality of sub-partitions of the current video block and at least one intra prediction scheme, wherein the current video block is a chroma block, and the plurality of sub-partitions are obtained by partitioning the current video block; and
generating the bitstream based on the prediction for the current video block.
